(19) United States
(12) Patent Application Publication
(10) Pub. No.: US 2021/0395275 A1
(43) Pub. Date: Dec. 23, 2021

(54) COMPOSITIONS AND METHODS FOR SELECTIVE SEPARATION OF HYDROCARBON ISOMERS

(71) Applicant: RUTGERS, THE STATE UNIVERSITY OF NEW JERSEY, NEW BRUNSWICK, NJ (US)

(72) Inventors: Jing Li, Piscataway, NJ (US); Hao Wang, Piscataway, NJ (US)

(21) Appl. No.: 16/967,972

(22) PCT Filed: Feb. 6, 2019
(86) PCT No.: PCT/US19/16778

§ 371 Date: Aug. 6, 2020

Related U.S. Application Data
(60) Provisional application No. 62/627,297, filed on Feb. 7, 2018.
(60) Provisional application No. 62/640,938, filed on Mar. 9, 2018.

(51) Int. Cl. C07F 7/00; B01J 20/22

(52) U.S. Cl. CPC C07F 7/003; B01J 20/226

(57) ABSTRACT

The present disclosure relates to novel metal-organic frameworks (MOFs) comprising tetratopic linkers with small pore apertures. In certain aspects, the disclosure provides Zr-MOFs, non-limiting examples include Zr(bptc), Zr(abtc), and Zr(tptc-(Me)₂). The present disclosure further relates to methods of utilizing the MOFs of the disclosure to separate hydrocarbons through adsorptive processes. The present disclosure further relates to the discovery that Ca(H₂tcpb) metal-organic framework (MOF) is capable of separating hydrocarbon isomers from one another through adsorptive processes. In one aspect, the disclosure provides a method of separating C5-C8 hydrocarbon isomers, such that straight chain, mono-branched, and/or multi-branched isomers are each separated from one another. This separation is achieved by taking advantage of the temperature dependent adsorptive properties of Ca(H₂tcpb) MOF.

### CROSS-REFERENCE TO RELATED APPLICATIONS

This application claims to priority under 35 U.S.C. § 119(e) to U.S. Provisional Patent Application No. 62/627,297, filed Feb. 7, 2018, and U.S. Provisional Patent Application No. 62/640,938, filed Mar. 9, 2018, all of which application are hereby incorporated herein by reference in their entireties.

### STATEMENT REGARDING FEDERALLY SPONSORED RESEARCH OR DEVELOPMENT

This invention was made with government support under DE-FG02-08ER-46491 awarded by Department of Energy. The government has certain rights in the invention.

### BACKGROUND OF THE INVENTION

Chemical separations account for about 50% of the industrial energy use in the United States and 10-15% of the nation's total energy consumption. The separation of hydrocarbons is a crucial process in petrochemical industry for the manufacture of high quality gasoline, plastics, and polymers. In particular, the separation of C6 alkane (hexane) isomers is necessary to produce premium grade gasoline, yet the process is difficult because C6 alkane isomers have similar chemical and physical properties.

The separation of alkane isomers based on their degree of branching represents a critical yet challenging process in the petrochemical industry. During oil refinement, light naphtha fraction (mostly straight-chained C5 and C6) undergoes catalytic isomerization and generates a mixture of linear, mono-branched, and di-branched isomers. Isomers of a higher degree of branching usually possess higher research octane number (RON). For example, the RONs of 3-methylpentane (RON 75) and 2,2-dimethylbutane (RON 94) are much higher than that of their linear isomer n-hexane (RON 25). Thus, to produce gasoline with high RON, alkane isomers with low RON need to be removed from the mixture and recycled back into the catalytic reactor. Distillation is a conventional process to separate alkane isomers.

However, in light of the high energy consumption associated with heat-driven distillations, more energy-efficient adsorptive separation through porous media can be employed as an alternative/supplementary technology for alkane isomer separations. Zeolite 5A (LTA), as the benchmark material for this separation process, is able to adsorb linear alkanes, while excluding mono- and di-branched isomers due to its suitable pore aperture. The adsorbed linear alkanes are subsequently sent back to the catalytic reactor, where they then undergo additional cycles. Adsorptive separation of hexane isomers by zeolite 5A has been employed in industry as a supplement to distillation. However, the relatively low uptake capacity for nHEX (e.g. ˜8 wt % at 150° C. and 105 torr) limits its separation efficiency. In addition, the incapability of adsorbing any branched C6 isomers prevents its use for achieving further improved RON by differentiating mono- and di-branched isomers.

Thus, new adsorbent materials that possess such capability are much needed, as separation of alkanes with different degree of branching is a critical step to produce higher quality gasoline with further improved RONs. Tremendous effort has been made to achieve this goal, including the use of a fixed bed of silicalite or zeolite membranes. However, because of the stringent requirement on the matching pore aperture of the adsorbent and kinetic diameter of the adsorbate, it has been extremely difficult to find a suitable candidate for this process. As such, to this date adsorptive separation of mono-branched and di-branched alkanes has not been implemented in real-world systems and search for ideal sorbent materials remains ongoing.

There remains a need in the art for methods and materials capable of separating isomers of hydrocarbon compounds. In certain embodiments, such methods should allow for the separation of straight chain isomers from branched isomers and mono-branched isomers from multi-branched isomers. The present invention meets this need.

### BRIEF SUMMARY OF THE INVENTION

The invention provides a metal-organic framework comprising at least one M⁴⁺ and at least one tetratopic organic linker. The invention further provides a method of at least partially separating a first aliphatic hydrocarbon compound from at least one distinct aliphatic hydrocarbon compound and/or a mixture of aliphatic hydrocarbons. The invention further provides a method of increasing or decreasing the ratio of an aliphatic hydrocarbon in a first fluid mixture comprising the aliphatic hydrocarbon. The invention further comprises a method of separating a first and a second aliphatic hydrocarbons from a first mixture of aliphatic hydrocarbons. The invention further provides a device for separating aliphatic hydrocarbon compounds from one another. The invention further provides a kit comprising a device of the invention and instructional materials for operating the device.

In certain embodiments, the linker comprises, or is, a compound of formula (I):

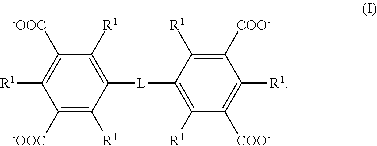

In certain embodiments, L is selected from the group consisting of a bond, optionally substituted C1-C6 alkylene, optionally substituted C2-C6 alkenylene, optionally substituted C2-C6 alkynylene, optionally substituted C1-C6 heteroalkylene, optionally substituted C2-C6 heteroalkenylene, optionally substituted C2-C6 heteroalkynylene,

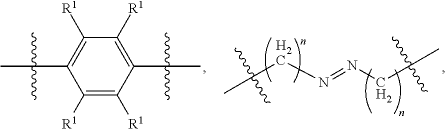

O, S, SO₂, NH and NCH₃.

In certain embodiments, each instance of R¹ is independently selected from the group consisting of H, CH₂, CH₂CH₃, OCH₃, OH, NH₂, F, Cl, Br, I, CF₃, SH, and NO₂.

In certain embodiments, each instance of n is an integer from 0 to 3.

In certain embodiments, M⁴⁺ is a metal selected from the group consisting of Zr⁴⁺, Hf⁴⁺ and Ti⁴⁺. In certain embodiments, M⁴⁺ is Zr⁴⁺. In certain embodiments, M⁴⁺ is in the form of a (M⁴⁺)₆ cluster.

In certain embodiments, the (M⁴⁺)₆ cluster comprises at least one μ₃-O bridging ligand, at least one μ₃-OH bridging ligand, and at least one formate bridging ligand. In certain embodiments, each (M⁴⁺)₆ cluster is bound to 12, 8, or 4 tetratopic organic linkers of formula (I).

In certain embodiments, the at least one linker of formula (I) is a compound selected from the group consisting of:

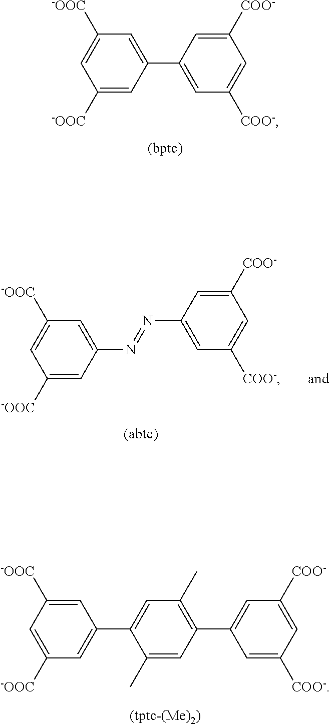

In certain embodiments, the framework has a topology selected from the group consisting of ftw, scu and lvt. In certain embodiments, the framework crystallizes in a space group selected from the group consisting of space group Im3, space group C2/m, and space group Imma. In certain embodiments, the framework has a Brunauer-Emmett-Teller (BET) surface area from about 1,000 m²/g to about 1,500 m²/g. In certain embodiments, the framework has a micropore volume from about 0.35 cm²/g to about 0.50 cm²/g. In certain embodiments, the framework is thermally stable up to about 400° C. In certain embodiments, the framework is stable after being heated at up to about 180° C. for 1 month. In certain embodiments, the framework retains crystallinity in aqueous solutions having a pH from about 2 to about 12. In certain embodiments, the framework is capable of reversibly adsorbing from about 100 mg/g to about 130 mg/g of aliphatic hydrocarbon (hydrocarbon/MOF).

In certain embodiments, the method comprises contacting the first aliphatic hydrocarbon compound and the at least one distinct aliphatic hydrocarbon compound with a metal-organic framework of the invention, whereby the first aliphatic hydrocarbon compound and the at least one distinct aliphatic hydrocarbon compound are at least partially separated from one another.

In certain embodiments, the first aliphatic hydrocarbon compound and the at least one distinct aliphatic hydrocarbon compound are run through a column that is at least partially packed with the metal-organic framework.

In certain embodiments, the first aliphatic hydrocarbon compound and the at least one distinct aliphatic hydrocarbon compound are independently selected from the group consisting of C5-C7 alkanes, C5-C7 alkenes, and C5-C7 alkynes.

In certain embodiments, the first aliphatic hydrocarbon compound and the at least one distinct aliphatic hydrocarbon compound are isomers.

In certain embodiments, the first aliphatic hydrocarbon compound and the at least one distinct aliphatic hydrocarbon compound are C6 isomers.

In certain embodiments, the first aliphatic hydrocarbon compound and the at least one distinct aliphatic hydrocarbon compound are selected from the group consisting of n-hexane, 2-methylpentane, 3-methylpentane, 2,2-dimethylbutane, and 2,3-dimethylbutane.

In certain embodiments, the method comprises contacting the first fluid mixture with the metal-organic framework of any of claims 1-15 thus originating a second fluid mixture. In certain embodiments, the second fluid mixture has a higher or lower ratio of the aliphatic hydrocarbon as compared to the first fluid mixture.

In certain embodiments, the aliphatic hydrocarbon compound is selected from the group consisting of C5-C7 alkanes, C5-C7 alkenes, and C5-C7 alkynes.

In certain embodiments, the aliphatic hydrocarbon compound and at least one distinct aliphatic hydrocarbon compound in the first fluid mixture are isomers. In certain embodiments, the aliphatic hydrocarbon compound and the at least one distinct aliphatic hydrocarbon compound in the first fluid mixture are C6 isomers. In certain embodiments, the aliphatic hydrocarbon compound and the at least one distinct aliphatic hydrocarbon compound in the first fluid mixture are selected from the group consisting of n-hexane, 2-methylpentane, 3-methylpentane, 2,2-dimethylbutane, and 2,3-dimethylbutane.

In certain embodiments, the method comprises contacting the mixture with a Ca(H₂tcpb) MOF, wherein the first aliphatic hydrocarbon is selectively adsorbed onto the Ca(H₂tcpb) MOF over at least one additional aliphatic hydrocarbon in the mixture. In certain embodiments, the mixture comprises at least one selected from the group consisting of a C₅ alkane, a C₅ alkene, a C₆ alkane, a C₆ alkene, a C₇ alkane, a C₇ alkene, a C₈ alkane, and a C₈ alkene. In certain embodiments, the mixture comprises at least one selected from the group consisting of C₅ alkane isomers, C₅ alkene isomers, C₆ alkane isomers, C₆ alkene isomers, C₇ alkane isomers, C₇ alkene isomers, C₈ alkane isomers, and C₈ alkene isomers. In certain embodiments, the mixture comprises at least one selected from the group consisting of saturated hydrocarbons, single unsaturated compounds, double unsaturated compounds, and triple unsaturated compounds. In certain embodiments, the mixture comprises at least one selected from the group consisting of straight chained, mono-branched and multi-branched compounds. In certain embodiments, the mixture comprising the first aliphatic hydrocarbon compound is run through a column that is at least partially filled with Ca(H₂tcpb) MOF at a temperature such that the first aliphatic hydrocarbon compound is adsorbed by the MOF while the remaining aliphatic hydrocarbons are not adsorbed or are adsorbed to a lower extent than the first aliphatic compound, thereby separating the first aliphatic hydrocarbon from the mixture.

In certain embodiments, the method comprises (a) running the first mixture through a first column that is at least partially filled with Ca(H₂tcpb) MOF at a first temperature such that the first aliphatic hydrocarbon in the mixture is adsorbed by the MOF while the remaining aliphatic hydrocarbons in the first mixture are not adsorbed or are adsorbed to a lower extent than the first aliphatic compound, thereby separating the first aliphatic hydrocarbon from the first mixture and generating a second mixture, which is depleted from the first aliphatic hydrocarbon as compared to the first mixture. In certain embodiments, the method comprises (b) running the second mixture of aliphatic hydrocarbons through a second column that is at least partially filled with Ca(H₂tcpb) MOF at a second temperature that is different from the first temperature such that a second aliphatic hydrocarbon in the mixture is adsorbed by the MOF while the remaining aliphatic hydrocarbons in the second mixture are not adsorbed or are adsorbed to a lower extent than the second aliphatic compound, thereby separating the second aliphatic hydrocarbon from the second mixture and generating a third mixture, which is depleted from the second aliphatic hydrocarbon as compared to the second mixture. In certain embodiments, the method comprises optionally repeating step (b) one or more times to separate further additional aliphatic hydrocarbons from the third mixture.

In certain embodiments, the first mixture comprises at least two selected from the group consisting of a C₅ alkane, a C₅ alkene, a C₆ alkane, a C₆ alkene, a C₇ alkane, a C₇ alkene, a C₈ alkane, and a C₈ alkene. In certain embodiments, the first mixture comprises at least one selected from the group consisting of C₅ alkane isomers, C₅ alkene isomers, C₆ alkane isomers, C₆ alkene isomers, C₇ alkane isomers, C₇ alkene isomers, C₈ alkane isomers, and C₈ alkene isomers. In certain embodiments, the first mixture comprises at least one selected from the group consisting of saturated hydrocarbons, single unsaturated compounds, double unsaturated compounds, and triple unsaturated compounds. In certain embodiments, the first mixture comprises at least one selected from the group consisting of straight chained, mono-branched and multi-branched compounds. In certain embodiments, the first mixture is a mixture of aliphatic hydrocarbon isomers. In certain embodiments, the method further comprises collecting the adsorbed, separated first aliphatic hydrocarbon from the first column and/or the adsorbed, separated second aliphatic hydrocarbon from the second column. In certain embodiments, the mixture is a gaseous mixture.

In certain embodiments, the device comprises a first column that is at least partially filled with Ca(H₂tcpb) MOF, the first column comprising an inlet, a first outlet, and a second outlet. In certain embodiments, the devise comprises a second column that is at least partially filled with Ca(H₂tcpb) MOF, the second column comprising an inlet, a first outlet, and a second outlet, wherein the inlet of the second column is in in fluidic communication with the first outlet of the first column. In certain embodiments, the device comprises a first heating element adapted and configured to regulate the temperature of the first column. In certain embodiments, the device comprises a second heating element adapted and configured to regulate the temperature of the second column. In certain embodiments, the device comprises hydrocarbon source in fluidic communication with the inlet of the first column, wherein the gas source is adapted and configured to supply a hydrocarbon mixture to the inlet of the first column. In certain embodiments, the device comprises at least one additional column comprising a first inlet, a first outlet and a second outlet, wherein the inlet of the additional column is in fluidic communication with the first outlet of the second column, and wherein the at least one additional column is at least partially filled with Ca(H₂tcpb) MOF. In certain embodiments, the device comprises at least one additional column comprising a first inlet, a first outlet and a second outlet, wherein the inlet of the additional column is in fluidic communication with the second outlet of the first column, and wherein the at least one additional column is at least partially filled with Ca(H₂tcpb) MOF. In certain embodiments, the device comprises at least one additional heating element adapted and configured to regulate the temperature of the additional column.

### BRIEF DESCRIPTION OF THE FIGURES

For the purpose of illustrating the invention, depicted in the drawings are certain embodiments of the invention. However, the invention is not limited to the precise arrangements and instrumentalities of the embodiments depicted in the drawings.

FIG. 1 is a schematic representation of the apparatus and methods utilized in column breakthrough experiments using the Zr-MOFs of the invention.

FIG. 2 is a set of schemes and structures of secondary building units (SBUs), organic linkers, crystal structures, and topology of compounds 1-3.

FIG. 3 is a graph showing observed (A), calculated (B) and difference (C) PXRD profiles for the activated compound 1 Zr-MOF based on Rietveld refinement results.

FIG. 4 is a set of schemes showing the crystal structure and topology of compound 1.

FIG. 5 is a graph showing simulated PXRD patterns of compound 1 (A), 2 (B), and 3 (C).

FIGS. 6A-6B are a set of schemes showing the crystal structure and topology of compound 2.

FIGS. 7A-7D are a set of schemes showing the crystal structure and topology of compound 3.

FIG. 8 is a diagram relating the topologies of Zr-MOFs built on Zr6 clusters with ditopic (145) and polytopic (56) linkers. Structure types with minimum transitivity yet to be realized are shown in red. Numbers next to the arrows represent connectivity of the linker or cluster.

FIG. 9 is a diagram showing a ftw net and its subnets with minimum transitivity (magenta and green balls represent the nodes of Zr₆ clusters and linkers, respectively). Structure types yet to be realized are 4-c sql, 4,6-c soc, and 4,6-c stp.

FIG. 10 is a graph showing pore aperture of ftw Zr-MOFs built on different linkers.

FIG. 11 is a diagram showing two possible relative orientations of a rectangular ligand in 4,12-ftw topology.

FIGS. 12A-12B are graphs of the N₂ adsorption isotherm at 77K (FIG. 12A) and BET plot (FIG. 12B) for compound 1.

FIGS. 13A-13B are graphs of the N₂ adsorption isotherm at 77K (FIG. 13A) and BET plot (FIG. 13B) for compound 2.

FIGS. 14A-14C are graphs showing the results of stability tests and porosity characterization of compounds 1 and 2. FIG. 14A is a set of PXRD patterns of compound 1. From bottom to top: simulated (A), as synthesized (B), after adsorption experiments (C), heated at 180° C. in open air for 1 month (D, relative humidity: ˜30-50% RH), and boiled in water for 1 week (E). FIG. 14B is a set of PXRD patterns of compound 2. From bottom to top: simulated (A), as synthesized (B), boiled in water for 3 days (C), and heated at 180° C. in open air for 1 week (D). FIG. 14C is a graph comparing the N₂ adsorption isotherms at 77 K for compound 1 (as synthesized and after being heated at 80° C. in water for 1 day, lower set of points) and compound 2 (as synthesized and after being heated at 80° C. in water for 1 day, upper set of points).

FIG. 15 is a graph showing PXRD patterns of compound 1. From bottom to top: simulated (A), as synthesized (B), activated (C), after adsorption study (D).

FIG. 16 is a graph showing PXRD patterns of compound 1. From bottom to top: as synthesized (A), 300° C. isothermal for 2 hours in nitrogen (B), 400° C. isothermal for 2 hours in nitrogen (C), 180° C. in open air for 1 week (D), 180° C. in open air for 1 month (E).

FIG. 17 is a graph showing PXRD patterns of compound 1. From bottom to top: as synthesized (A), immersed in water for 1 week (B), immersed in pH=2 aqueous HCl solution for 1 week (C), immersed in pH=12 NaOH aqueous solution for 1 week (D), immersed in 100° C. water (in teflon bomb) for 1 week (E), immersed in hexane isomers solution (n-hexane: 3-methylpentane: 2,2-dimethylbutane=1:1:1) for 1 month (F).

FIG. 18 is a graph of a thermogravimetric analysis (TGA) curve for compound 1.

FIGS. 19A-19C are N₂ adsorption isotherms at 77 K before (A) and after (B) water treatment for compound 1 (FIG. 19A), compound 2 (FIG. 19B) and UiO-67 (FIG. 19C). (Water treatment: ˜100 mg of sample immersed in ˜20 mL of water which is heated at 80° C. for 24 hours).

FIG. 20 is a set of PXRD patterns of UiO-67: Simulated (A), as synthesized (B) and after immersed in H₂O at 80° C. for 1 day (C), for comparative purposes.

FIG. 21 is a set of PXRD patterns of compound 2. From bottom to top: simulated (A), as synthesized (B), after being immersed in H₂O at 80° C. for 3 days (C), after being heated at 180° C. in open air for 3 days (D).

FIG. 22 is a graph of a thermogravimetric analysis (TGA) curve for compound 2.

FIG. 23 is a set of PXRD patterns of compound 3. From bottom to top: simulated (A), as synthesized (B), activated (C).

FIG. 24 is a graph of a thermogravimetric analysis (TGA) curve for compound 3.

FIGS. 25A-25B are graphs of the N₂ adsorption isotherm at 77K (FIG. 25A) and BET plot (FIG. 25B) for compound 3.

FIG. 26 is a graph of n-hexane adsorption isotherms on compound 1 at (from top to bottom) 30° C. (A), 90° C. (B), 120° C. (C) and 150° C. (D).

FIG. 27 is a graph of n-hexane adsorption isotherms on compound 1 at (from top to bottom 180°) C. (A), 200° C. (B), 220° C. (C), and 240° C. (D).

FIGS. 28A-28C are graphs showing adsorption of n-hexane (top) and 3-methylpentane (bottom) on prior art zeolite 5A at (FIG. 28A) 30° C., (FIG. 28B) 90° C., and (FIG. 28C) 150° C.

FIG. 29 is a graph showing isosteric heats of adsorption (Qₛₜ) for n-hexane adsorption on compound 1.

FIGS. 30A-31 are a set of graphs showing adsorption and separation of C6 alkane isomers by the compounds of the invention as well as prior art zeolite 5A. FIGS. 30A-30B show a set of adsorption isotherms (FIG. 30A) and adsorption rates (FIG. 30B, at 100 torr) for compound 1 at 150° C. FIG. 30C is a graph comparing nHEX adsorption rates for compound 1 and zeolite 5A at 150° C. and 100 torr. FIGS. 30D-30E show a set of adsorption isotherms (FIG. 30D) and adsorption rates (FIG. 30E, at 100 torr) for compound 2 at 150° C. FIG. 30F is a graph showing heat of adsorption of C6 alkane isomers on compound 2. FIGS. 30G-30I show breakthrough curves of an equimolar ternary mixture of C6 alkane isomers at 150° C. for (FIG. 30G) zeolite 5A, (FIG. 30H) compound 1, and (FIG. 30I) compound 2. Green curve represents the real-time RON of the eluted products.

FIG. 31 is a graph of adsorption isotherms of n-hexane (A), 3-methylpentane (B) and 2,3-dimethylbutane (C) on compound 1 at 150° C.

FIGS. 32A-32C are a set of graphs showing adsorption of n-hexane (top), 3-methylpentane (middle) and 2,3-dimethylbutane (bottom) on compound 1 at (FIG. 32A) 30° C., (FIG. 32B) 90° C., and (FIG. 32C) 150° C.

FIG. 33 is a graph showing ten cycles of n-hexane adsorption isotherms on compound 1 at 150° C. (desorption condition: 150° C. for 30 min under nitrogen).

FIG. 34 is a set of PXRD patterns of prior art material UiO-66. Simulated (bottom), as synthesized (top).

FIG. 35 is a set of PXRD patterns of prior art material Y-fum. Simulated (bottom), as synthesized (top).

FIG. 36 is a set of PXRD patterns of prior art material UiO-67. Simulated (A), as synthesized (B).

FIGS. 37A-37C are graphs showing the adsorption of n-hexane (A), 3-methylpentane (B) and 2,3-dimethylbutane (C) on prior art material UiO-66 at (FIG. 37A) 30° C., (FIG. 37B) 90° C., and (FIG. 37C) 150° C.

FIGS. 38A-38C are graphs showing the adsorption of n-hexane (A) and 3-methylpentane (B) on prior art zeolite 5A at (FIG. 38A) 30° C., (FIG. 38B) 90° C., and (FIG. 38C) 150° C.

FIGS. 39A-39C are graphs showing the adsorption of n-hexane (black) and 3-methylpentane (red) on prior art material Y-fum at (FIG. 39A) 30° C., (FIG. 39B) 90° C., and (FIG. 39C) 150° C.

FIGS. 40A-40C are graphs showing the adsorption of n-hexane (black) and 3-methylpentane (red) on prior art material ZIF-8 at (FIG. 40A) 30° C., (FIG. 40B) 90° C., and (FIG. 40C) 150° C.

FIG. 41 is a plot comparing n-hexane uptake and n-hexane/3-methylpentane uptake ratio for various materials at 150° C. (150° C. and 100 torr). Selectivity was estimated as the ratio of uptake.

FIG. 42 is a graph showing n-hexane adsorption isotherms on compound 2 at (from top to bottom) 30° C. (A), 90° C. (B) and 150° C. (C).

FIG. 43 is a graph showing n-hexane adsorption isotherms on compound 2 at (from top to bottom 120°) C. (A), 130° C. (B) 140° C. (C) and 150° C. (D).

FIG. 44 is a graph showing 3-methylpentane adsorption isotherms on compound 2 at (from top to bottom) 30° C. (A), 90° C. (B) and 150° C. (C).

FIG. 45 is a graph showing 3-methylpentane adsorption isotherms on compound 2 at (from top to bottom) 120° C. (A), 130° C. (B) 140° C. (C) and 150° C. (D).

FIG. 46 is a graph showing 2,3-dimethylbutane adsorption isotherms on compound 2 at (from top to bottom) 120° C. (A), 130° C. (B) 140° C. (C) and 150° C. (D).

FIGS. 47A-47C are graphs showing adsorption of (from top to bottom) n-hexane (A), 3-methylpentane (B) and 2,3-dimethylbutane (C) on compound 2 at (FIG. 47A) 30° C., (FIG. 47B) 90° C., and (FIG. 47C) 150° C.

FIG. 48 is a graph showing isosteric heats of adsorption (Qₛₜ) for n-hexane (A), 3-methylpentane (B) and 2,3-dimethylbutane (C) adsorption on compound 2 as a function of loading.

FIGS. 49A-49B are graphs showing separation of n-hexane (A), 3-methylpentane (B) and 2,3-dimethylbutane (C) running through a packed bed of prior art material zeolite 5A at 150° C. (top) and 30° C. (bottom). d curve indicates the RON of the eluted mixture.

FIGS. 50A-50B are graphs showing separation of n-hexane (A), 3-methylpentane (B) and 2,3-dimethylbutane (C) running through a packed bed of compound 1 at 150° C. (top) and 30° C. (bottom). D curve indicates the RON of the eluted mixture.

FIGS. 51A-51B are graphs showing separation of n-hexane (A), 3-methylpentane (B) and 2,3-dimethylbutane (B) running through a packed bed of compound 2 at 150° C. (top) and 30° C. (bottom). D curve indicates the RON of the eluted mixture.

FIGS. 52A-52B are models used for energy barrier calculations. FIG. 52A is a representative structure of n-hexane about to enter the MOF pore window. FIG. 52B is a representative structure of the n-hexane inside the MOF pore window before it enters the MOF cage.

FIGS. 53A-53F are chemical models used for energy barrier calculations. FIGS. 53A-53C are three C6 isomers: n-hexane (FIG. 53A), 2-methylpentane (FIG. 53B) and 2,2-dimethylbutane (FIG. 53C). FIGS. 53D-53F are the three MOF entrances explored in the simulations: “straight” (FIG. 53D), “diagonal” (FIG. 53E) and “breathing” (FIG. 53F). In the “straight” model, the guest molecules traverse straight through the pore window opening. In the “diagonal” model, the molecules go along a path that dips down by 45° with respect to the “straight” entrance, which allows the molecules to go through a different opening that is noticeably larger. Finally, the “breathing” model represents the same path as the “diagonal” model, but the opening is temporarily increased in size due to the breathing motion of the MOF. Approximate areas of the various openings are indicated at the center of the figures; in the case of the “breathing” mechanism, the indicated area is a typical value during the breathing motion.

FIGS. 54A-54D are graphs showing time and temperature dependent energy barriers. Total energy fluctuations for n-hexane (FIG. 54A), 2-methylpentane (FIG. 54B), and 2,2-dimethylbutane (FIG. 54C) at 300 K and n-hexane at 423 K (FIG. 54D) along with the calculated time-dependent energy barriers. The B lines indicate the total energies of the system when the isomer is about to enter the MOF pore and the A lines are the total energies when the isomer is inside the MOF pore window. The difference is shown as the energy barrier in the right panels.

FIGS. 55A-55B are graphs summarizing the investigation of the mechanism of separation of C6 alkane isomers in compounds 1 and 2. FIG. 55A is a schematic representation of the energy barriers calculated from molecular dynamic simulations in compound 1 to highlight vast differences between the linear and branched C6 alkane isomers as well as the effect of temperature. The energy barriers range from 0 (no barrier) to 4 eV and are broken into 0.5 eV increments. The size of each circle corresponds to the amount of time spent in the increment. A larger circle thus indicates more time steps with a barrier in that increment range. FIG. 55B is a series of IR spectra of compound 2 upon adsorption of three C6 alkane isomers after 3 minutes under 10 torr at 30° C. All spectra are normalized by the reference spectra recorded prior to the adsorption.

FIGS. 56A-56B are IR spectra of (FIG. 56A) nHEX and (FIG. 56B) 3MP adsorbed compound 2 (bottom spectra) and after 1 min evacuation (top spectra). All spectra are normalized by the reference spectra recorded prior to adsorption.

FIG. 57A is a diagram of the crystal structure of Ca(H₂tcpb) showing the 1D open channels. FIG. 57B is a diagram of the crystal structure of Ca(H₂tcpb) showing the shape of 1D channels outlined by adsorbed helium atoms. Helium adsorption simulation was performed at 1 K and 1 bar.

FIGS. 57C-57E are schematic representations of aliphatic hydrocarbon mixture separation devices according to exemplary embodiments of the invention.

FIG. 58 is a series of PXRD spectra of as-synthesized Ca(H₂tcpb). From bottom to top: Simulated, fresh, and on shelf for 3 years.

FIGS. 59A-59B are graphs showing thermogravimetric analysis of as synthesized Ca(H₂tcpb).xH₂O (FIG. 59A) and activated Ca(H₂tcpb) after being exposed in open air for 5 days (FIG. 59B).

FIGS. 60A-60C are adsorption isotherms of nHEX (FIG. 60A), 3MP (FIG. 60B), and 22DMB (FIG. 60C) at 30° C. (top line), 60° C. (second from top line), 90° C. (middle line), 120° C. (second from bottom line), and 150° C. (bottom line). FIGS. 60D-60E are comparison isotherms showing adsorption of nHEX (top line), 3MP (middle line), and 22DMB (bottom line) at 60° C. (FIG. 60D) and 120° C. (FIG. 60E). The inserts in FIGS. 60D-60E show adsorption rates of the corresponding isomers at 100 torr. FIG. 60F is a schematic representation of the proposed temperature programmed separation of C6 alkane isomers.

FIGS. 61A-61F are schematic setups (FIGS. 61A-61C) and results (FIGS. 61D-61F) of multicomponent column breakthrough experiments for the ternary mixture of nHEX (bottom line), 3MP (middle line), and 22 DMB (top line) (FIGS. 61A and 61D), binary mixture of nHEX (bottom line) and 3MP (top line) (FIGS. 61B and 61E), and binary mixture of 3MP (bottom line) and 22DMB (top line) (FIGS. 61C and 61F).

FIG. 62 is a graph showing thermogravimetric analysis of nHEX loaded Ca(H₂tcpb).

FIG. 63 is a series of PXRD patterns of Ca(H₂tcpb). From bottom to top: Activated at 150° C., nHEX loaded, and reactivated after nHEX loading.

FIG. 64 is a graph showing thermogravimetric analysis of 3MP loaded Ca(H₂tcpb).

FIG. 65 is a series of PXRD patterns of Ca(H₂tcpb). From bottom to top: Activated at 150° C., 3MP loaded, and reactivated after 3MP loading.

FIG. 66 is a graph showing thermogravimetric analysis of 22DMB loaded Ca(H₂tcpb).

FIG. 67 is a series of PXRD patterns of Ca(H₂tcpb). From bottom to top: Activated at 150° C., 22DMB loaded, and reactivated after 22DMB loading.

FIG. 68 is a set of PXRD patterns of various forms of Ca(H₂tcpb). Important diffraction planes are indicated in the figure. From the bottom line to the top line, the Ca(H₂tcpb) forms are: activated; as synthesized, loaded with H₂O; loaded with nHEX; loaded with 3MP; and loaded with 22DMB.

FIG. 69 is a schematic representation of the pore enlargement of Ca(H2tcpb) upon guest inclusion.

FIG. 70 is a graph showing the results of a Ca(H₂tcpb) column breakthrough experiment for an equimolar binary mixture of 3MP and 22DMB under humid (50% relative humidity) conditions.

FIGS. 71A-71E are adsorption isotherms of nHEX (FIG. 71A), nPEN (FIG. 71B), and nHEP (FIG. 71C), 3MP (FIG. 71D), and 2 MB (FIG. 71E) on Ca(H₂tcpb) at 30° C. (top line), 60° C. (second from top line), 90° C. (second from bottom line), and 120° C. (bottom line).

### DETAILED DESCRIPTION OF THE INVENTION

The present invention relates in one aspect to the unexpected discovery of novel metal-organic frameworks (MOFs) comprising tetratopic linkers with small pore apertures. The present invention further relates to methods of utilizing the MOFs of the invention to separate hydrocarbons, including isomers thereof, through adsorptive processes.

The present invention relates in another aspect to the unexpected discovery that Ca(H₂tcpb) MOF is capable of separating hydrocarbon isomers from one another through adsorptive processes. In one aspect, the invention provides a method of separating C5-C8 hydrocarbon isomers, such that straight chain, mono-branched and multi-branched isomers are each separated from one another. In certain embodiments, this separation is achieved by taking advantage of the temperature dependent adsorptive properties of Ca(H₂tcpb) MOF.

### DISCLOSURE

Metal-organic frameworks (MOFs) have been investigated for gas storage and separation not only because of their high porosity but more importantly, they also offer fascinating tunability with respect to their pore size, shape, and surface functionality. These features make them attractive candidates for energy-efficient separation of hydrocarbons via different mechanisms that are not easily achievable by traditional porous solids. While MOFs have shown strong potential for the separation of alkane isomers, none of them have reached the performance level of the benchmark material, zeolite 5A, with respect to both adsorption capacity and selectivity under similar industrial relevant conditions.

In certain embodiments, the present invention includes a novel MOF family, including structures built on zirconium and tetratopic carboxylate linkers. This family of MOFs is interesting due to the fact that Zr MOFs are highly stable and tetratopic linkers can be varied in size and structure to control the overall structure type. For example, a specific ftw type structure can form with Zr and a rigid and planar tetratopic linker, featuring three-dimensional (3D) porous frameworks with large cubic cages but small window aperture. This structure is desirable for molecular separation through selective size sieving. However, all ftw type Zr-MOFs reported to date are built on relatively large organic linkers (e.g. porphyrin or pyrene based molecules), which result in pore apertures that are too large for molecular exclusion based separation process. Since the pore aperture of a ftw Zr-MOF is dominated by the distance between adjacent carboxylates of the organic ligand (or adjacent Zr₆ SBUs in the MOF structure), the present invention includes isophthalate based tetratopic linkers with appropriate molecular dimensions to reduce the distance between adjacent SBUs and consequently the pore aperture.

One embodiment of the invention includes a series of three organic linkers with similar geometry but different aspect ratios, 3,3′,5,5′-biphenyltetracarboxylate (bptc), 5,5′-(diazene-1,2-diyp)diisophthalate (abtc), and 2′,5′-dimethyl-[1,1′:4′,1″-terphenyl]-3,3″,5,5″-tetracarboxylate (tptc-(Me)₂).

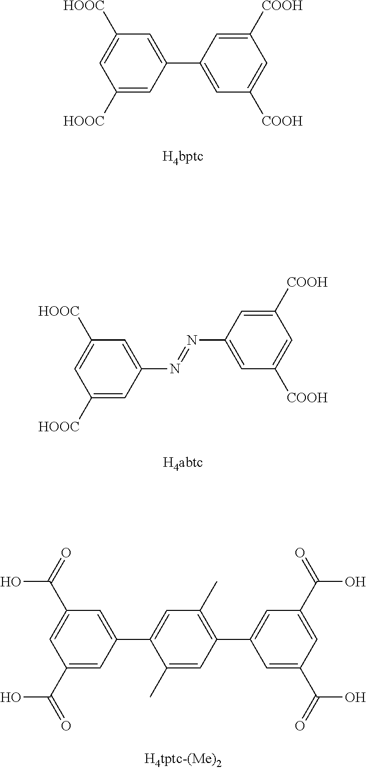 [SMILES: O=C(O)c1cc(C(=O)O)cc(-c2cc(C(=O)O)cc(C(=O)O)c2)c1 ; O=C(O)c1cc(/N=N/c2cc(C(=O)O)cc(C(=O)O)c2)cc(C(=O)O)c1 ; Cc1cc(-c2cc(C(=O)O)cc(C(=O)O)c2)c(C)cc1-c1cc(C(=O)O)cc(C(=O)O)c1]

Crystals were obtained of these three Zr-MOF compounds after systematic synthetic optimization. Two of these structures, Zr-bptc and Zr-abtc, are highly stable frameworks with optimal pore structure for separation of C6 alkane isomers. Their performance is comparable and, in some aspects, outperforms the benchmark material zeolite 5A.

### Metal-Organic Frameworks

In one aspect, the invention provides a metal-organic framework comprising at least one M⁴⁺, and at least one tetratopic organic linker of formula (I):

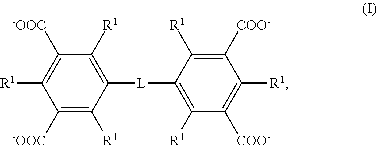

wherein in (I):

L is selected from the group consisting of a bond, optionally substituted C1-C6 alkylene, optionally substituted C2-C6 alkenylene, optionally substituted C2-C6 alkynylene, optionally substituted C1-C6 heteroalkylene, optionally substituted C2-C6 heteroalkenylene, optionally substituted C2-C6 heteroalkynylene,

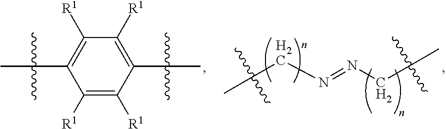

O, S, SO₂, NH and NCH₃;

each instance of R¹ is independently selected from the group consisting of H, CH₃, CH₂CH₃, OCH₃, OH, NH₂, F, Cl, Br, I, CF₃, SH, and NO₂; and each instance of n is an integer from 0 to 3.

In certain embodiments, M⁴⁺ is a metal selected from the group consisting of Zr⁴⁺, Hf⁴⁺ and Ti⁴⁺. In other embodiments, M⁴⁺ is Zr⁴⁺.

In certain embodiments, the M⁴⁺ is in the form of a (M⁴⁺)₆ cluster. In other embodiments, the (M⁴⁺)₆ cluster comprises at least one μ₃-O bridging ligand. In other embodiments, the (M⁴⁺)₆ cluster comprises at least one μ₃-OH bridging ligand. In yet other embodiments, the (M⁴⁺)₆ cluster comprises at least one formate bridging ligand. In certain embodiments, each (M⁴⁺)₆ cluster is bound to from 4 to 12 tetratopic organic linkers of formula (I). In certain embodiments, each (M⁴⁺)₆ cluster is bound to 12, 8, or 4 tetratopic organic linkers of formula (I).

In certain embodiments, the (M⁴⁺)₆ cluster is arranged such that the M⁴⁺ ions form an octahedron. In certain embodiments, the metal-organic framework crystallizes in a form such that the secondary building units (SBUs) of the material are at least one selected from the group consisting of Zr₆(μ₃-O)₄(μ₃-OH)₄(COO)₁₂, Zr₆(μ₃-O)₄(μ₃-OH)₄(COO)₈ and Zr₆(μ₃-O)₄(μ₃-OH)₄(COO)₄.

In certain embodiments, the at least one linker of formula (I) is a compound selected from the group consisting of

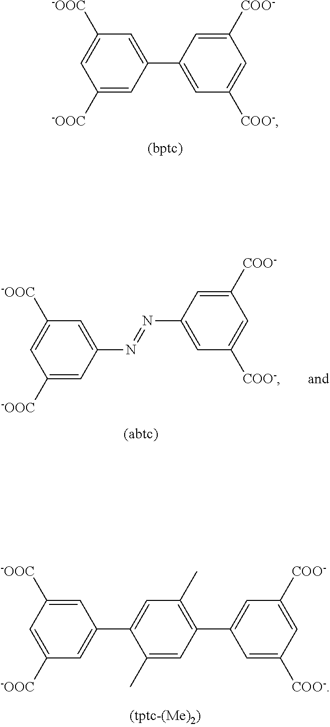

In certain embodiments, the metal-organic framework has a topology selected from the group consisting of ftw, scu, and lvt.

In certain embodiments, the metal-organic framework crystallizes in a cubic crystal system. In other embodiments, the metal-organic framework crystallizes in a cubic crystal system in space group Im3.

In certain embodiments, the metal-organic framework crystallizes in a monoclinic crystal system. In other embodiments, the metal-organic framework crystallizes in a monoclinic crystal system in space group C2/m.

In certain embodiments, the metal-organic framework crystallizes in an orthorhombic crystal system. In other embodiments, the metal-organic framework crystallizes in an orthorhombic crystal system in space group Imma.

In certain embodiments, the metal-organic framework 3D structure has a pore or window size of about 4 Å to about 20 Å. In other embodiments, the metal-organic framework 3D structure has a pore or window size of about 4.5 Å to about 7 Å.

In certain embodiments, the metal-organic framework is a compound of formula Zr₆O₄(OH)₄(bptc)₃ In other embodiments, the metal-organic framework is a compound of empirical formula C₂₄H₉O₁₆Zr₃. In yet other embodiments, the metal-organic framework crystallizes in a cubic crystal system in space group Im3. In yet other embodiments, the metal-organic framework has unit cell dimensions a=24.3597 (3) Å. In yet other embodiments, the metal-organic framework has a unit volume of about 14455.0 (5) Å³. In yet other embodiments, the metal-organic framework has an X-ray powder diffraction spectrum comprising 2θ values (in degrees) of about 7.26, 10.26, 12.58, 13.58, and 14.54.

In certain embodiments, the metal-organic framework is a compound of formula Zr₆O₄(OH)₄(abtc)₂(OH)₄(H₂O)₄ In other embodiments, the metal-organic framework is a compound of empirical formula C₃₂H₂₀N₄O₃₂Zr₆. In yet other embodiments, the metal-organic framework crystallizes in a monoclinic crystal system in space group C2/m. In yet other embodiments, the metal-organic framework has unit cell dimensions a=25.4692(11) Å, b=36.3589(15) Å, c=21.5275(9) Å, α=90°, β=122.260(2)°, γ=90°. In yet other embodiments, the metal-organic framework has a unit volume of about 16857.8(13) Å³. In yet other embodiments, the metal-organic framework has an X-ray powder diffraction spectrum comprising 2θ values (in degrees) of about 6.86, 9.54, 9.72, 10.00, and 13.76.

In certain embodiments, the metal-organic framework is a compound of formula Zr₆O₄(OH)₄(tptc-(Me)₂)(HCOO)₄(OH)₄(H₂O)₄. In other embodiments, the metal-organic framework is a compound of empirical formula C₁₄H₁₇O₁₆Zr₃. In yet other embodiments, the metal-organic framework crystallizes in an orthorhombic crystal system in space group Imma. In yet other embodiments, the metal-organic framework has unit cell dimensions a=25.2379(14) Å, b=27.7529(16) Å, c=15.2344(10) Å, α=90°, β=90°, γ=90°. In yet other embodiments, the metal-organic framework has a unit volume of about 10670.6(11) Å³. In yet other embodiments, the metal-organic framework has an X-ray powder diffraction spectrum comprising 2θ values (in degrees) of about 6.36, 6.62, 7.00, 9.46, 9.63, and 11.18.

In certain embodiments, the MOF has a Brunauer-Emmett-Teller (BET) surface area from about 1,000 m²/g to about 1,500 m²/g. In other embodiments, the MOF has a micropore volume from about 0.35 cm²/g to about 0.50 cm²/g. In certain embodiments, the MOF is thermally stable up to about 400° C. In other embodiments, the MOF is stable after being heated at up to about 180° C. for 1 month. In yet other embodiments, the MOF retains crystallinity in aqueous solutions having a pH from about 2 to about 12.

In certain embodiments, the MOF is capable of reversibly and selectively adsorbing aliphatic hydrocarbon compounds. In other embodiments, the MOF is capable of adsorbing alkanes, alkenes, and alkynes, including single, double and triple unsaturated compounds. In preferred embodiments, the aliphatic hydrocarbon compounds are C5-C7 compounds. In yet other embodiments, the aliphatic hydrocarbon compounds are straight chained, branched, or multi-branched compounds. In an exemplary embodiment, the MOF is capable of reversibly adsorbing n-hexane. In other embodiments, the MOF is capable of adsorbing from about 100 mg/g to about 130 mg/g of aliphatic hydrocarbon (hydrocarbon/MOF).

In certain embodiments, the MOF is capable of separating aliphatic hydrocarbon isomers from one another. In other embodiments, the MOF is capable of separating n-hexane from other C6 aliphatic compounds. In yet other embodiments, the MOF is capable of separating at least two compounds selected from n-hexane, 2-methylpentane, 3-methylpentane, 2,2-dimethylbutane, and 2,3-dimethylbutane, from one another. Without wishing to be limited by any particular theory, the MOF is capable of separating aliphatic hydrocarbon isomers through selective adsorption, whereby multibranched hydrocarbons are not adsorbed or only marginally adsorbed, monobranched hydrocarbons are moderately adsorbed, and unbranched hydrocarbons are strongly adsorbed.

### Separation Methods

The invention further provides methods of separating aliphatic hydrocarbon compounds from one another using the metal-organic frameworks of the invention. In certain embodiments, the method comprises contacting a mixture of aliphatic hydrocarbons with a MOF of the invention. In other embodiments, the method comprises running a mixture of aliphatic hydrocarbons through a column at is at least partially filled within a MOF of the invention.

In certain embodiments, the mixture of aliphatic hydrocarbon compounds comprise one or more selected from the group consisting of alkanes, alkenes, and alkynes, including single, double and triple unsaturated compounds. In other embodiments, the aliphatic hydrocarbon compounds are C5-C7 compounds. In yet other embodiments, the aliphatic hydrocarbon compounds are straight chained, branched, or multi-branched compounds.

In certain embodiments, the method comprises running a mixture of aliphatic hydrocarbons comprising n-hexane through a column which is at least partially filled with a MOF of the invention, whereby the n-hexane is separated from the mixture. In other embodiments, the method comprises running a mixture of C6 alkanes through a column comprising a MOF of the invention. In other embodiments, the method comprises running a mixture comprising at least two compounds selected from n-hexane, 2-methylpentane, 3-methylpentane, 2,2-dimethylbutane and 2,3-dimethylbutane through a column comprising a MOF of the invention, whereby the different isomers elute from the column at different times.

In certain embodiments, the aliphatic hydrocarbons are in a gaseous form. In other embodiments, the separation takes place at a temperature from about 30° C. to about 300° C.

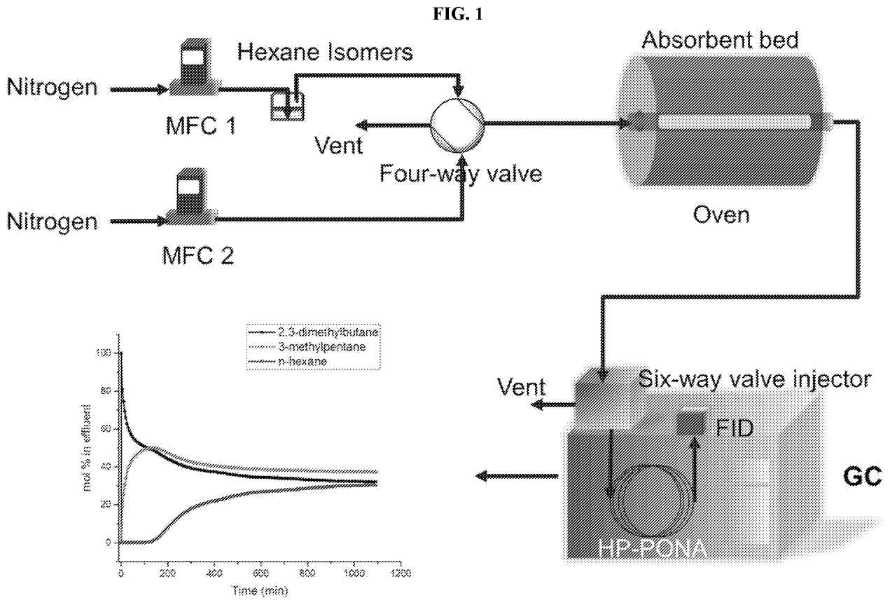

The invention provides a method of separating at least one aliphatic hydrocarbon from a mixture of aliphatic hydrocarbon compounds using a metal organic framework comprising repeating units of Ca²⁺ coordinated to four H₂tcpb ligands in an octahedral fashion (exemplified in FIG. 1A).

In certain embodiments, the method comprises contacting a mixture of aliphatic hydrocarbons with a Ca(H₂tcpb) MOF. In other embodiments, the method comprises running a mixture of aliphatic hydrocarbons through a column that is at least partially filled with a Ca(H₂tcpb) MOF.

In certain embodiments, the mixture of aliphatic hydrocarbons comprises at least one selected from the group consisting of a C₅ alkane, a C₅ alkene, a C₆ alkane, a C₆ alkene, a C₇ alkane, a C₇ alkene, a C₈ alkane, and a C₈ alkene.

In certain embodiments, the mixture of aliphatic hydrocarbons comprises at least one selected from the group consisting of C₅ alkane isomers, C₅ alkene isomers, C₆ alkane isomers, C₆ alkene isomers, C₇ alkane isomers, C₇ alkene isomers, C₈ alkane isomers, and C₈ alkene isomers. In other embodiments, the mixture of aliphatic hydrocarbons comprises at least one selected from the group consisting of saturated hydrocarbons, single unsaturated compounds, double unsaturated compounds, and triple unsaturated compounds. In yet other embodiments, the aliphatic hydrocarbons are straight chained, mono-branched, or multi-branched compounds.

In certain embodiments, the mixture of aliphatic hydrocarbons comprises only hydrocarbons having the same number of carbon atoms (i.e. isomers). In other embodiments, the mixture of aliphatic hydrocarbons comprises hydrocarbons having different numbers of carbon atoms. In certain embodiments, the method provides a means for separating straight chained aliphatic hydrocarbon isomers, mono-branched aliphatic hydrocarbon isomers, and/or multi-branched aliphatic hydrocarbon isomers from one another.

In certain embodiments, the method comprises running a mixture of aliphatic hydrocarbons, comprising the at least one aliphatic hydrocarbon compound to be separated, through a column that is at least partially filled with Ca(H₂tcpb) MOF at a temperature such that the at least one aliphatic hydrocarbon compound in the mixture is preferentially adsorbed by the MOF, while the remaining aliphatic hydrocarbons are not adsorbed (and/or adsorbed to a lower extent that the at least one aliphatic hydrocarbon), thereby separating the at least one aliphatic hydrocarbon from the mixture and/or depleting the content of the at least one aliphatic hydrocarbon in the mixture.

In certain embodiments, the invention provides a method of separating a first and a second aliphatic hydrocarbon compounds from a mixture of aliphatic hydrocarbons containing the first and the second aliphatic hydrocarbon compounds. In certain embodiments, the method comprises (a) running the mixture of aliphatic hydrocarbons through a first column that is at least partially filled with Ca(H₂tcpb) MOF at a first temperature, such that a first aliphatic hydrocarbon in the mixture is preferentially adsorbed by the MOF, while the remaining aliphatic hydrocarbons are not adsorbed (and/or adsorbed to a lower extent that the first aliphatic hydrocarbon), thereby separating the first aliphatic hydrocarbon from the mixture (and/or depleting the content of the first aliphatic hydrocarbon in the mixture). In certain embodiments, the method further comprises (b) running the mixture of aliphatic hydrocarbons isolated in (a) through a second column that is at least partially filled with Ca(H₂tcpb) MOF at a second temperature that is different from the first temperature, such that a second aliphatic hydrocarbon in the mixture is preferentially adsorbed by the MOF while the remaining aliphatic hydrocarbons are not adsorbed (and/or adsorbed to a lower extent that the second aliphatic hydrocarbon), thereby separating the second aliphatic hydrocarbon from the mixture (and/or depleting the content of the second aliphatic hydrocarbon in the mixture). In certain embodiments, the method further comprises optionally repeating step (b) one or more times to separate further additional aliphatic hydrocarbons from the mixture of aliphatic hydrocarbons.

In certain embodiments, the method further comprises collecting the adsorbed, separated hydrocarbons from their respective columns.

In certain embodiments, the aliphatic hydrocarbons are in a gaseous form. In certain embodiments, the aliphatic hydrocarbons are in liquid form. In other embodiments, the first temperature, the second temperature, and any additional temperature are each independently a temperature from about 30° C. to about 350° C.

In certain embodiments, the mixture of aliphatic hydrocarbon isomers is a mixture comprising at least two aliphatic hydrocarbon isomers. In other embodiments, the mixture of aliphatic hydrocarbon isomers is a binary mixture, a ternary mixture, or a quaternary mixture. In yet other embodiments, the mixture of aliphatic hydrocarbon isomers is a mixture comprising 2 to about 18 aliphatic hydrocarbon isomers.

In certain embodiments, the method comprises running a mixture of aliphatic hydrocarbons comprising n-hexane through a column that is at least partially filled with Ca(H₂tcpb) MOF, whereby the n-hexane is separated from the mixture. In other embodiments, the method comprises running a mixture of aliphatic hydrocarbons comprising 2-methylpentane through a column that is at least partially filled with Ca(H₂tcpb) MOF, whereby the 2-methylpentane is separated from the mixture. In other embodiments, the method comprises running a mixture of aliphatic hydrocarbons comprising 3-methylpentane through a column that is at least partially filled with Ca(H₂tcpb) MOF, whereby the 3-methylpentane is separated from the mixture. In other embodiments, the method comprises running a mixture of aliphatic hydrocarbons comprising 2,2-dimethylbutane through a column that is at least partially filled with Ca(H₂tcpb) MOF, whereby the 2,2-dimethylbutane is separated from the mixture. In other embodiments, the method comprises running a mixture of aliphatic hydrocarbons comprising 2,3-dimethylbutane through a column that is at least partially filled with Ca(H₂tcpb) MOF, whereby the 2,3-dimethylbutane is separated from the mixture.

In certain embodiments, the invention provides a method of separating n-hexane, 3-methylpentane and 2,2 dimethylpentane from one another. In certain embodiments, the method comprises (a) running a first mixture comprising n-hexane, 3-methylpentane and 2,2 dimethylpentane through a first column that is at least partially filled with Ca(H₂tcpb) MOF at a first temperature such that n-hexane is preferentially adsorbed by the MOF while the 3-methylpentane and 2,2 dimethylpentane are not adsorbed (or adsorbed to a lower extent that n-hexane), thereby generating a second mixture comprising 3-methylpentane and 2,2 dimethylpentane, wherein the second mixture has a lower content of n-hexane than the first mixture. In certain embodiments, the method comprises (b) running the second mixture through a second column that is at least partially filled with Ca(H₂tcpb) MOF at a second temperature such that the 3-methylpentane is preferentially adsorbed by the MOF while the 2,2 dimethylpentane is not adsorbed (or adsorbed to a lower extent that 3-methylpentane), thereby generating a third mixture comprising 2,2-dimethylpentane, wherein the third mixture has a lower content of 3-methylpentane than the second mixture. In certain embodiments, the method further comprises collecting the separated n-hexane, 3-methylpentane, and 2,2 dimethylpentane.

In certain embodiments, the first temperature is about 30° C. to about 350° C. In certain embodiments, the second temperature is about 30° C. to about 350° C. In other embodiments, the first temperature and the second temperature are different temperatures.

In certain embodiments, the first temperature is about 120° C. In certain embodiments, the second temperature is about 60° C.

### Kits and Devices

The invention also provides kits and devices comprising the MOF of the invention.

In certain embodiments, the invention provides a device comprising a column which is at least partially filled with a MOF of the invention. In other embodiments, the device is adapted and configured to flow a mixture of hydrocarbons through a column which is at least partially filled with a MOF of the invention. In yet other embodiments, the device is adapted and configured to flow the mixture of liquid hydrocarbons through the column under an applied pressure.

In certain embodiments, the device is a fix-bed reactor packed with the MOF of the invention. An exemplary embodiment of a device of the invention is illustrated in FIG. 1.

In certain embodiments, the device is capable of separating aliphatic hydrocarbon isomers from one another.

In certain embodiments, the invention provides a kit comprising a device of the invention. In other embodiments, the kit comprises instructional materials for operating the device. In yet other embodiments, the kit comprises instructional materials for carrying out the methods of the invention.

In one aspect, the invention provides a device for separating aliphatic hydrocarbon compounds from one another.

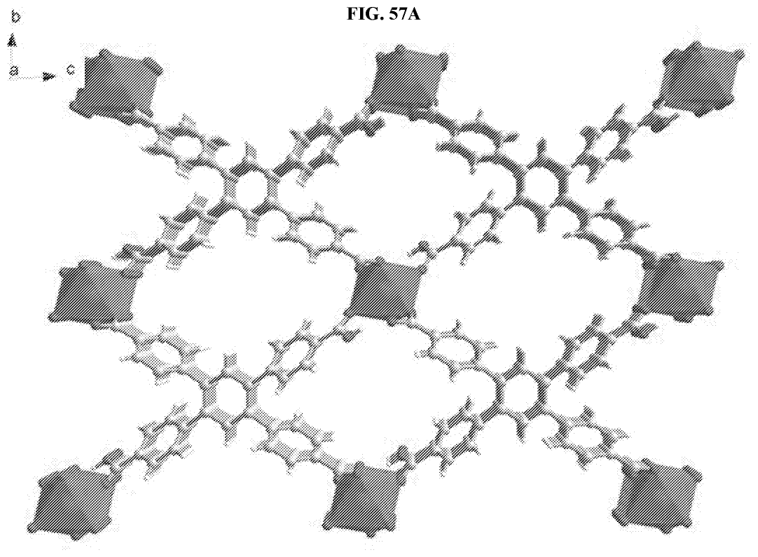

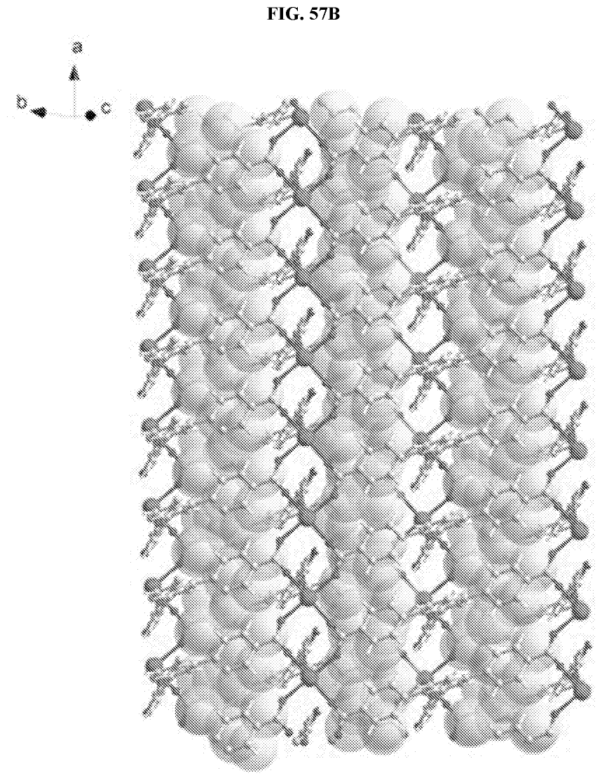

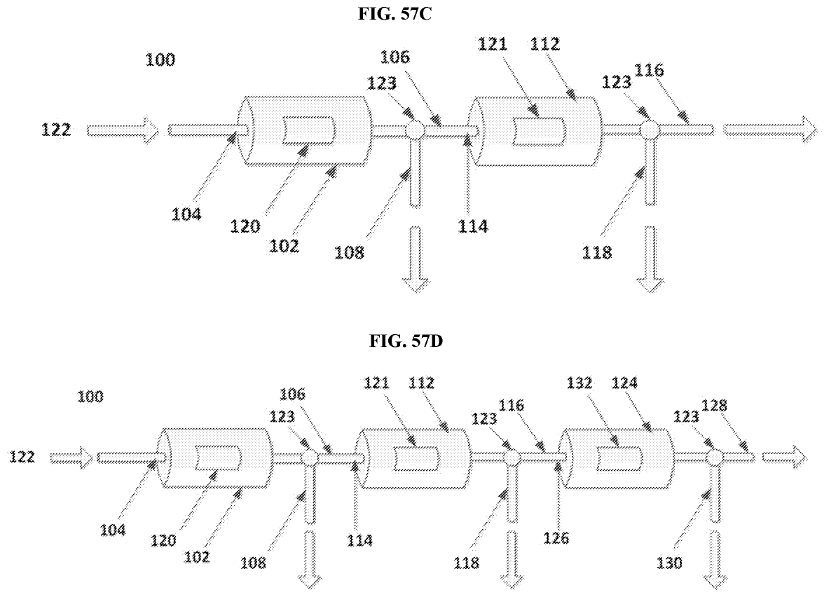

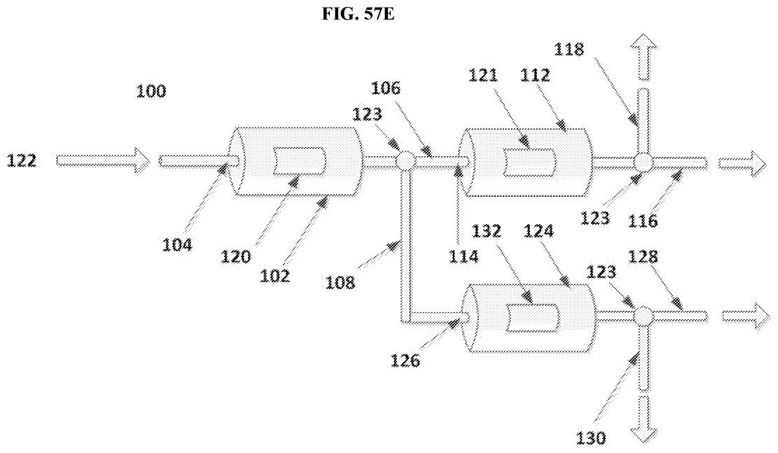

Referring now to FIG. 57C, in certain embodiments, the device 100 comprises at least one of the following:

a first column 102 that is at least partially filled with Ca(H₂tcpb) MOF, the first column 102 comprising an inlet 104, a first outlet 106 and a second outlet 108;

a second column 112 that is at least partially filled with Ca(H₂tcpb) MOF, the second column comprising an inlet 114, a first outlet 116 and a second outlet 118 wherein the inlet 114 of the second column 112 is in in fluidic communication with the first outlet 106 of the first column 102;

a first heating element 120 adapted and configured to regulate the temperature of the first column 102; and

a second heating element 121 adapted and configured to regulate the temperature of the second column 112.

In certain embodiments, the device 100 further comprises a hydrocarbon source 122. In other embodiments, the hydrocarbon source 122 is in fluidic communication with the inlet 104 of the first column 102 and is adapted and configured to supply a hydrocarbon mixture to the inlet 104 of the first column 102. In certain embodiments, the hydrocarbon source 122 is a gaseous hydrocarbon source. In other embodiments, the hydrocarbon source 122 is a liquid hydrocarbon source. In yet other embodiments, the hydrocarbon source 122 is adapted and configured to supply a hydrocarbon mixture comprising at least one carrier gas. In yet other embodiments, the hydrocarbon source 122 is adapted and configured to supply a hydrocarbon mixture that does not comprise at least one carrier gas.

In certain embodiments, the device 100 is adapted and configured such that a hydrocarbon mixture can flow through the inlet 103 of the first column 102, through the first column 102, through the first outlet 106, through the inlet 114 of the second column 112, through the second column 112 and out of the first outlet 116. In other embodiments, the device 100 comprises one or more valves 123 adapted and configured to divert flow from the columns such that the hydrocarbon mixture instead flows to the second outlets 108, 118.

Referring now to FIG. 57D, in certain embodiments, the device 100 further comprises at least one additional column 124 in sequence with the first 102 and second 112 columns. In other embodiments, the device 100 comprises at least one additional column 124 that is at least partially filled with Ca(H₂tcpb) MOF, the additional column 124 comprising an inlet 126, a first outlet 128 and a second outlet 130, wherein the inlet 126 of the additional column 124 is in fluidic communication with the first outlet 116 of the second column 112. In certain embodiments, the device further comprises at least one additional heating element 132 adapted and configured to regulate the temperature of the at least one additional column 124.

Referring now to FIG. 57E, in certain embodiments, the device 100 further comprises at least one additional column 124 in parallel with the second 112 column. In other embodiments, the device 100 comprises at least one additional column 124 that is at least partially filled with Ca(H₂tcpb) MOF, the additional column 124 comprising an inlet 126, a first outlet 128 and a second outlet 130, wherein the inlet 126 of the additional column 124 is in fluidic communication with the second outlet 108 of the first column 112. In certain embodiments, the device further comprises at least one additional heating element 132 adapted and configured to regulate the temperature of at least one additional column 124.

In certain embodiments, the device 100 comprises at least two additional columns 124, each independently disposed in the device 100 in sequence or parallel with the second column 112 and/or any other additional columns 124, such that an outlet of one column is in fluidic communication with an inlet of the next column.

In certain embodiments, the device 100 further comprises a computer. In other embodiments, the computer is a hardware and/or software device in electronic communication with at least one element of the device 100 selected from the group consisting of the first heating element 120, the second heating element 121, the gas source 122, the one or more valves 123, and the at least one additional heating element 132. In certain embodiments, the computer regulates the temperature of the heating elements 120, 121, 132, such that the columns 102, 112, 124 are held at a predetermined temperature. In other embodiments, the computer regulates the flow of gas from the gas source 122 into the inlet 104. In yet other embodiments, the computer regulates and directs flow of gas between the outlets 106, 108, 116, 118, 128, 130 by manipulating the one or more valves 123.

In certain embodiments, the columns 102, 112, 124 are gas tight tubes of substantially any shape or dimension capable of being packed with Ca(H₂tcpb) MOF. In other embodiments, the columns are fix-bed reactors.

In certain embodiments, the device 100 can be used in the methods of the invention to separate a mixture of aliphatic hydrocarbons. In other embodiments, the gas source 122 is capable of feeding a mixture of aliphatic hydrocarbons to the first column 102 wherein the mixture of aliphatic hydrocarbons is one described elsewhere herein. In certain embodiments, the columns 102, 112, 124 are each independently held at a temperature necessary to preferentially adsorb a different hydrocarbon species.

In certain embodiments, the invention provides a kit comprising a device of the invention. In other embodiments, the kit comprises instructional materials for operating the device. In yet other embodiments, the kit comprises instructional materials for carrying out the methods of the invention.

### Definitions

As used herein, each of the following terms has the meaning associated with it in this section.

As used herein, unless defined otherwise, all technical and scientific terms generally have the same meaning as commonly understood by one of ordinary skill in the art to which this invention belongs. Generally, the nomenclature used herein and the laboratory procedures in surface chemistry are those well-known and commonly employed in the art.

As used herein, the articles “a” and “an” refer to one or to more than one (i.e. to at least one) of the grammatical object of the article. By way of example, “an element” means one element or more than one element.

As used herein, the term “about” will be understood by persons of ordinary skill in the art and will vary to some extent on the context in which it is used. As used herein, “about” when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

As used herein, the term “aliphatic” refers to hydrocarbon compounds that are non-aromatic. In certain embodiments, aliphatic hydrocarbons are open-chain hydrocarbons. In other embodiments, aliphatic hydrocarbons are both open-chain and non-aromatic cyclic hydrocarbons. Aliphatic hydrocarbons include hydrocarbons comprising single C—C bonds, double C═C bonds, triple CEC bonds or any combinations thereof. In certain embodiments, aliphatic hydrocarbons can comprise one or more hetero-atoms, including, but not limited to O, N, S, Cl, F, Br, and I. In other embodiments, the aliphatic hydrocarbons comprise only hydrogen and carbon.

As used herein, the term “MOF” refers to a metal-organic framework compound comprising metal ions and/or metal clusters coordinated to organic ligands to form one, two or three-dimensional structures. MOFs often contain pores or voids that extend throughout the framework structure. These pores are often stable and can act as hosts in guest-host interactions with guest molecules.

As used herein, the term “Zeolite 5A (LTA)” and “zeolite 5A” refer to a zeolite Linde Type A material having Ca²⁺ and Na⁺ charge-balancing cations and a pore size of about 5 Å.

As used herein, the terms “UiO-66”, “UiO-67” and “UiO-68” refer to metal-organic framework compounds comprising Zr₆ clusters linked by terephthalic acid (Benzene-1,4-dicarboxylic acid), Biphenyl-4,4′-dicarboxylic acid and p-terphenyl-4,4″-dicarboxylic acid, respectively.

As used herein, the term “Y-fum” refers to a metal-organic framework compound comprising Y₆ clusters linked by fumaric acid.

As used herein, the term “alkenyl,” employed alone or in combination with other terms, means, unless otherwise stated, a stable monounsaturated or di-unsaturated straight chain or branched chain hydrocarbon group having the stated number of carbon atoms. Examples include vinyl, propenyl (or allyl), crotyl, isopentenyl, butadienyl, 1,3-pentadienyl, 1,4-pentadienyl, and the higher homologs and isomers. A functional group representing an alkene is exemplified by —CH₂—CH═CH₂.

As used herein, the term “alkoxy” employed alone or in combination with other terms means, unless otherwise stated, an alkyl group having the designated number of carbon atoms, as defined above, connected to the rest of the molecule via an oxygen atom, such as, for example, methoxy, ethoxy, 1-propoxy, 2-propoxy (isopropoxy) and the higher homologs and isomers. A specific example is (C₁-C₃)alkoxy, such as, but not limited to, ethoxy and methoxy.

As used herein, the term “alkyl,” by itself or as part of another substituent means, unless otherwise stated, a straight or branched chain hydrocarbon having the number of carbon atoms designated (i.e., C₁-C₁₀ means one to ten carbon atoms) and includes straight, branched chain, or cyclic substituent groups. Examples include methyl, ethyl, propyl, isopropyl, butyl, isobutyl, tert-butyl, pentyl, neopentyl, hexyl, and cyclopropylmethyl. A selected example is (C₁-C₆)alkyl, such as, but not limited to, ethyl, methyl, isopropyl, isobutyl, n-pentyl, n-hexyl and cyclopropylmethyl.

As used herein, the term “alkynyl,” employed alone or in combination with other terms, means, unless otherwise stated, a stable straight chain or branched chain hydrocarbon group with a triple carbon-carbon bond, having the stated number of carbon atoms. Non-limiting examples include ethynyl and propynyl, and the higher homologs and isomers. The term “propargylic” refers to a group exemplified by —CH₂—C≡CH. The term “homopropargylic” refers to a group exemplified by —CH₂CH₂—C≡CH. The term “substituted propargylic” refers to a group exemplified by —CR₂—C≡CR′, wherein each occurrence of R′ is independently H, alkyl, substituted alkyl, alkenyl or substituted alkenyl, with the proviso that at least one R′ group is not hydrogen. The term “substituted homopropargylic” refers to a group exemplified by —CR′₂CR′₂—C≡CR′, wherein each occurrence of R′ is independently H, alkyl, substituted alkyl, alkenyl or substituted alkenyl, with the proviso that at least one R′ group is not hydrogen.

As used herein, the term “aromatic” refers to a carbocycle or heterocycle with one or more polyunsaturated rings and having aromatic character, i.e. having (4n+2) delocalized π (pi) electrons, where n is an integer.

As used herein, the term “aryl,” employed alone or in combination with other terms, means, unless otherwise stated, a carbocyclic aromatic system containing one or more rings (typically one, two or three rings) wherein such rings may be attached together in a pendent manner, such as a biphenyl, or may be fused, such as naphthalene. Examples include phenyl, anthracyl, and naphthyl.

As used herein, the term “alkylene” by itself or as part of another substituent means, unless otherwise stated, a straight or branched hydrocarbon group having the number of carbon atoms designated (i.e., C₁-C₁₀ means one to ten carbon atoms) and includes straight, branched chain, or cyclic substituent groups, wherein the group has two open valencies. Examples include methylene, 1,2-ethylene, 1,1-ethylene, 1,1-propylene, 1,2-propylene and 1,3-propylene. Heteroalkylene substituents can a group consisting of the stated number of carbon atoms and one or more heteroatoms selected from the group consisting of O, N, and S, and wherein the nitrogen and sulfur atoms may be optionally oxidized and the nitrogen heteroatom may be optionally quaternized. The heteroatom(s) may be placed at any position of the heteroalkyl group, including between the rest of the heteroalkyl group and the fragment to which it is attached, as well as attached to the most distal carbon atom in the heteroalkyl group.

As used herein, the term “alkenylene”, employed alone or in combination with other terms, means, unless otherwise stated, a stable mono-unsaturated or di-unsaturated straight chain or branched chain hydrocarbon group having the stated number of carbon atoms wherein the group has two open valencies. Heteroalkenylene substituents can a group consisting of the stated number of carbon atoms and one or more heteroatoms selected from the group consisting of O, N, and S, and wherein the nitrogen and sulfur atoms may be optionally oxidized and the nitrogen heteroatom may be optionally quaternized. The heteroatom(s) may be placed at any position of the heteroalkenyl group, including between the rest of the heteroalkenyl group and the fragment to which it is attached, as well as attached to the most distal carbon atom in the heteroalkenyl group.

As used herein, the term “alkynylene”, employed alone or in combination with other terms, means, unless otherwise stated, a stable straight chain or branched chain hydrocarbon group with a triple carbon-carbon bond, having the stated number of carbon atoms wherein the group has two open valencies. Heteroalkynylene substituents can a group consisting of the stated number of carbon atoms and one or more heteroatoms selected from the group consisting of O, N, and S, and wherein the nitrogen and sulfur atoms may be optionally oxidized and the nitrogen heteroatom may be optionally quaternized. The heteroatom(s) may be placed at any position of the heteroalkynyl group, including between the rest of the heteroalkynyl group and the fragment to which it is attached, as well as attached to the most distal carbon atom in the heteroalkynyl group.

As used herein, the term “halide” refers to a halogen atom bearing a negative charge. The halide anions are fluoride (F⁻), chloride (Cl⁻), bromide (Br⁻), and iodide (I⁻).

As used herein, the term “halo” or “halogen” alone or as part of another substituent refers to, unless otherwise stated, a fluorine, chlorine, bromine, or iodine atom.

As used herein, the term “heteroalkenyl” by itself or in combination with another term refers to, unless otherwise stated, a stable straight or branched chain monounsaturated or diunsaturated hydrocarbon group consisting of the stated number of carbon atoms and one or two heteroatoms selected from the group consisting of O, N, and S, and wherein the nitrogen and sulfur atoms may optionally be oxidized and the nitrogen heteroatom may optionally be quaternized. Up to two heteroatoms may be placed consecutively. Examples include —CH═CH—O—CH₃, —CH═CH—CH₂—OH, —CH₂—CH═N—OCH₃, —CH═CH—N(CH₃)—CH₃, and —CH₂—CH═CH—CH₂—SH.

As used herein, the term “heteroalkyl” by itself or in combination with another term refers to, unless otherwise stated, a stable straight or branched chain alkyl group consisting of the stated number of carbon atoms and one or two heteroatoms selected from the group consisting of O, N, and S, and wherein the nitrogen and sulfur atoms may be optionally oxidized and the nitrogen heteroatom may be optionally quaternized. The heteroatom(s) may be placed at any position of the heteroalkyl group, including between the rest of the heteroalkyl group and the fragment to which it is attached, as well as attached to the most distal carbon atom in the heteroalkyl group. Examples include: —O—CH₂—CH₂—CH₃, —CH₂—CH₂—CH₂—OH, —CH₂—CH₂—NH—CH₃, —CH₂—S—CH₂—CH₃, and —CH₂CH₂—S(═O)—CH₃. Up to two heteroatoms may be consecutive, such as, for example, —CH₂—NH—OCH₃, or —CH₂—CH₂—S—S—CH₃.

As used herein, the term “substituted” refers to that an atom or group of atoms has replaced hydrogen as the substituent attached to another group.

As used herein, the term “substituted”, such as in “substituted alkyl”, “substituted alkenyl”, “substituted alkynyl”, “substituted alkylene”, “substituted alkenylene” or “substituted alkynylene” means alkyl, cycloalkyl, alkenyl, alkynyl, alkylene, alkenylene, alkynylene as defined above, substituted by one, two or three substituents selected from the group consisting of C₁-C₁₀ alkyl, halogen, ═O, —OH, alkoxy, tetrahydro-2-H-pyranyl, —NH₂, —N(CH₃)₂, (1-methyl-imidazol-2-yl), pyridin-2-yl, pyridin-3-yl, pyridin-4-yl, —C(═O)OH, trifluoromethyl, —C≡N, —C(═O)O(C₁-C₄)alkyl, —C(═O)NH₂, —C(═O)NH(C₁-C₄)alkyl, —C(═O)N((C₁-C₄)alkyl)₂, —SO₂NH₂, —C(═NH)NH₂, and —NO₂, preferably containing one or two substituents selected from halogen, —OH, alkoxy, —NH₂, trifluoromethyl, —N(CH₃)₂, and —C(═O)OH, more preferably selected from halogen, alkoxy and —OH. Examples of substituted alkyls include, but are not limited to, 2,2-difluoropropyl, 2-carboxycyclopentyl and 3-chloropropyl.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual and partial numbers within that range, for example, 1, 2, 2.7, 3, 4, 5, 5.3, and 6. This applies regardless of the breadth of the range.

### Selected Embodiments

Embodiment 1: A metal-organic framework comprising at least one M⁴⁺ and at least one tetratopic organic linker of formula (I):

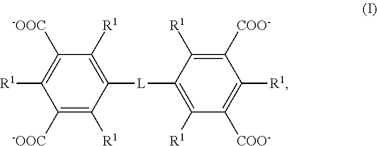

wherein in (I): L is selected from the group consisting of a bond, optionally substituted C1-C6 alkylene, optionally substituted C2-C6 alkenylene, optionally substituted C2-C6 alkynylene, optionally substituted C1-C6 heteroalkylene, optionally substituted C2-C6 heteroalkenylene, optionally substituted C2-C6 heteroalkynylene,

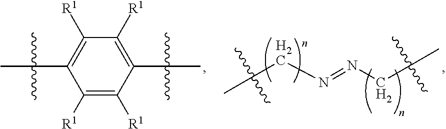

O, S, SO₂, NH and NCH₃; each instance of R¹ is independently selected from the group consisting of H, CH₂, CH₂CH₃, OCH₃, OH, NH₂, F, Cl, Br, I, CF₃, SH, and NO₂; and each instance of n is an integer from 0 to 3.

Embodiment 2: The metal-organic framework of Embodiment 1, wherein M⁴⁺ is a metal selected from the group consisting of Zr⁴⁺, Hf⁴⁺ and Ti⁴⁺.

Embodiment 3: The metal-organic framework of any of Embodiments 1-2, wherein M⁴⁺ is Zr⁴⁺.

Embodiment 4: The metal-organic framework of any of Embodiments 1-3, wherein M⁴⁺ is in the form of a (M⁴⁺)₆ cluster.

Embodiment 5: The metal-organic framework of any of Embodiments 1-4, wherein the (M⁴⁺)₆ cluster comprises at least one μ₃-O bridging ligand, at least one μ₃-OH bridging ligand, and at least one formate bridging ligand.

Embodiment 6: The metal-organic framework of any of Embodiments 1-5, wherein each (M⁴⁺)₆ cluster is bound to 12, 8, or 4 tetratopic organic linkers of formula (I).

Embodiment 7: The metal-organic framework of any of Embodiments 1-6, wherein the at least one linker of formula (I) is a compound selected from the group consisting of:

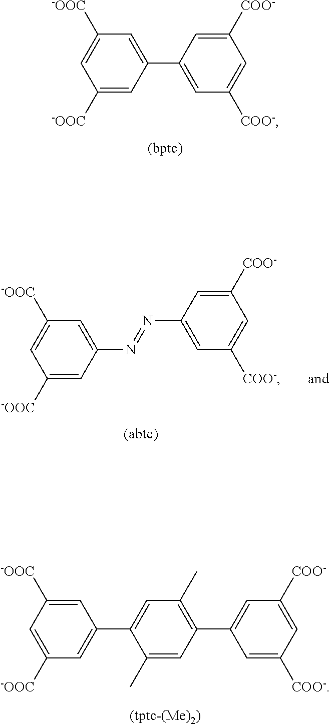

Embodiment 8: The metal-organic framework of any of Embodiments 1-7, wherein the framework has a topology selected from the group consisting of ftw, scu and lvt.

Embodiment 9: The metal-organic framework of any of Embodiments 1-8, wherein the framework crystallizes in a space group selected from the group consisting of space group Im3, space group C2/m, and space group Imma.

Embodiment 10: The metal-organic framework of any of Embodiments 1-9, wherein the framework has a Brunauer-Emmett-Teller (BET) surface area from about 1,000 m²/g to about 1,500 m²/g.

Embodiment 11: The metal-organic framework of any of Embodiments 1-10, wherein the framework has a micropore volume from about 0.35 cm²/g to about 0.50 cm²/g.

Embodiment 12: The metal-organic framework of any of Embodiments 1-11, wherein the framework is thermally stable up to about 400° C.

Embodiment 13: The metal-organic framework of any of Embodiments 1-12, wherein the framework is stable after being heated at up to about 180° C. for 1 month.

Embodiment 14: The metal-organic framework of any of Embodiments 1-13, wherein the framework retains crystallinity in aqueous solutions having a pH from about 2 to about 12.

Embodiment 15: The metal-organic framework of any of Embodiments 1-14, wherein the framework is capable of reversibly adsorbing from about 100 mg/g to about 130 mg/g of aliphatic hydrocarbon (hydrocarbon/MOF).

Embodiment 16: A method of at least partially separating a first aliphatic hydrocarbon compound from at least one distinct aliphatic hydrocarbon compound, the method comprising contacting the first aliphatic hydrocarbon compound and the at least one distinct aliphatic hydrocarbon compound with a metal-organic framework of any of Embodiments 1-15, whereby the first aliphatic hydrocarbon compound and the at least one distinct aliphatic hydrocarbon compound are at least partially separated from one another.

Embodiment 17: The method of any of Embodiment 16, wherein the first aliphatic hydrocarbon compound and the at least one distinct aliphatic hydrocarbon compound are run through a column that is at least partially packed with the metal-organic framework.

Embodiment 18: The method of any of Embodiments 16-17, wherein the first aliphatic hydrocarbon compound and the at least one distinct aliphatic hydrocarbon compound are independently selected from the group consisting of C5-C7 alkanes, C5-C7 alkenes, and C5-C7 alkynes.

Embodiment 19: The method of any of Embodiments 16-18, wherein the first aliphatic hydrocarbon compound and the at least one distinct aliphatic hydrocarbon compound are isomers.

Embodiment 20: The method of any of Embodiments 16-19, wherein the first aliphatic hydrocarbon compound and the at least one distinct aliphatic hydrocarbon compound are C6 isomers.

Embodiment 21: The method of any of Embodiments 16-20, wherein the first aliphatic hydrocarbon compound and the at least one distinct aliphatic hydrocarbon compound are selected from the group consisting of n-hexane, 2-methylpentane, 3-methylpentane, 2,2-dimethylbutane, and 2,3-dimethylbutane.

Embodiment 22: A method of increasing or decreasing the ratio of an aliphatic hydrocarbon in a first fluid mixture comprising the aliphatic hydrocarbon, wherein the method comprises contacting the first fluid mixture with the metal-organic framework of any of Embodiments 1-15 thus originating a second fluid mixture, wherein the second fluid mixture has a higher or lower ratio of the aliphatic hydrocarbon as compared to the first fluid mixture.

Embodiment 23: The method of Embodiment 22, wherein the aliphatic hydrocarbon compound is selected from the group consisting of C5-C7 alkanes, C5-C7 alkenes, and C5-C7 alkynes.

Embodiment 24: The method of any of Embodiments 22-23, wherein the aliphatic hydrocarbon compound and at least one distinct aliphatic hydrocarbon compound in the first fluid mixture are isomers.

Embodiment 25: The method of any of Embodiments 22-24, wherein the aliphatic hydrocarbon compound and the at least one distinct aliphatic hydrocarbon compound in the first fluid mixture are C6 isomers.

Embodiment 26: The method of any of Embodiments 22-25, wherein the aliphatic hydrocarbon compound and the at least one distinct aliphatic hydrocarbon compound in the first fluid mixture are selected from the group consisting of n-hexane, 2-methylpentane, 3-methylpentane, 2,2-dimethylbutane, and 2,3-dimethylbutane.

Embodiment 27: A method of separating a first aliphatic hydrocarbon compound from a mixture of aliphatic hydrocarbons, the method comprising contacting the mixture with a Ca(H₂tcpb) MOF, wherein the first aliphatic hydrocarbon is selectively adsorbed onto the Ca(H₂tcpb) MOF over at least one additional aliphatic hydrocarbon in the mixture, wherein the mixture comprises at least one selected from the group consisting of a C₅ alkane, a C₅ alkene, a C₆ alkane, a C₆ alkene, a C₇ alkane, a C₇ alkene, a C₈ alkane, and a C₈ alkene.

Embodiment 28: The method of Embodiment 27, wherein the mixture comprises at least one selected from the group consisting of C₅ alkane isomers, C₅ alkene isomers, C₆ alkane isomers, C₆ alkene isomers, C₇ alkane isomers, C₇ alkene isomers, C₈ alkane isomers, and C₈ alkene isomers.

Embodiment 29: The method of any of Embodiments 27-28, wherein the mixture comprises at least one selected from the group consisting of saturated hydrocarbons, single unsaturated compounds, double unsaturated compounds, and triple unsaturated compounds.

Embodiment 30: The method of any of Embodiments 27-29, wherein the mixture comprises at least one selected from the group consisting of straight chained, mono-branched and multi-branched compounds.

Embodiment 31: The method of any of Embodiments 27-30, wherein the mixture comprising the first aliphatic hydrocarbon compound is run through a column that is at least partially filled with Ca(H₂tcpb) MOF at a temperature such that the first aliphatic hydrocarbon compound is adsorbed by the MOF while the remaining aliphatic hydrocarbons are not adsorbed or are adsorbed to a lower extent than the first aliphatic compound, thereby separating the first aliphatic hydrocarbon from the mixture.

Embodiment 32: A method of separating a first and a second aliphatic hydrocarbons from a first mixture of aliphatic hydrocarbons, the method comprising: (a) running the first mixture through a first column that is at least partially filled with Ca(H₂tcpb) MOF at a first temperature such that the first aliphatic hydrocarbon in the mixture is adsorbed by the MOF while the remaining aliphatic hydrocarbons in the first mixture are not adsorbed or are adsorbed to a lower extent than the first aliphatic compound, thereby separating the first aliphatic hydrocarbon from the first mixture and generating a second mixture, which is depleted from the first aliphatic hydrocarbon as compared to the first mixture; (b) running the second mixture of aliphatic hydrocarbons through a second column that is at least partially filled with Ca(H₂tcpb) MOF at a second temperature that is different from the first temperature such that a second aliphatic hydrocarbon in the mixture is adsorbed by the MOF while the remaining aliphatic hydrocarbons in the second mixture are not adsorbed or are adsorbed to a lower extent than the second aliphatic compound, thereby separating the second aliphatic hydrocarbon from the second mixture and generating a third mixture, which is depleted from the second aliphatic hydrocarbon as compared to the second mixture; and (c) optionally repeating step (b) one or more times to separate further additional aliphatic hydrocarbons from the third mixture.

Embodiment 33: The method of Embodiments 32, wherein the first mixture comprises at least two selected from the group consisting of a C₅ alkane, a C₅ alkene, a C₆ alkane, a C₆ alkene, a C₇ alkane, a C₇ alkene, a C₈ alkane, and a C₈ alkene.

Embodiment 34: The method of any of Embodiments 32-33, wherein the first mixture comprises at least one selected from the group consisting of C₅ alkane isomers, C₅ alkene isomers, C₆ alkane isomers, C₆ alkene isomers, C₇ alkane isomers, C₇ alkene isomers, C₈ alkane isomers, and C₈ alkene isomers.

Embodiment 35: The method of any of Embodiments 32-34, wherein the first mixture comprises at least one selected from the group consisting of saturated hydrocarbons, single unsaturated compounds, double unsaturated compounds, and triple unsaturated compounds.

Embodiment 36: The method of any of Embodiments 32-35, wherein the first mixture comprises at least one selected from the group consisting of straight chained, mono-branched and multi-branched compounds.

Embodiment 37: The method of any of Embodiments 32-36, wherein the first mixture is a mixture of aliphatic hydrocarbon isomers.

Embodiment 38: The method of any of Embodiments 32-37, further comprising collecting the adsorbed, separated first aliphatic hydrocarbon from the first column and/or the adsorbed, separated second aliphatic hydrocarbon from the second column.

Embodiment 39: The method of any of Embodiments 27-38, wherein the mixture is a gaseous mixture.

Embodiment 40: A device for separating aliphatic hydrocarbon compounds from one another, the device comprising: a first column that is at least partially filled with Ca(H₂tcpb) MOF, the first column comprising an inlet, a first outlet, and a second outlet; a second column that is at least partially filled with Ca(H₂tcpb) MOF, the second column comprising an inlet, a first outlet, and a second outlet, wherein the inlet of the second column is in in fluidic communication with the first outlet of the first column; a first heating element adapted and configured to regulate the temperature of the first column; and a second heating element adapted and configured to regulate the temperature of the second column.

Embodiment 41: The device of Embodiment 40, further comprising a hydrocarbon source in fluidic communication with the inlet of the first column, wherein the gas source is adapted and configured to supply a hydrocarbon mixture to the inlet of the first column.

Embodiment 42: The device of any of Embodiments 40-41, further comprising at least one additional column comprising a first inlet, a first outlet and a second outlet, wherein the inlet of the additional column is in fluidic communication with the first outlet of the second column, and wherein the at least one additional column is at least partially filled with Ca(H₂tcpb) MOF.

Embodiment 43: The device of any of Embodiments 40-42, further comprising at least one additional column comprising a first inlet, a first outlet and a second outlet, wherein the inlet of the additional column is in fluidic communication with the second outlet of the first column, and wherein the at least one additional column is at least partially filled with Ca(H₂tcpb) MOF.

Embodiment 44: The device of any of Embodiments 40-43, further comprising at least one additional heating element adapted and configured to regulate the temperature of the additional column.

Embodiment 45: A kit comprising a device of any of Embodiments 40-44 and instructional materials for operating the device.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. Although the description herein contains many embodiments, these should not be construed as limiting the scope of the invention but as merely providing illustrations of some of the presently preferred embodiments of the invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application. In general the terms and phrases used herein have their art-recognized meaning, which can be found by reference to standard texts, journal references and contexts known to those skilled in the art. Any preceding definitions are provided to clarify their specific use in the context of the invention.

The following examples further illustrate aspects of the present invention. However, they are in no way a limitation of the teachings or disclosure of the present invention as set forth herein.

### Examples

The invention is now described with reference to the following Examples. These Examples are provided for the purpose of illustration only, and the invention is not limited to these Examples, but rather encompasses all variations that are evident as a result of the teachings provided herein.

### Materials

All reagents were used as received unless otherwise specified.

### Nuclear Magnetic Resonance Measurement

Nuclear magnetic resonance (NMR) data were collected on a 400 MHz Oxford NMR or a 300 MHz Oxford NMR unit.

### Single-Crystal Synchrotron X-Ray Diffraction Analysis

Single-crystal synchrotron X-ray diffraction data of Compounds 2 and 3 were collected at 150 K on a D8 goniostat equipped with a Bruker PHOTON100 CMOS detector at Beamline 11.3.1 at the Advanced Light Source (ALS) in Lawrence Berkeley National Laboratory, using synchrotron radiation tuned to λ=0.7749 Å. The structure was solved by direct methods and refined by full-matrix least-squares on F² using the Bruker SHELXTL package.

### Powder X-Ray Diffraction (PXRD) Analysis

Powder X-ray diffraction (PXRD) analysis was carried out on a Rigaku Ultima-IV automated diffraction system using Cu Kα radiation (λ=1.5406 Å). The data were collected at room temperature in a 20 range of 3-40° with a scan speed of 2°/min. The operating power was 40 kV/40 mA.

### Thermogravimetric Analysis

Thermogravimetric analyses (TGA) of samples were performed using the TA Instrument Q5000IR thermal gravimetric analyzer with nitrogen flow and sample purge rate at 10 ml/min and 25 ml/min respectively. About 3-5 mg of sample was loaded onto a platinum sample pan and heated from room temperature to 600° C. at a rate of 10° C./min under nitrogen flow.

### Gas Adsorption Measurements

N₂ adsorption at 77 K was performed on a Micromeritics 3Flex adsorption analyzer. Prior to each measurement, ˜100 mg of solvent exchanged sample was activated under dynamic vacuum overnight (300° C. for compound 1 and 150° C. for compounds 2 and 3).

### Hydrocarbon Adsorption Measurements

Hydrocarbon adsorption measurements were performed on a gravimetric vapor adsorption analyzer modified from a TGA Q50 (TA Instruments). Ultra-high pure N₂ (99.999%) was used as a carrier gas passing through a bubbler filled with liquid hydrocarbon. The partial pressure of hydrocarbon was controlled by adjusting the blend ratio of pure N₂ and N₂ saturated with hydrocarbon vapor. Adsorbed amount was monitored by the weight change of the sample. For a typical measurement, ˜20 mg sample was first activated at its outgassing temperature (300° C. for compound 1 and 180° C. for compound 2; 200° C. otherwise) under pure N₂ flow for 2 hours to remove the initial solvent residing in the pores. The temperature was then cooled to adsorption temperature (30, 60, 90, 120, or 150° C.) and hydrocarbon vapor was introduced to the adsorption chamber, where N₂ was used as carrier gas passing through a bubbler filled with liquid hydrocarbon adsorbate and then went through a condenser (maintained at 18° C.) before being mixed with another pure N₂ flow and finally introduced to the furnace where adsorption takes place. The condenser guarantees that the hydrocarbon stream was saturated at 18° C. Hydrocarbon partial pressure was controlled by adjusting the flow rate of saturated hydrocarbon vapor in N₂ and the other N₂ flow. Mass of the adsorbent was recorded over the experiment period.

### Multicomponent Breakthrough Measurements

### For Examples 1-7

The breakthrough experiment was conducted using a lab-scale fix-bed reactor at 303 K and 423 K (FIG. 1). In a typical experiment, the powder was activated at 453 K or 623 K for 3 h. Then 1.0 g of material was packed into a quartz column (5.8 mm I.D.×150 mm) with silane treated glass wool filling the void space. A nitrogen gas flow (1 cm³/min) was used to purge the adsorbent. The flow of nitrogen gas was then turned off while another dry N₂ at a rate of 1 mL/min bubbled through a mixture of hexane isomers according to the following volumes: 3.50 mL of 2,3-dimethylbutane, 4.22 mL of 3-methylpentane and 5.82 mL of n-hexane. The effluent from the column was monitored using an online GC equipped with HP-PONA column and FID.

### For Examples 8-10

The two-column breakthrough experiment was conducted using two lab-scale fix-bed reactors at 120° C. and 60° C., respectively. Similarly, a one-column breakthrough measurement was performed with a lab-scale fix-bed reactor at 120 or 60° C. In a representative experiment, 0.25 g of MOF material was packed into a quartz column (5.8 mm I.D.×150 mm) with silane treated glass wool filling the void space. A nitrogen flow (1 mL/min) was used to purge the adsorbent. The MOF powder was activated at 200° C. overnight and the flow of nitrogen was then turned off while a separate dry nitrogen flow was bubbled through a mixture of hexane isomers at a rate of 1 mL/min according to the following volumes (the volumes were determined through trial and error and calculated by gas chromatography (GC): the experiment was run without any sample and the vapor phase ratios were optimized to an equimolar mixture): 5.84 mL of nHEX, 4.12 mL of 3MP, and 2.57 mL of 22DMB for nHEX/3MP/22DMB ternary mixture (partial pressure of each component is 49 torr), 7.56 mL of nHEX and 4.22 mL of 3MP for nHEX/3MP binary mixture (partial pressure of each component is 72 torr), 4.22 mL of 3MP, and 2.47 mL of 22DMB for 3MP/22DMB binary mixture (partial pressure of each component is 78 torr). For humid conditions, another nitrogen flow bubbling through a water bubbler was mixed with the 3MP/22DMP binary mixture (partial pressure of each alkane component is 39 torr). The effluent from the column was monitored using an online gas chromatogram (GC) equipped with HP-PONA column and FID.

### For Examples 1-10

The absolute adsorbed amount of gas i (qᵢ) is calculated from the breakthrough curve by the equation:

$${q}_{i} = \frac{{F}_{i} \times {t}_{0} - {V}_{dead} - {\int }_{0}^{{t}_{0}} {F}_{e} Δ t}{m}$$

where Fᵢ is the influent flow rate of the specific gas (cm³/min); t₀ is the adsorption time (min); V_{dead} is the dead volume of the system (cm³); Fₑ is the effluent flow rate of the specific gas (cm³/min); and m is the mass of the sorbent (g). The real time RON of the effluent is calculated according to reported literature (Peralta, et al., 2012, Ind. Eng. Chem. Res. 51:4692-4702).

### Synthesis of H₄bptc

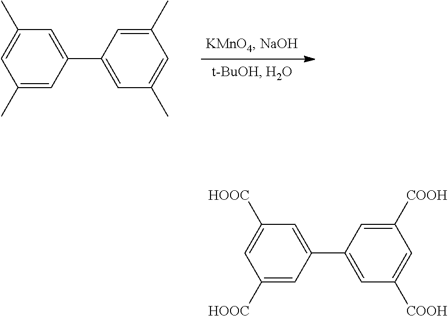

The synthesis of H₄bptc was carried out according to reported procedure with slight modifications³. 3,3′5,5′-tetramethylbiphenyl (5.0 g, 0.023 mol), NaOH (2.0 g, 0.05 mol) were mixed in t-BuOH/H₂O (100/100 mL) with stirring at 50° C. KMnO₄ (43.0 g, 0.27 mol) was added in portions over one week. The temperature was subsequently increased to 70° C. and kept for 2 days. The mixture was filter when hot and the clear filtrate was added into 100 mL 6M HCl. White solid was obtained upon filtration. The crude product was recrystallized from DMF (˜100 mL) to give pure H₄bptc with a yield 82%.

### Synthesis of H₄abtc

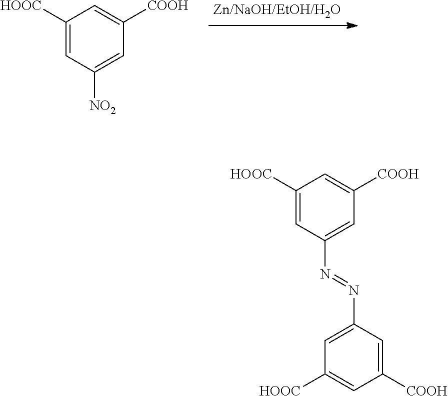 [SMILES: O=C(O)c1cc(C(=O)O)cc([N+](=O)[O-])c1 ; O=C(O)c1cc(/N=N/c2cc(C(=O)O)cc(C(=O)O)c2)cc(C(=O)O)c1]

H₄abtc was synthesized according to the following procedure. 5-nitroisophthalic acid (2.1 g, 0.01 mol), NaOH (3.2 g, 0.08 mol), Zinc powder (2.1 g, 0.04 mol) were mixed in ethanol/H₂O (50/20 mL). The mixture was kept under refluxing for 12 hours before cooled to room temperature. Yellow solid was obtained through vacuum filtration which was then dissolved in 80 mL 1M NaOH solution. Upon filtration, the filtrate was acidified with 6 M HCl to get orange solid. The crude product was recrystallized from DMF to give pure H₄abtc as orange solid (1.3 g, yield: 73%).

Synthesis of H₄tptc-(Me)₂

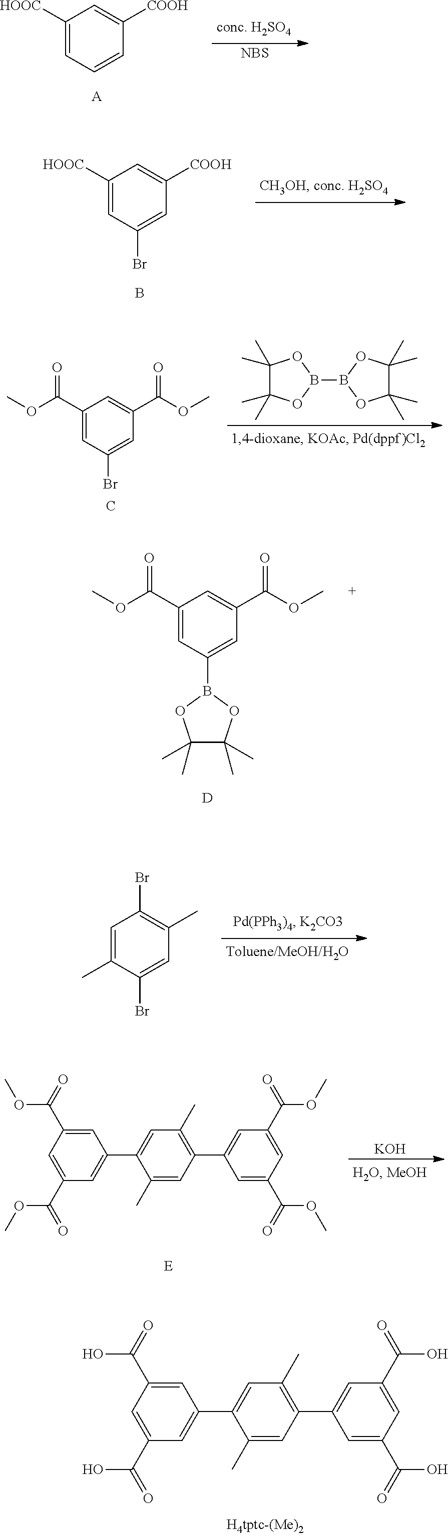

A to B: A (14.0 g, 0.084 mol) was dissolved in 40 mL conc. H₂SO₄ at 60° C. under stirring. N-Bromosuccinimide (NBS, 16 g, 0.090 mol) was added to the reaction in portions over 1 hour and the mixture was stirred at 60° C. for an additional hour. After the reaction was completed, the mixture was poured into 200 g crushed ice and stirred at room temperature for 1 hour. Light yellow solid was obtained by filtration and washed with DI water (100 mL). The crude product was recrystallized from ethyl acetate to give pure B (12 g, 59% yield). B to C: B (8 g, 0.033 mol) was dissolved in 120 mL methanol under stirring and 6 mL conc. H₂SO₄ was subsequently added to the mixture. The reaction was heated to reflux for 24 hours. After cooling down to room temperature the solvent was removed through rotovap. The obtained solid was dispersed in 40 mL DI water and the aqueous phase was extracted by dichloromethane (40 mL×3). The combined organic layer was washed with saturated NaHCO₃ and brine and dried over MgSO₄. Crude product was obtained upon removal of the solvent which was recrystallized from methanol to give pure C (8.3 g, 91% yield). C to D: C (3.3 g, 0.012 mol), bis(pinacolato)diboron (3.4 g, 0.013 mol), dried potassium acetate (3.6 g), [1,1′-Bis(diphenylphosphino)ferrocene]palladium(II) dichloride (Pd(dppf)Cl₂, 0.2 g, 0.27 mol) were mixed in a 250 mL flask and evacuated for 1 hour before 100 mL dried, degassed 1,4-dioxane was added. The reaction was stirred at 80° C. under nitrogen atmosphere for 24 hours. After the reaction was completed, organic solvent was removed by rotovap and the remained solid was extracted with dichloromethane. The crude product was purified through a silica plug with a eluent of petroleum ether:ethyl acetate=8:1 to give pure D as a white solid (3.5 g, 90% yield).

D to E: D (2.0 g, 6.3 mmol), 2,5-dibromo-p-xylene (0.6 g, 2.3 mmol), tetrakis (triphenylphosphine) palladium(0) (150 mg, 0.15 mmol) and potassium carbonate (760 mg, 5.5 mmol) were mixed in a 100 mL flask and evacuated for 1 hour before 40 mL degassed toluene-methanol-water (v:v:v=20:10:10) mixed solvent was added. The reaction was heated to reflux for 3 days. The reaction was cooled to room temperature when it was completed and organic solvent was removed by rotary evaporation. 50 mL DI water was added to the residue which was extracted by dichloromethane for 3 times with 50 mL each time. The organic phase was combined and washed with water and brine and dried over anhydrous MgSO₄. After removal of organic solvent, the crude product was washed with a mixed solvent of acetone/dichloromethane (v/v=9/1) several times (10 mL×5) to give pure compound E (0.68 g, 60% yield).

E to H4tptc-2Me: E (0.5 g, 1 mmol) was dissolved in a mixture of 30 mL THF and 30 mL 3M KOH aqueous solution. The mixture was heated to reflux for 12 hours. After removal of THF, the remaining clear solution was added dropwise to excess 6M HCl solution. The white precipitate was collected by centrifuge and washed with DI water until it is neutral. The resultant solid was dried at 80° C. under vacuum to give pure H₄-tptc-2Me (0.4 g, 92% yield).

### Synthesis of H₄tcpb

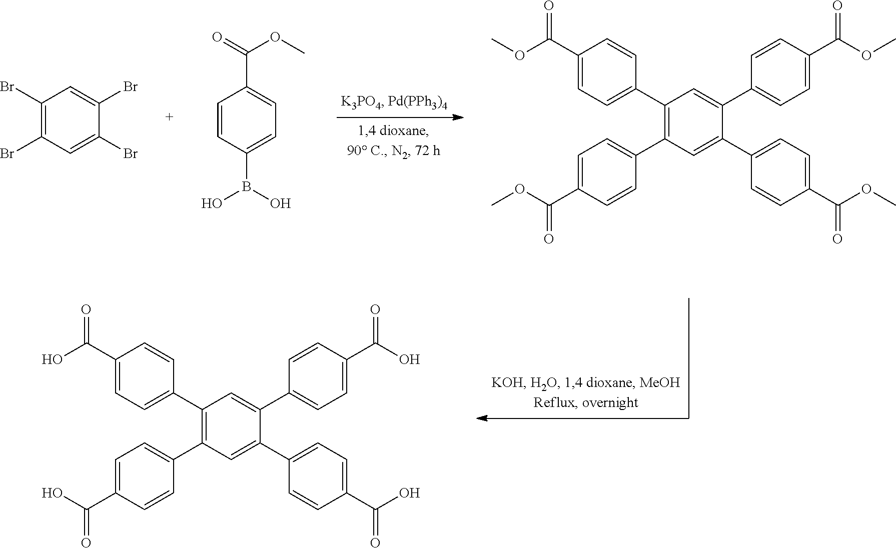

H₄tcpb was synthesized through Suzuki coupling reactions and subsequent hydrolysis. Briefly, 1,2,4,5-tetrabromobenzene (1.97 g, 5 mmol), 4-Methoxycarbonylphenylboronic acid (5.4 g, 30 mmol), K₃PO₄ (6.36 g, 30 mmol), and Pd(PPh₃)₄ (0.578 g, 0.5 mmol) were mixed in degassed 1,4-dioxane (200 mL). The mixture was heated at 90° C. under nitrogen atmosphere for 3 days. After the reaction was complete, organic solvent was removed by rotovap and 100 mL of water was added to the solid residual which was extracted by dichloromethane (3×50 mL). The organic phase was combined and dried over MgSO₄ overnight. The organic solvent was removed in vacuo to give the crude product which was purified by column chromatography (eluent: Hexane/ethyl acetate=4:1 and then dichloromethane). The obtained ester was hydrolyzed in a mixture of KOH aqueous solution (3M, 50 mL), 1,4-dioxane (50 mL), and methanol (50 mL) by reflux overnight to give pure form of H₄tcpb (2.1 g, Yield: 75%). ¹H NMR (DMSO-d₆, 300 MHz): 7.35 (d, 8H), 7.56 (s, 2H), 7.84 (d, 8H), 12.97 (s, 4H).

### Synthesis of Ca(H₂tcpb)

CaCl₂ (90 mg) and H₄tcpb (90 mg) were added to ethanol (10 mL) and the mixture was stirred at room temperature for 2 hours before being transferred to a 20 mL Teflon bomb. The bomb was placed at an oven preset at 100° C. for 3 days. Colorless crystals were obtained after the reaction was cooled to room temperature (Yield: 25% based on the organic ligand).

### Synthesis of Compound 1

Zirconium (IV) oxychloride octahydrate (ZrOCl₂.8H₂O, 32.2 mg, 0.1 mmol) was ultrasonically dissolved in a mixed solvent of N,N-dimethylformamide (DMF, 5 mL) and formic acid (5 mL) in a 20 mL scintillation vial. H₄bptc (33 mg, 0.1 mmol) was then added to the solution which was sonicated for 5 min before being moved to a preheated oven at 120° C. The reaction was kept at 120° C. for 3 days, and microcrystalline white powder was obtained through centrifuge. The materials were washed with DMF and methanol with a Soxhlet extractor for 2 and 3 days, respectively prior to adsorption study. Yield: 68% (based on Zr). The same crystalline phase was obtained when the ratio for DMF:formic acid (v:v) is between 0 to 1.5 (total volume is 10 mL), beyond which the reaction generated an amorphous gel. Teflon lined vessels were used for all reactions when the ratio was less than 1 to prevent evaporation of the solvent.

Crystal data and structure refinement of compound 1

| Formula | Zr₆O₄(OH)₄(bptc)₃ |
|---|---|
| Empirical Formula | C₄₈H₁₈O₃₂Zr₆ |
| Wavelength | 1.5406 Å Cu—Kα₁ |
| Crystal system | Cubic |
| Space group | Im-3 |
| Unit cell dimensions | a = 24.3597 (3) Å |
| Volume | 14455.0 (5) Å³ |
| Z | 8 |
| 2Theta range for | 5° < 2θ < 70° |
| data refinement | |
| Number of parameters | 30 |
| Number of data points | 5000 |
| Number of restrains | 6 for Zr—O bond distances, |
| | 10 for O—Zr—O bond angles, |
| | 4 for C—O bond distances, |
| | 2 for C—C bond distances |
| Refinement method | Rietveld refinement |
| Rₚ/R_{wp}/Rₑₓₚ | 0.0391/0.0586/0.0273 |
| R_{B} | 0.0381 |

### Synthesis of Compound 2

Zirconium (IV) oxychloride octahydrate (ZrOCl₂.8H₂O, 32.2 mg, 0.1 mmol) was ultrasonically dissolved in a mixed solvent of N,N-dimethylformamide (DMF, 8 mL) and formic acid (6 mL) in a 20 mL scintillation vial. H₄abtc (35.8 mg, 0.1 mmol) was then added to the solution which was sonicated for 5 min before being moved to a preheated oven at 120° C. The reaction was kept at 120° C. for 3 days, and light orange solids were observed in the reaction glass vial upon cooling. These solids are either microcrystalline or crystals large enough for single crystal X-ray diffraction analysis. The solid samples were collected by centrifuge (or vacuum filtration). The materials were washed with DMF and methanol with a Soxhlet extractor for 2 and 3 days, respectively prior to adsorption study. Yield: 74% (based on Zr). Compound 2 remained to be the only phase for the DMF:formic acid ratio (v:v) between 0 to 1.4 (total volume is 14 mL). Similar to the synthesis of compound 1, an amorphous gel would form beyond this range. Teflon lined vessels were used for all reactions where the ratio was less than 1.

Crystal data and structure refinement for compound 2

| Formula | Zr₆O₄(OH)₄(abtc)₂(OH)₄(H₂O)₄ | |
|---|---|---|
| Empirical formula | C32 H20 N4 O32 Zr6 | |
| Formula weight | 1519.84 | |
| Temperature | 100(2) K | |
| Wavelength | 0.7749 Å | |
| Crystal system | Monoclinic | |
| Space group | C2/m | |
| Unit cell dimensions | a = 25.4692(11) Å | α = 90°. |
| | b = 36.3589(15) Å | β = 122.260(2)°. |
| | c = 21.5275(9) Å | γ = 90°. |

| | |
|---|---|
| Volume | 16857.8(13) Å³ |
| Z | 8 |
| Density (calculated) | 1.198 Mg/m³ |
| Absorption coefficient | 0.965 mm⁻¹ |
| F(000) | 5888 |
| Crystal size | 0.130 × 0.020 × 0.020 mm³ |
| Theta range for data collection | 2.397 to 27.868°. |
| Index ranges | −30 ≤ h ≤ 25, 0 ≤ k ≤ 43, 0 ≤ l ≤ 25 |
| Reflections collected | 94479 |
| Independent reflections | 22502 [R(int) = 0.1156] |
| Completeness to theta = 27.706° | 98.6% |
| Absorption correction | Semi-empirical from equivalents |
| Max. and min. transmission | 0.981 and 0.612 |
| Refinement method | Full-matrix least-squares on F² |
| Data/restraints/parameters | 22502/1202/678 |
| Goodness-of-fit on F² | 1.027 |
| Final R indices [I > 2sigma(I)] | R1 = 0.0848, wR2 = 0.2296 |
| R indices (all data) | R1 = 0.1311, wR2 = 0.2742 |
| Extinction coefficient | n/a |
| Largest diff. peak and hole | 2.918 and −1.470 e · Å⁻³ |

### Synthesis of Compound 3

Zirconium (IV) oxychloride octahydrate (ZrOCl₂.8H₂O, 32.2 mg, 0.1 mmol) was ultrasonically dissolved in a mixed solvent of N,N-dimethylformamide (DMF, 8 mL) and formic acid (4.5 mL) in a 20 mL scintillation vial. H₄tptc-(Me)₂ (21.7 mg, 0.05 mmol) was then added to the solution which was sonicated for 5 min before being moved to a preheated oven at 120° C. The reaction was kept at 120° C. for 3 days and colorless crystals were obtained through centrifuging. Yield: 55% (based on Zr). The same crystalline phase was obtained when the amount of formic acid was between 3.5-4.5 mL (8 mL DMF), beyond which either an amorphous gel (less acid) or a clear solution (more acid) was observed.

Crystal data and structure refinement for compound 3

| Formula | Zr₆O₄(OH)₄(tptc-(Me)₂)(HCOO)₄(OH)₄(H₂O)₄ | |
|---|---|---|
| Empirical formula | C14 H17 O16 Zr3 | |
| Formula weight | 714.93 | |
| Temperature | 100(2) K | |
| Wavelength | 0.7749 Å | |
| Crystal system | Orthorhombic | |
| Space group | Imma | |
| Unit cell dimensions | a = 25.2379(14) Å | α = 90°. |
| | b = 27.7529(16) Å | β = 90°. |
| | c = 15.2344(10) Å | γ = 90°. |

| | |
|---|---|
| Volume | 10670.6(11) Å³ |
| Z | 8 |
| Density (calculated) | 0.890 Mg/m³ |
| Absorption coefficient | 0.757 mm⁻¹ |
| F(000) | 2792 |
| Crystal size | 0.200 × 0.070 × 0.040 mm³ |
| Theta range for data collection | 2.337 to 22.990°. |
| Index ranges | −25 ≤ h ≤ 25, −27 ≤ k ≤ 27, −15 ≤ l ≤ 15 |
| Reflections collected | 21998 |
| Independent reflections | 2981 [R(int) = 0.0642] |
| Completeness to theta = 22.990° | 98.2% |
| Refinement method | Full-matrix least-squares on F² |
| Data/restraints/parameters | 2978/275/172 |
| Goodness-of-fit on F³ | 3.131 |
| Final R indices [I > 2sigma(I)] | R1 = 0.1484, wR2 = 0.3954 |
| R indices (all data) | R1 = 0.1896, wR2 = 0.4420 |
| Extinction coefficient | n/a |
| Largest diff. peak and hole | 4.545 and −1.103 e · Å⁻³ |

### Synthesis of UiO-66 and UiO-67

UiO-66 and UiO-67 were synthesized according to procedures reported in Cavka, et al., 2008, J. Am. Chem. Soc. 130:13850-13851. Briefly ZrCl₄ (0.1 mmol) and the corresponding ligand (0.1 mol) were dissolved in 15 mL DMF and heated at 120° C. for 24 hours. Crystalline powder was collected by centrifuge. Phase purity was confirmed by PXRD analysis.

### Synthesis of Y-fum

Y-fum was synthesized according to procedures reported in Assen, et al., 2015, Angew. Chem. Int. Ed. 54:14353-14358 Briefly Y(NO₃)₃.6H₂O (0.1 mmol), fumaric acid (0.1 mmol), and 2-fluorobenzoic acid (0.15 mmol) were dissolved in 2.7 mL DMF and 0.7 mL water and the mixture was heated at 120° C. for 3 days. Crystals were obtained by filtration. Phase purity was confirmed by PXRD analysis.

### Computational Modelling

Ab initio modeling was performed at the density functional theory (DFT) level with VASP, using the PBE exchange-correlation functional. PAW pseudopotentials were implemented with an energy cutoff of 600 eV, and only the F point was used. Due to the size of compound 1, appropriate cut outs of the MOF were taken directly from the experimental CIF file to perform the DFT calculations. In order to find temperature dependent energy barriers, ab initio molecular dynamics (AIMD) calculations using a Verlet algorithm were performed; corresponding energy barriers were then calculated via appropriate energy differences as explained in the text. For consistency and comparison purposes, ground-state energy barriers were also calculated in the same way as in the AIMD. The AIMD trajectories were run for a total of 800 fs and data was collected after a 200 fs thermalization period.

### IR Spectroscopy Study

For in situ IR absorption measurements of the C6 isomers in compound 2, 2 mg of the MOF powder was pressed onto a tungsten mesh (diameter of 1.2 cm and 1 mm thick). The sample was placed into an environmental cell at the focal point of the sample compartment of the infrared spectrometer. The cell was connected to a vacuum line for evacuation (base pressure of 20 mTorr). The samples were activated under vacuum (20 mTorr) at 150° C. until the IR spectra did not show any more changes (complete loss of water vapor). A pressure of 10 Torr was established for each of the dry C6 isomers vapors (nHEX, 3MP, or 23DMB) in the cell and all spectra were recorded in transmission at 30° C. between 400 and 4000 cm⁻¹ (4 cm⁻¹ spectral resolution, sufficient for the inhomogeneous widths of >10 cm⁻¹). The gas evacuation and desorption from the MOF were monitored as a function of time after pumping was initiated.

### PXRD Measurement on the Alkane Loaded Ca(H₂Tcpb)

˜20 mg of as synthesized MOF was activated at 150° C. on a TGA for 30 minutes. The activated sample was immersed in 5 mL of alkane (nHEX, 3MP, or 22DMB) overnight. The solid was pipetted out for PXRD measurement.

### Example 1: Synthesis and Crystal Structure

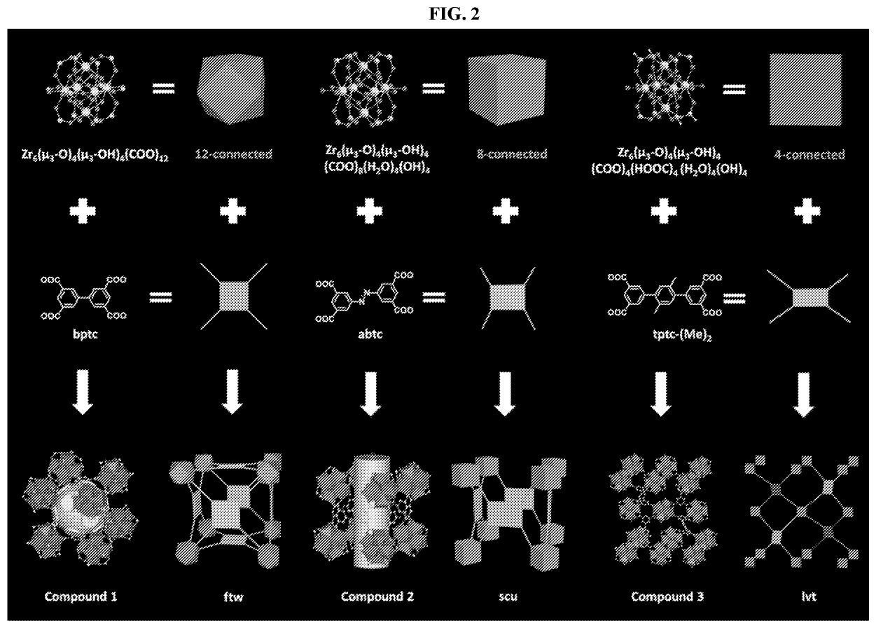

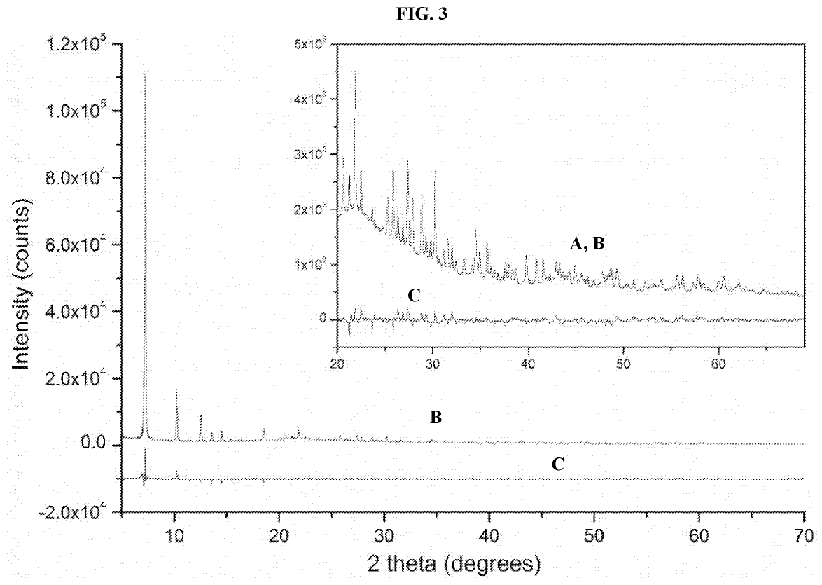

Three crystalline materials, Zr₆(μ₃-O)₄(μ₃-OH)₄(bptc)₃ (Zr-bptc or compound 1), Zr₆(μ₃-O)₄(μ₃-OH)₄(abtc)₂(OH)₄(H₂O)₄ (Zr-abtc or compound 2) and Zr₆(μ₃-O)₄(μ₃—OH)₄(tptc-(Me)₂)(HCOO)₄(OH)₄(H₂O)₄ (Zr-tptc-(Me)₂ or compound 3) were synthesized by solvothermal reactions. Compounds 2 and 3 were structurally characterized by single crystal X-ray diffraction (SCXRD) analysis, while the crystal structure of compound 1 was determined via powder refinement (FIGS. 2-3).

Compound 1 crystallized in cubic crystal system (space group Im3) and features 4,12-c ftw topology. The structure displayed 12-connected Zr₆(μ₃-O)₄(μ₃-OH)₄(COO)₁₂ SBUs, linked together through 4-connected bptc⁴⁻ ligands to form a 3D framework (FIG. 4). The SBU was composed of six Zr atoms assembled into an octahedron where the eight facets are occupied by μ₃-O²⁻ or μ₃-OH⁻ anions. Each Zr atom was coordinated to eight O atoms, four of which belong to four different bptc⁴⁻ ligands and the remaining four are from μ₃-O²/OH⁻ groups. Each bptc⁴⁻ linker was connected to four different SBUs with each carboxylate coordinated by two adjacent Zr atoms in the same SBU in a bi-monodentate fashion. Compound 1 contained cubic cage-like pores with Zr₆ clusters on the vertices and planar bptc⁴⁻ linkers on the faces. The cages had a dimension of ˜12 Å and were interconnected through smaller tetrahedral cages located at the twelve edges of the cubic cages. These tetrahedral cages had a window size of ˜4.5 Å. The bptc⁴⁻ linker is the smallest member of all tetratopic linkers among all Zr-MOFs known in the art. Compound 1 also represents the first Zr-MOF built on isophthalate-based polytopic ligands. While isophthalate-based organic linkers have been used in constructing MOFs with various metals, no zirconium MOFs made with such ligands has been reported. Without wishing to be limited to any particular theory, this could be because the short distance between the two carboxylates on the same isophthalate moiety gives rise to an added difficulty in forming extended structures with large Zr₆ SBUs. The synthesis reported herein suggests that a large amount of acid modulator is necessary to obtain crystalline products for compounds of this type.

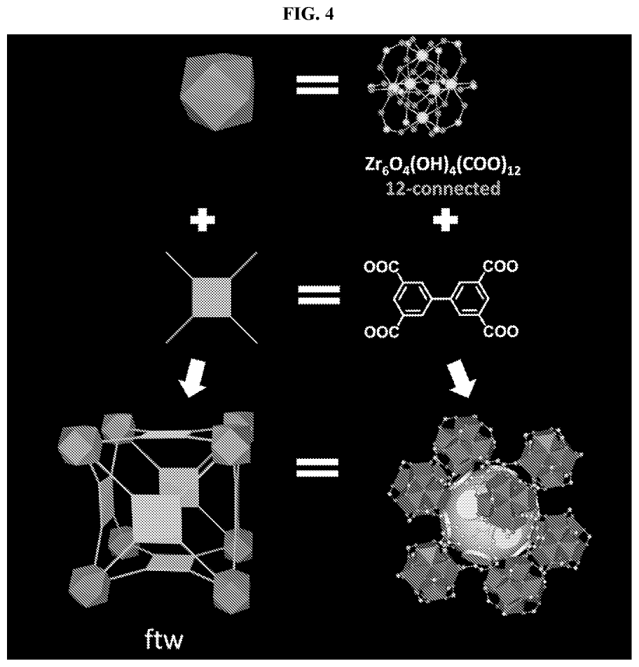

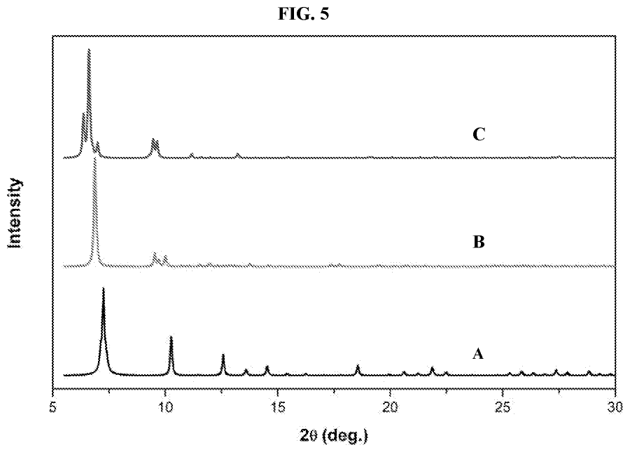

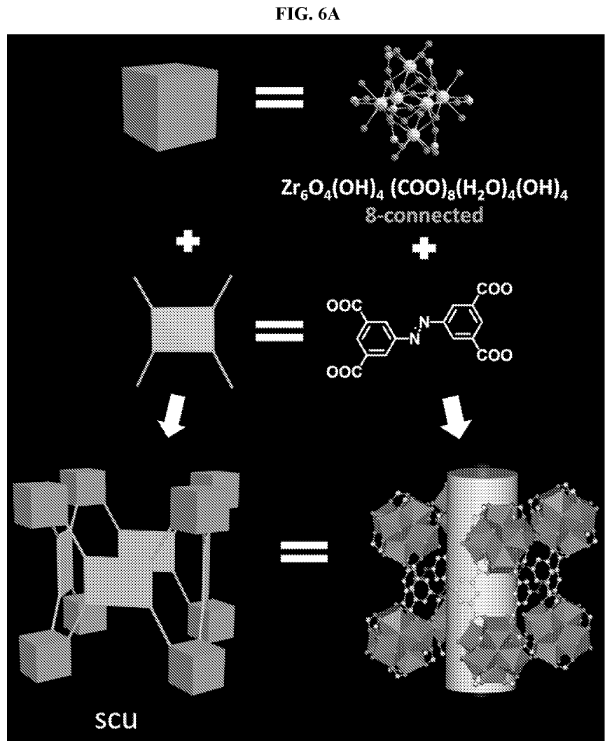

Linker bptc⁴⁻ was replaced by abtc⁴⁻ to form compound 2 (FIG. 5). Single crystal X-ray diffraction analysis revealed that compound 2 crystallized in monoclinic crystal system (space group C2/m). The structure consisted of 8-connected Zr₆(μ₃-O)₄(μ₃-OH)₄(COO)₈ SBUs that were propagated by 4-connected abtc⁴⁻ linkers along three dimensions, forming a framework with a very rare 4,8-c scu topology (FIGS. 6A-6B). The connectivity of the SBU was reduced to 8 from 12 in compound 1 as a result of four out of twelve carboxylate groups being replaced by terminal H₂O/OH⁻. In addition to the coordination to four O atoms from capped μ₃-O²/OH⁻, each Zr atom at the equatorial position also coordinated to two carboxylate O atoms from two different abtc⁴⁻ ligands, and another two O atoms from terminal H₂O/OH⁻ groups. The four remaining coordination sites of each of the two Zr atoms at the apical position were all occupied by carboxylate O atoms from four different abtc⁴⁻ ligands. The rectangular ligand abtc⁴⁻ was present in both trans and gauche conformation. Comparing to the overall connectivity of compound 1, the abtc⁴⁻ ligands along the crystallographic a-axis were missing in compound 2, leading to the transformation from cage-like pore to 1D channel with a diameter of 7 Å. Without wishing to be limited to any particular theory, the preference of scu topology over ftw for compound 2 is likely due to the increase in aspect ratio of the organic ligands (from 1.45 for bptc⁴⁻ to 1.78 for abtc⁴), which resulted from a change of a nearly square shaped tetratopic ligand to a rectangle shaped ligand.

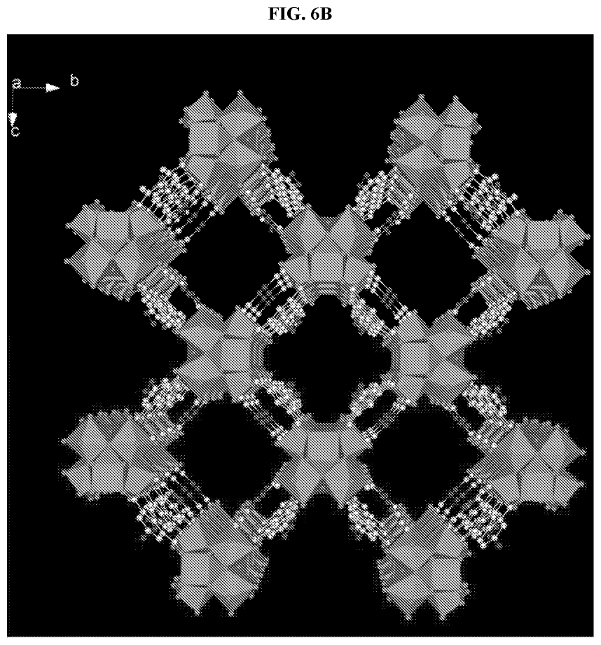

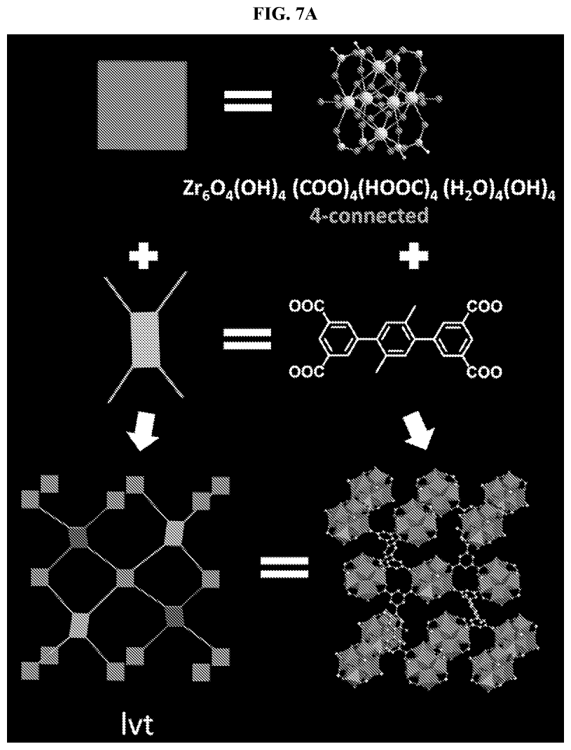

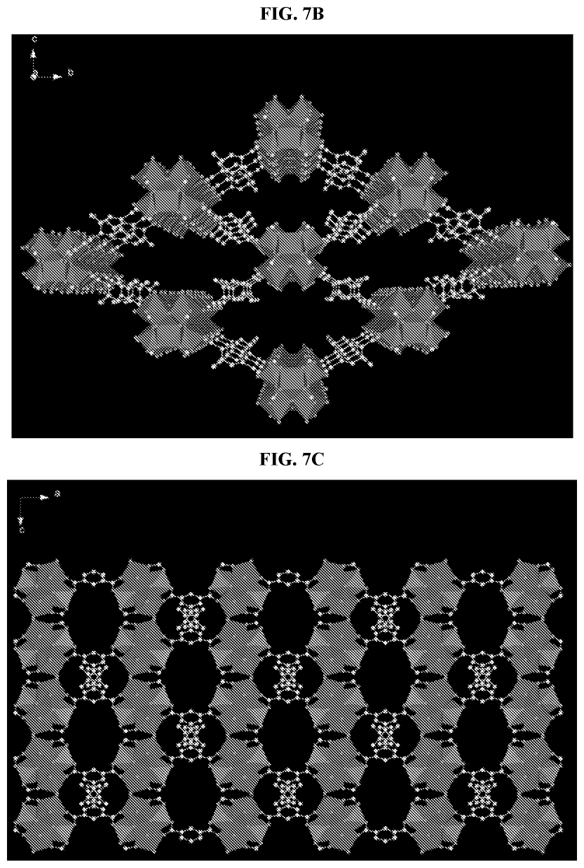

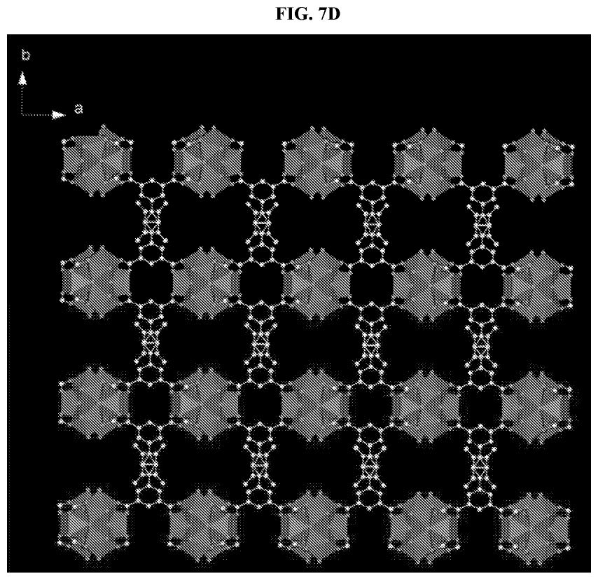

Further increase in the aspect ratio of the organic ligand tptc-(Me)₂ (2.28 aspect ratio, where two isophthalate groups are separated apart by a phenyl ring) led to a different connectivity in compound 3. Single crystal X-ray diffraction analysis showed that compound 3 crystallized in orthorhombic crystal system (space group Imma). In this structure, the formula of the SBU changed to Zr₆(μ₃-O)₄(μ₃-OH)₄(COO)₄, where the Zr₆ octahedral core remained but its connectivity was further reduced to 4 as a result of replacing four carboxylates in compound 2 by four terminal formate groups (FIGS. 7A-7C). Each of the four equatorial Zr atoms coordinated to eight O atoms where four are from bridging μ₃-O²/OH⁻, two from terminal H₂O/OH⁻, one from terminal formate and one from a carboxylate of a tptc-(Me)₂⁴⁻ linker. The two apical Zr atoms coordinated to four bridging μ₃-O²/OH⁻, two formate groups and two carboxylates from two distinct tptc-(Me)₂⁴⁻. The terminal formate groups adopted a bi-monodentate coordination mode, similar to carboxylates from tptc-(Me)₂⁴⁻ linkers. The connection mode of the four-connected SBU in compound 3 resembled that of the paddle-wheel dinuclear M₂(COO)₄ (M=Zn, Cu, etc) SBU commonly observed for Cu or Zn based MOFs. The resulting 3D structure adopts a rarely reported 4-c lvt topology.

### Example 2: Topological Analysis

Topology-directed design of MOFs (or reticular chemistry) is a powerful tool in creating various structure types for specific applications, as exemplified by MOFs constructed from Zn₄O(COO)₆ clusters and ditopic ligands. Zr-MOFs built on tetratopic linkers exhibit tremendous diversity in their structure topology, depending on the geometry, symmetry, and connectivity of both inorganic clusters and organic linkers. Noticeably, the organic linker chosen to construct a framework plays a vital role in the resulting underlying topology of this subgroup of MOFs.

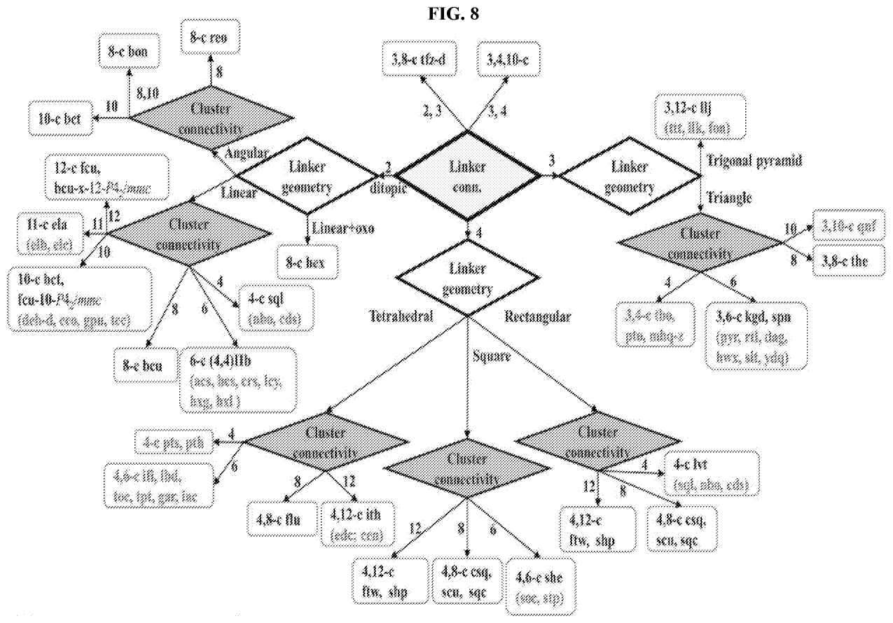

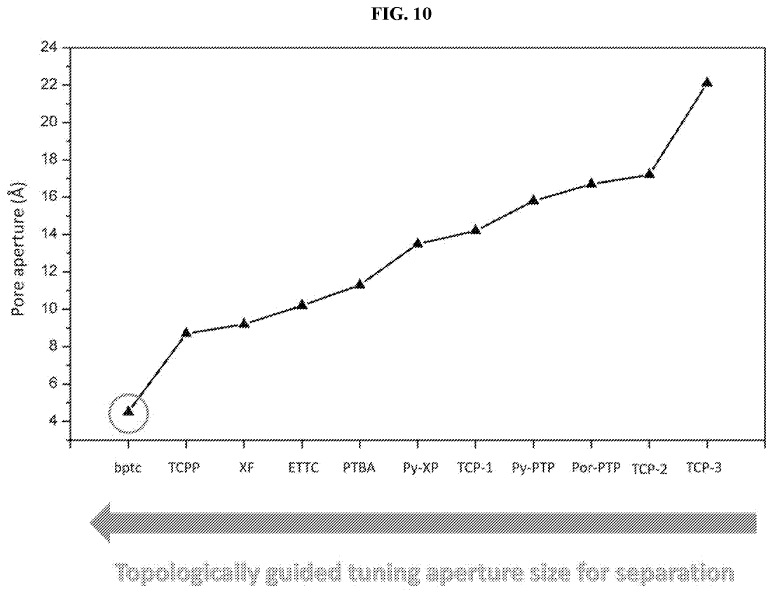

A detailed analysis of 211 Zr-MOFs constructed from Zr₆ cluster and ditopic or polytopic linkers reported in the prior art (Scheme 1) was carried out, with special attention to 44 Zr-MOFs with tetratopic linkers using ToposPro approach (FIG. 8). Out of these 44 Zr-MOFs, a total number of 5 structures were constructed from tetrahedron shaped ligands. The underlying topology of the remaining 39 structures built on planar tetratopic linkers possess 4,12-c ftw/shp, 4,8-c csq/sqc/scu, and 4,6-c she for 12-, 8-, and 6-connected Zr₆ clusters, respectively. The ftw topology is recognized to be the most thermodynamically stable structure type and has the largest porosity and lowest propensity for framework catenation making it desirable for adsorption related applications (FIG. 10).

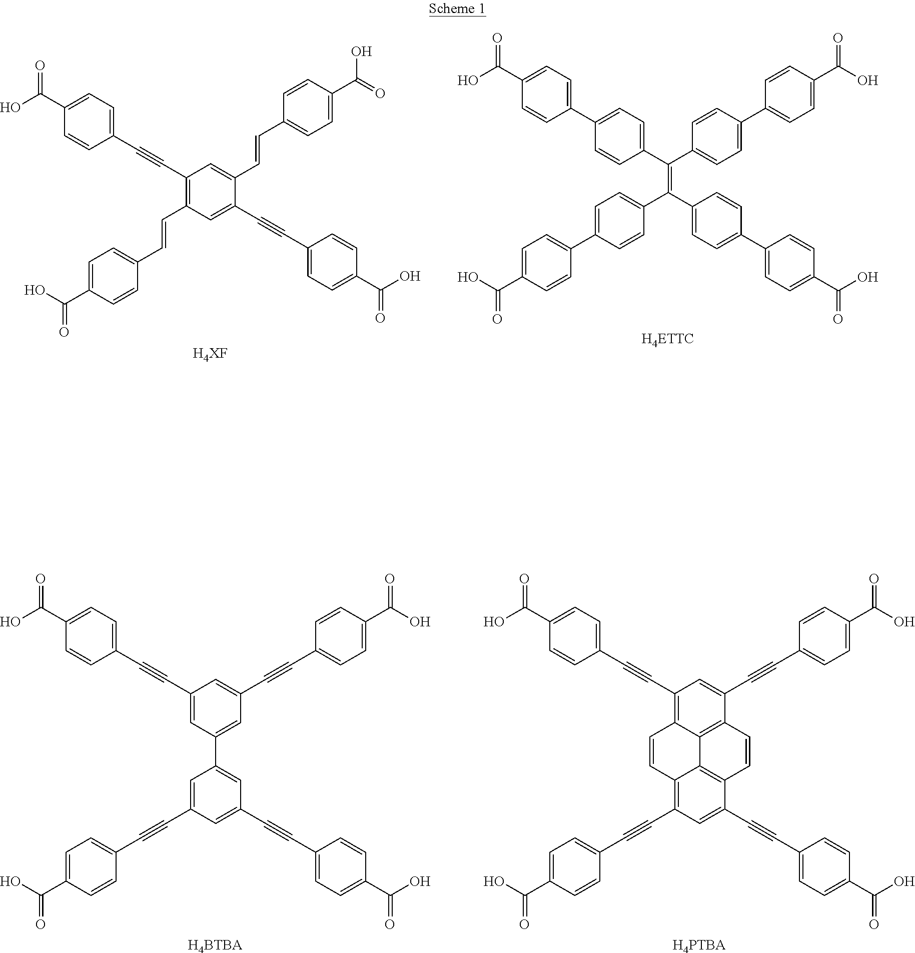

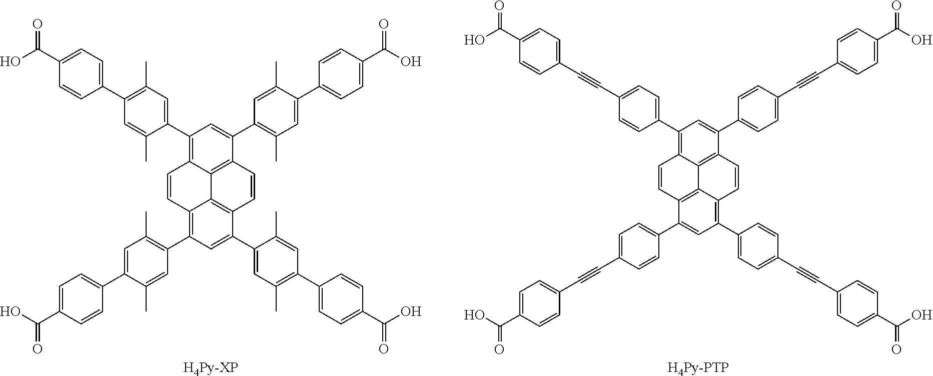 [SMILES: Cc1cc(-c2cc(-c3cc(C)c(-c4ccc(C(=O)O)cc4)cc3C)c3ccc4c(-c5cc(C)c(-c6ccc(C(=O)O)cc6)cc5C)cc(-c5cc(C)c(-c6ccc(C(=O)O)cc6)cc5C)c5ccc2c3c54)c(C)cc1-c1ccc(C(=O)O)cc1 ; O=C(O)c1ccc(C#Cc2ccc(-c3cc(-c4ccc(C#Cc5ccc(C(=O)O)cc5)cc4)c4ccc5c(-c6ccc(C#Cc7ccc(C(=O)O)cc7)cc6)cc(-c6ccc(C#Cc7ccc(C(=O)O)cc7)cc6)c6ccc3c4c65)cc2)cc1 ; "H4Py-PTP" ; "H4Py-XP"]

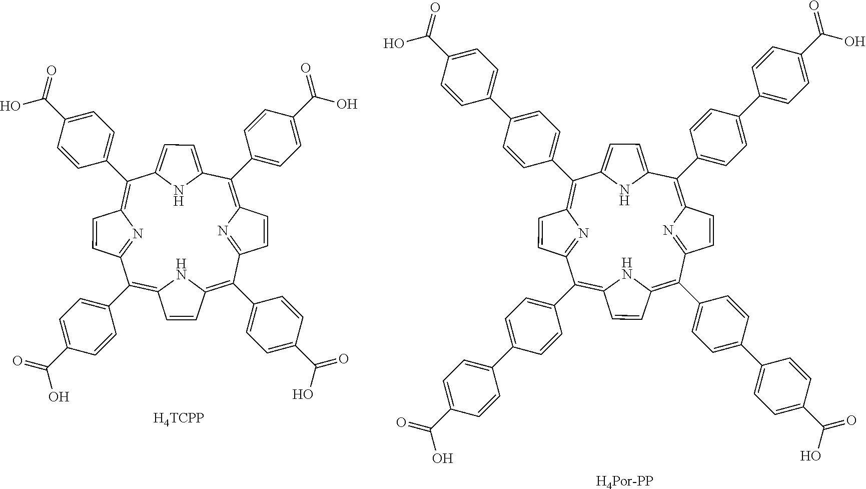 [SMILES: O=C(O)c1ccc(-c2c3nc(c(-c4ccc(C(=O)O)cc4)c4ccc([nH]4)c(-c4ccc(C(=O)O)cc4)c4nc(c(-c5ccc(C(=O)O)cc5)c5ccc2[nH]5)C=C4)C=C3)cc1 ; "H4TCPP" ; "HH4" ; O=C(O)c1ccc(-c2ccc(-c3c4nc(c(-c5ccc(-c6ccc(C(=O)O)cc6)cc5)c5ccc([nH]5)c(-c5ccc(-c6ccc(C(=O)O)cc6)cc5)c5nc(c(-c6ccc(-c7ccc(C(=O)O)cc7)cc6)c6ccc3[nH]6)C=C5)C=C4)cc2)cc1 ; "H4Por-PP"]

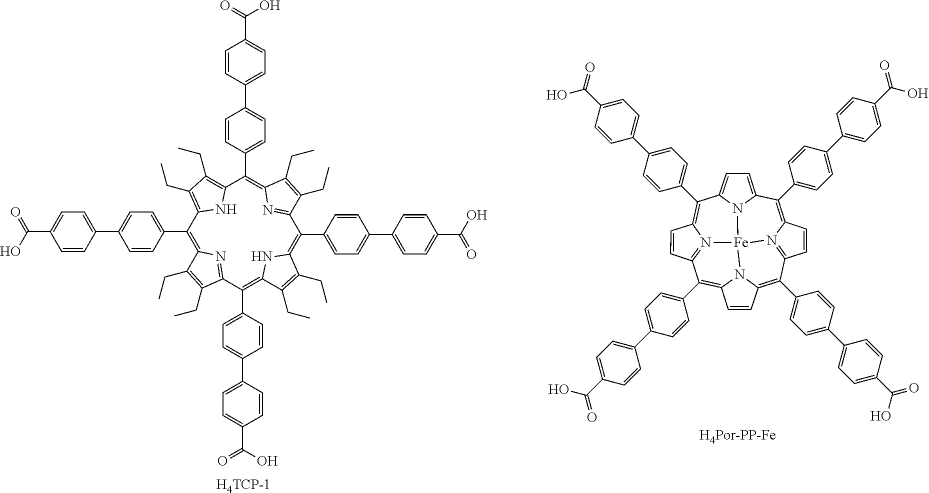

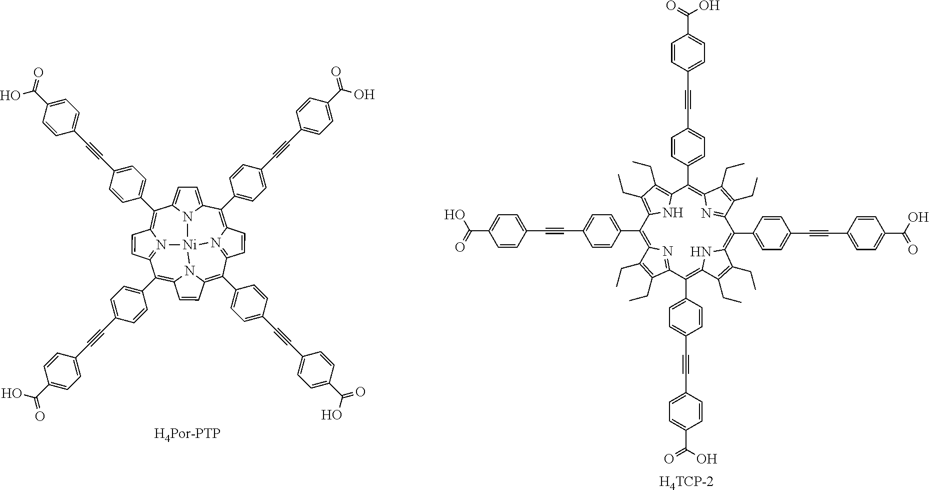

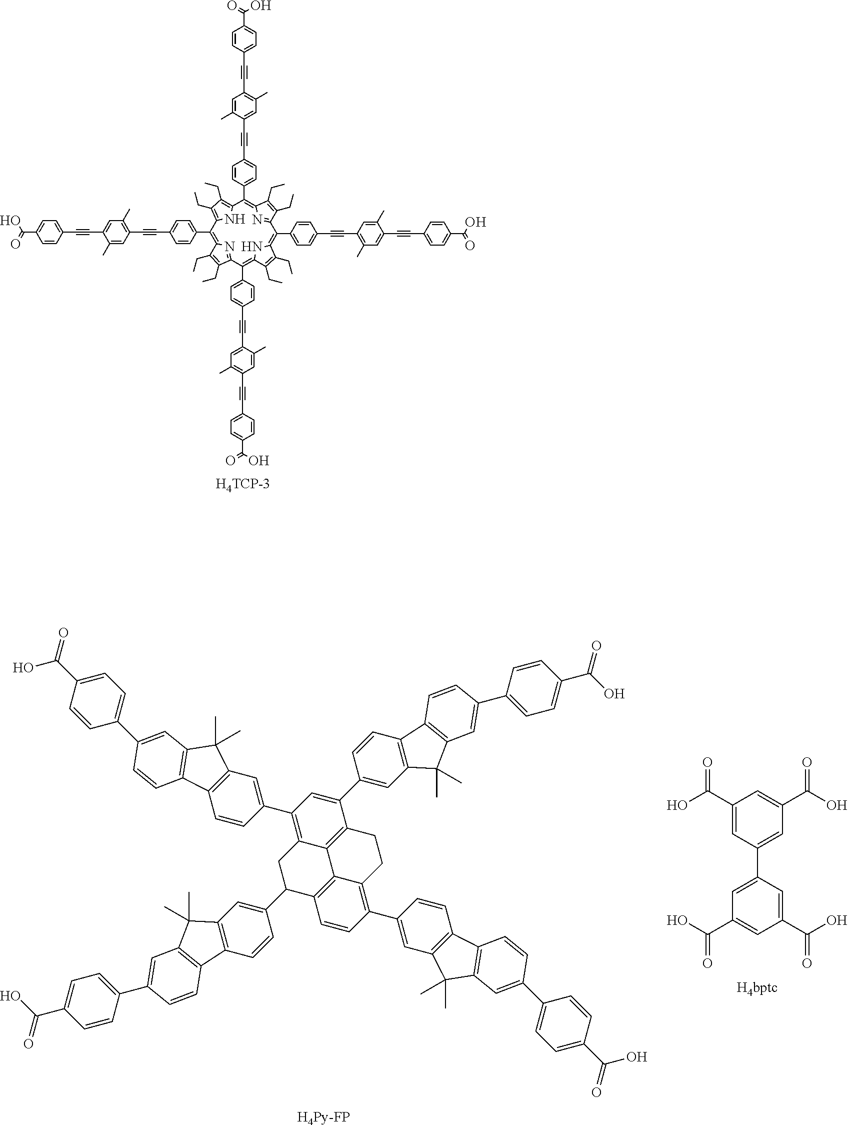

Furthermore, a closer look at the 18 ftw structures reported to date shows that 14 of them demonstrate the same symmetry as the idealized net, even when the ligand has a rectangular shape. This reflects in a disorder of the ligands on the two possible relative orientations giving an average structure as 3,12-c xxv net which is observed for all structures containing a porphyrinic ligand (FIG. 11). The four least symmetric ftw structures have rectangular ligands and two of them have an aspect ratio greater than one (1.03 and 1.15), deviating from the hypothesis that an ftw structure must use a ligand with unitary aspect ratio. In particular, the bptc⁴⁻ linker in compound 1 has the largest aspect ratio of 1.45 that gives the ordered ftw related net 3,12-c kle. The only other known example of kle net is NU-1000, which incorporates a pyrene-based tetratopic ligand with an aspect ratio of 1.03. These examples suggest that with proper synthetic conditions, other ftw related kle structures may be possible with ligands of aspect ratio greater than 1.0. However, it should be noted that, while a square shaped tetratopic ligand is not a necessary requirement for the formation of ftw topology, there is an upper limit in the ligand aspect ratio above which such a topology will no longer be thermodynamically favored. This is indeed the case for compounds 2 and 3. The high aspect ratio of abtc⁴⁻ (1.78) creates severe steric hindrance, which prevents the formation of 12-connected Zr₆ SBU. As a result, compound 2 adopts the 4,8-c scu topology. The scu is by itself a unique net, with very few structures reported. The higher aspect ratio of abtc⁴⁻ also causes the distortion of the 8-connected Zr₆ cluster in compound 2, and consequently a lower symmetry of D₄ₕ, compared to Oₕ symmetry of the 12-connected Zr₆ cluster in compound 1. Having tptc-(Me)₂⁴⁻, a ligand with an even higher aspect ratio of 2.28 incorporated in the structure, compound 3 adopts 4-connected Zr₆ clusters. The structure is a unique type and also represents the first example of a 3D Zr-MOF with a 4-c node Zr₆ cluster. Such coordination of a Zr₆ cluster has only been observed for ditopic ligands in a sql 2D layered MOF compound.

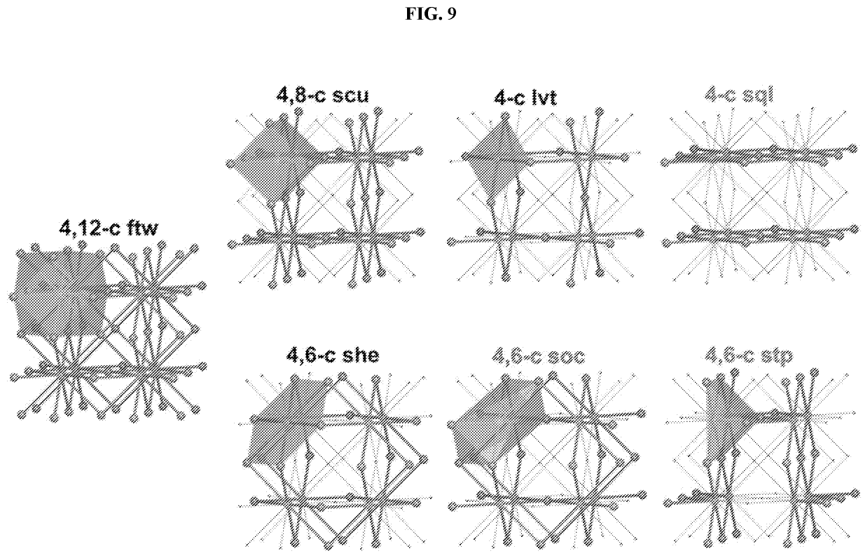

These results suggest ligand geometry plays an important role in determining the symmetry and connectivity of the Zr₆ SBU as well as the resulting topology of the Zr-MOF. This is shown by the scheme (FIG. 9) of the general relations between ligand connectivity and geometry, cluster connectivity, and resulting overall topology. Each underlying net for giving connectivity of the ligand and cluster has the minimal possible transitivity. Transitivity is a measure of “regularity” of a net and the structure of MOFs follow a general principle that their underlying nets tend to be those of minimal transitivity. Thus, 4,12-c ftw/shp, 4,8-c csq/sqc/scu, 4,6-c she contain two distinct nodes and only one type of edge (transitivity 21) and 4-c lvt is uninodal edge-transitive net (transitivity 11). The nets with lower coordinations such as 4,8-c scu, 4,6-c she, and 4-c lvt can be obtained from the 4,12-c ftw net (having the highest coordination) by removing 4-c nodes and hence reducing the ligand/cluster ratio. The relations together with the minimal transitivity principle provides the ground for predicting possible topological types of new Zr-MOFs yet to be realized, which are subnets of the ftw net with minimal transitivity (FIG. 9): 4,6-c soc (transitivity 21), 4,6-c stp (transitivity 21), and 4-c sql (transitivity 11).

### Example 3: Porosity and Stability

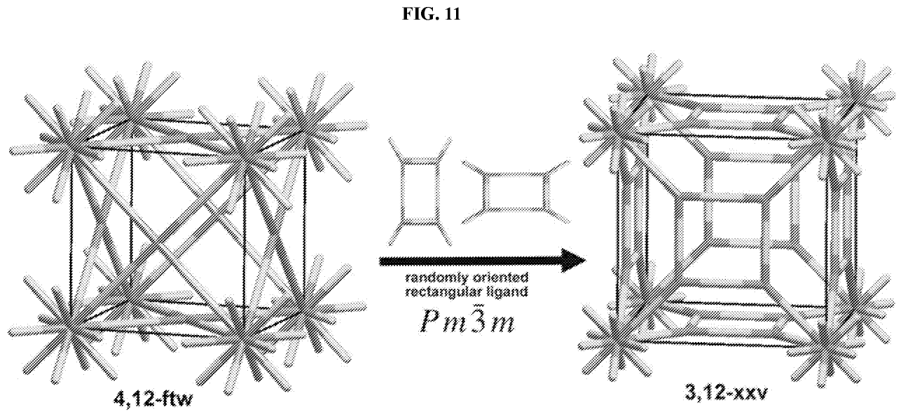

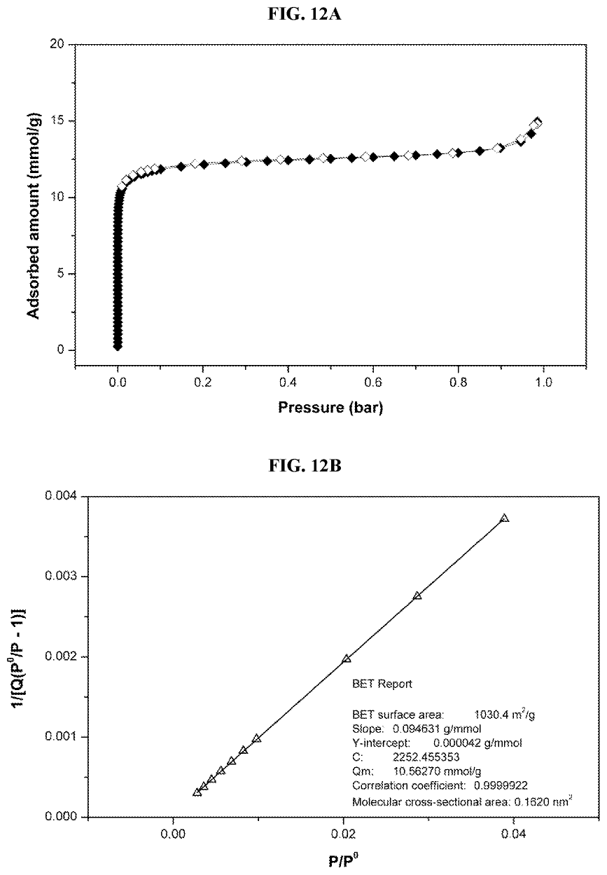

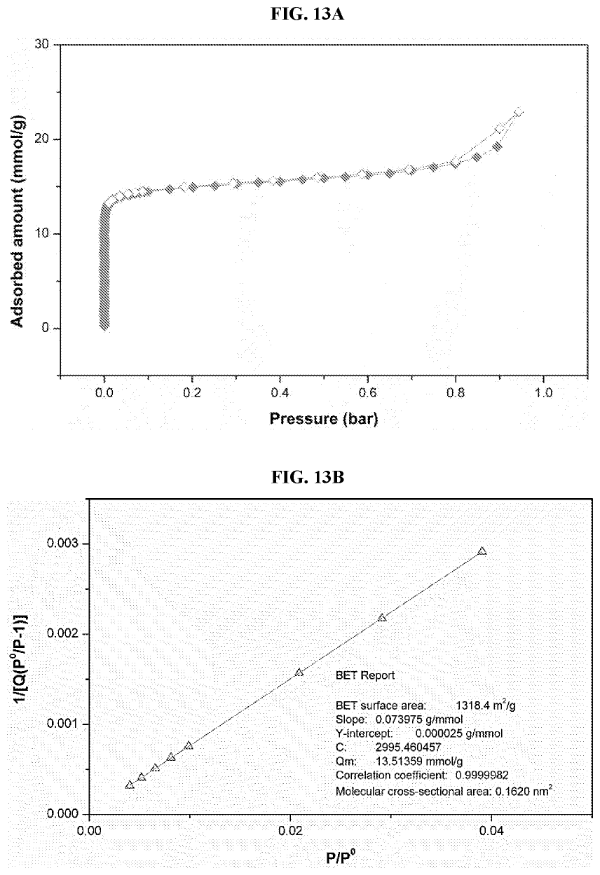

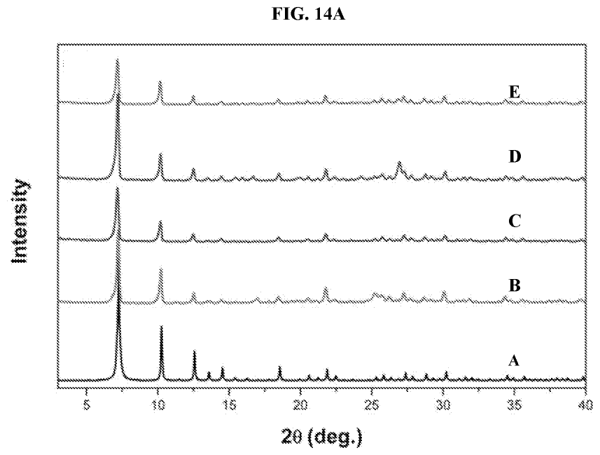

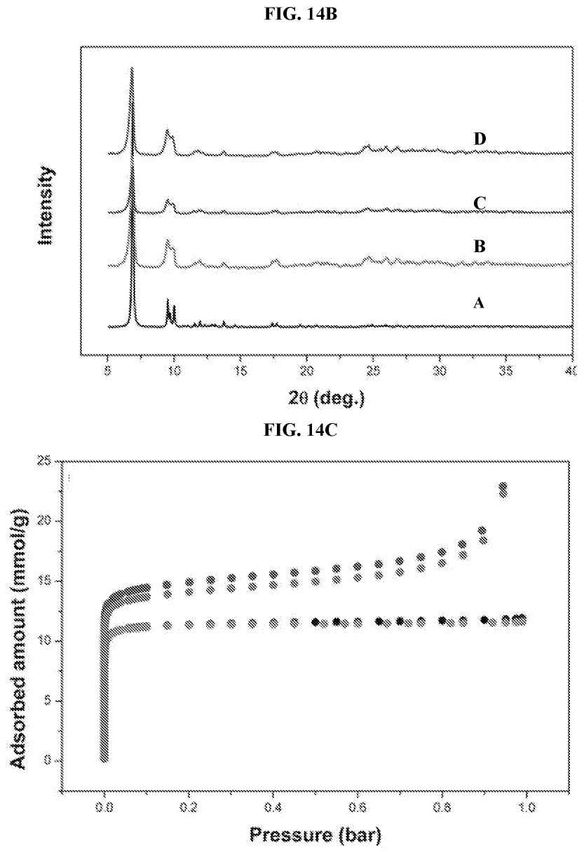

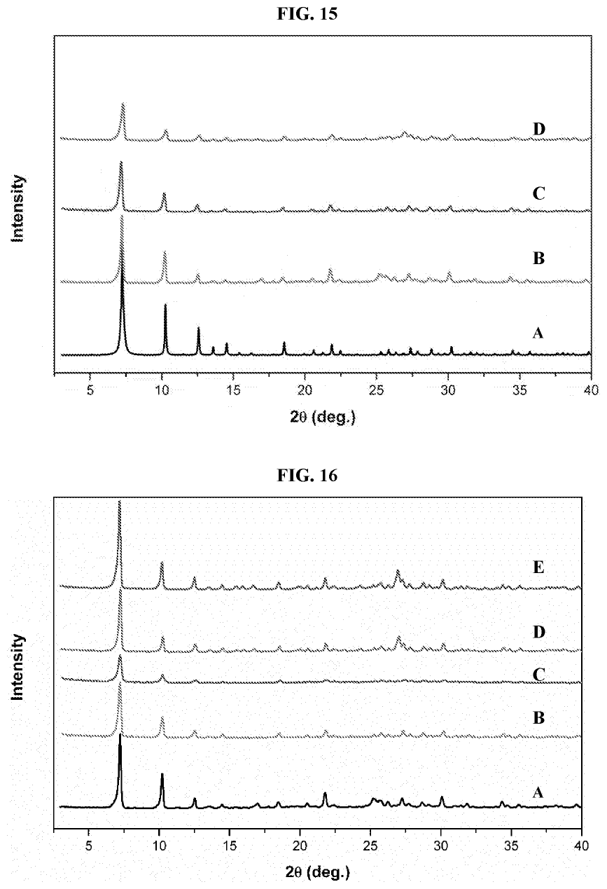

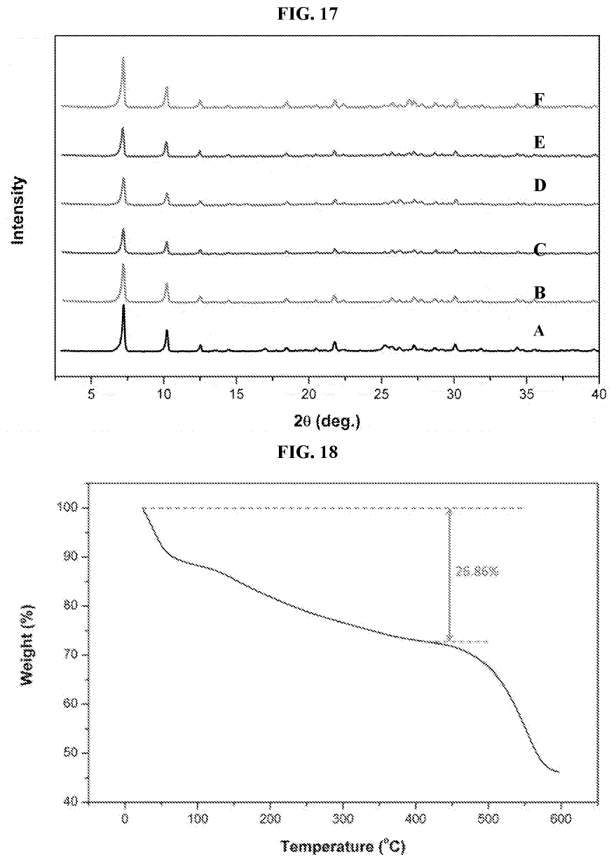

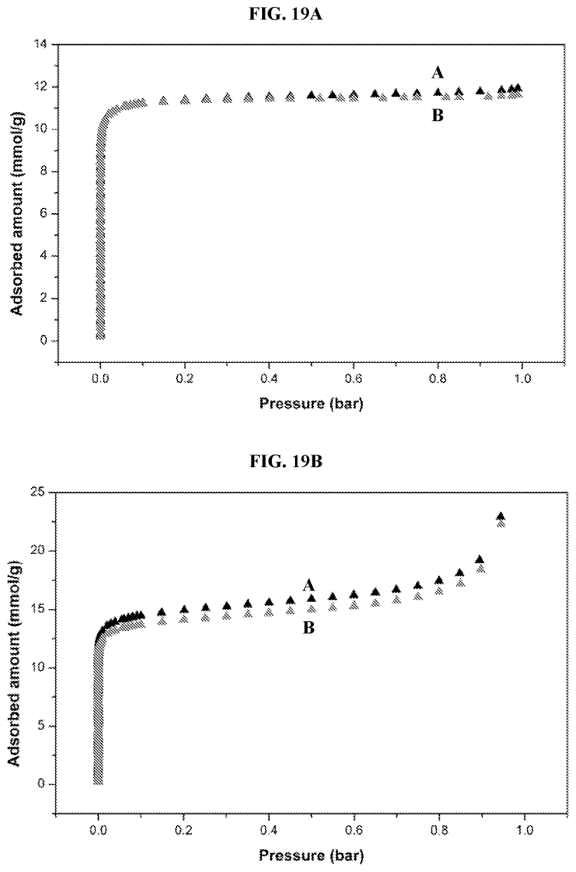

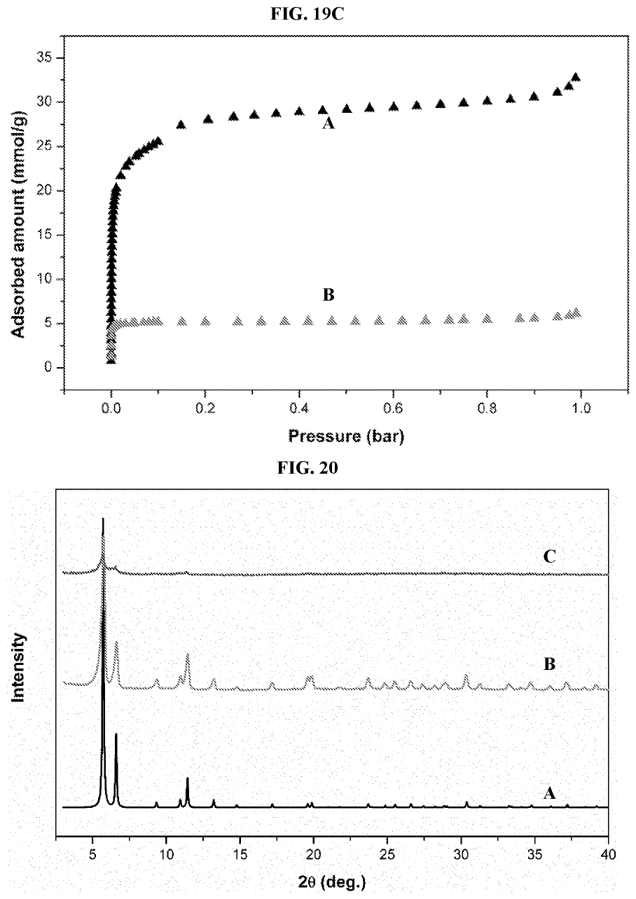

Porosity of compounds 1 and 2 has been confirmed by nitrogen adsorption measurements at 77 K. The Type I adsorption isotherm profiles indicate their microporous nature. The BET surface areas are 1030 and 1318 m²/g for compounds 1 and 2, respectively and micropore volumes are 0.38 cm³/g and 0.45 cm³/g for compounds 1 and 2, respectively (FIGS. 12A-12B, 13A-13B). These values are significantly higher than that of zeolite 5A (BET surface area: ˜600 m²/g, pore volume: 0.25 cm³/g). Compound 1 also possesses exceptionally high thermal and water stability (FIGS. 14A, 15-18), being thermally stable up to at least 400° C. The structure of compound 1 remained intact after being heated at 180° C. in open air for 1 month. It can also be immersed in aqueous solutions of pH=2 to 12 for 1 week without losing any crystallinity. A close comparison is made between compound 1 and prior art compound UiO-67 with respect to framework stability, since both are made of the same 12-connected Zr₆ SBU and organic ligands with similar length. Strikingly, compound 1 is much more robust than UiO-67 (FIGS. 19A-19C and Table 1). After soaking in water at 80° C. for 1 day, both crystallinity and porosity of compound 1 were well retained, whereas UiO-67 lost most of its long-range order and ˜80% of its porosity (FIG. 20). This can be attributed to the difference in their ligand connectivity (4 in compound 1 and 2 in UiO-67).

TABLE 1
Porosity characterization before and after water treatment

BET surface area (m²/g)

| | Before water treatment | After water treatment |
|---|---|---|
| Compound 1 | 1030 | 1035 |
| Compound 2 | 1318 | 1250 |
| UiO-67 | 2299 | 473 |

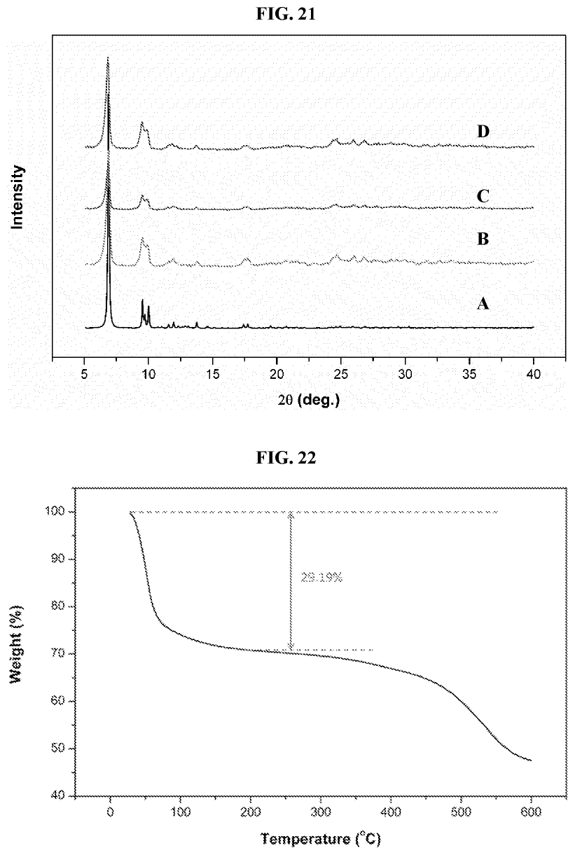

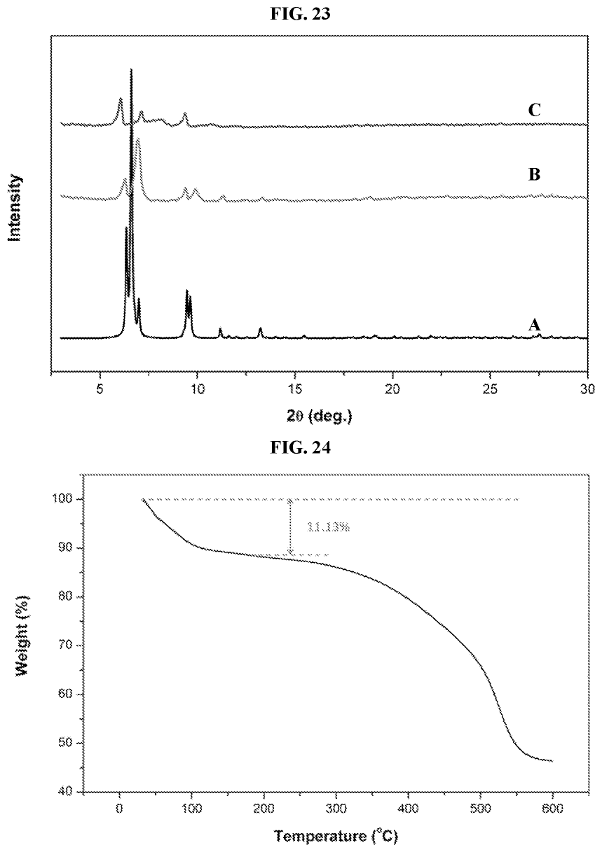

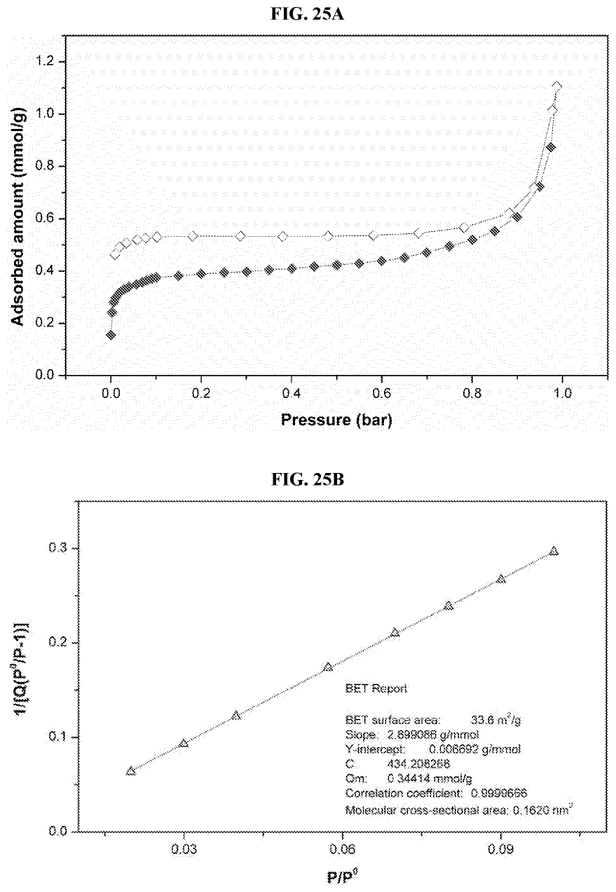

The stability of compounds 1, 2 and 3 was further explored. Compound 2 exhibited good thermal and water stability (FIGS. 21-22); however, it was found to be not as robust as compound 1. Although compound 2 retained crystallinity after various thermal/water treatments it experiences a slight decrease in porosity after hot water treatment (FIGS. 14B-14C). Compound 3, on the other hand, exhibited poor stability and suffered structural collapse upon thermal activation and showed almost no porosity (FIGS. 23, 24, 25A-25B). Based on the above analysis on their structures and topology, it is clear that the distinct difference in each compound's framework stability correlates to the connectivity of their SBUs.

### Example 4: Single Component Adsorption of C6 Isomers

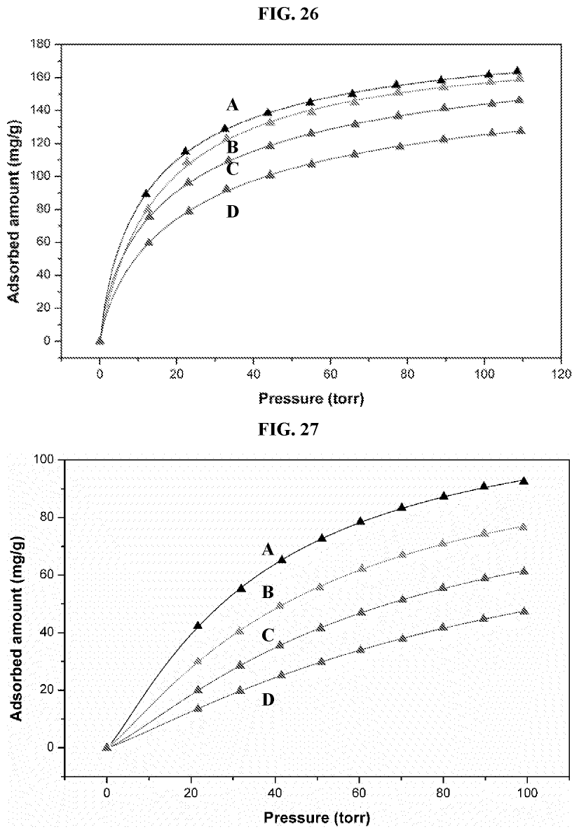

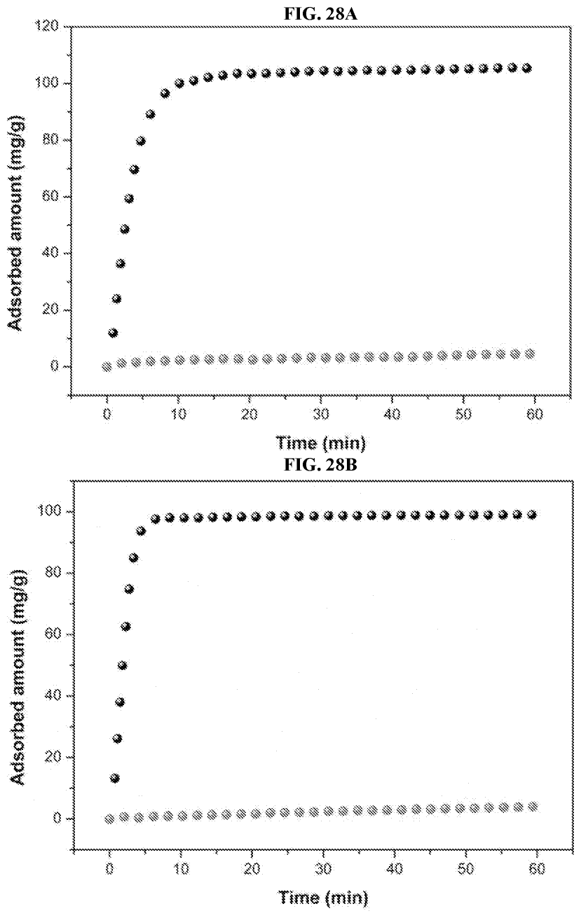

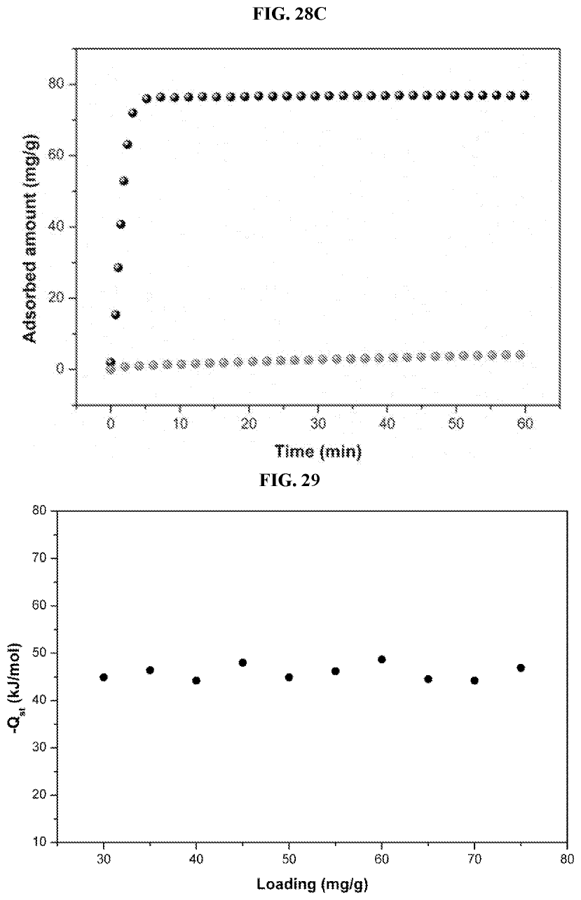

C6 isomers were selected to test the separation performance of compound 1 based on the consideration of its pore structure. Single component equilibrium isotherms of n-hexane (nHEX) were collected on compound 1 at various temperatures (FIGS. 26-27). At 150° C., a temperature chosen based on the industrial operation temperature range (100 to 200° C.), compound 1 takes up 130 mg/g nHEX under a partial pressure of 110 torr, which is ˜70% higher than that of the benchmark material zeolite 5A with an uptake of 77 mg/g under the same condition (FIG. 28C). This uptake capacity represents the highest value of any porous material known in the art under similar conditions. The ideal pore structure in compound 1 may account for its high nHEX uptake at high temperature: the large cages guarantee the void space needed to accommodate a large amount of adsorbates while the suited pore aperture serves as a gate to control the diffusion of molecules into the cages.

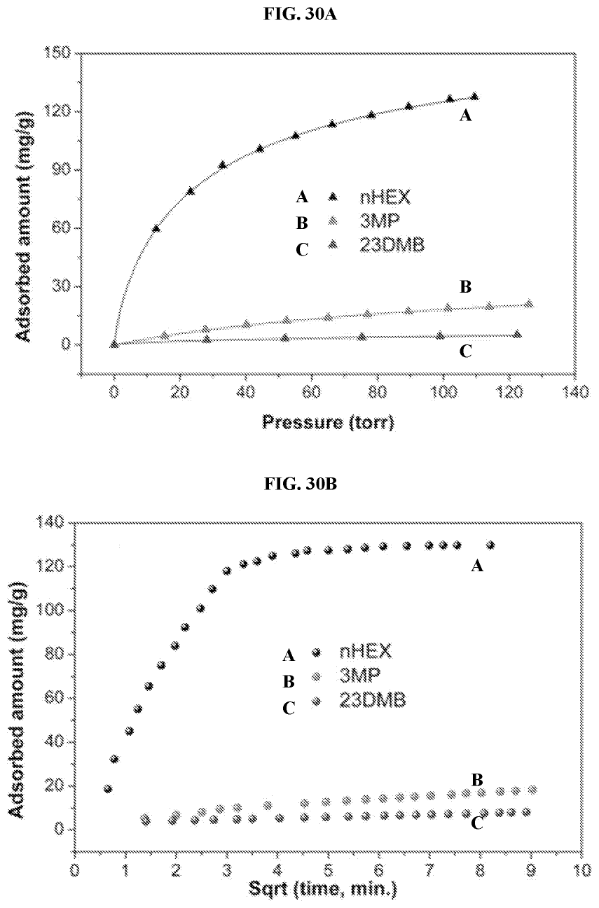

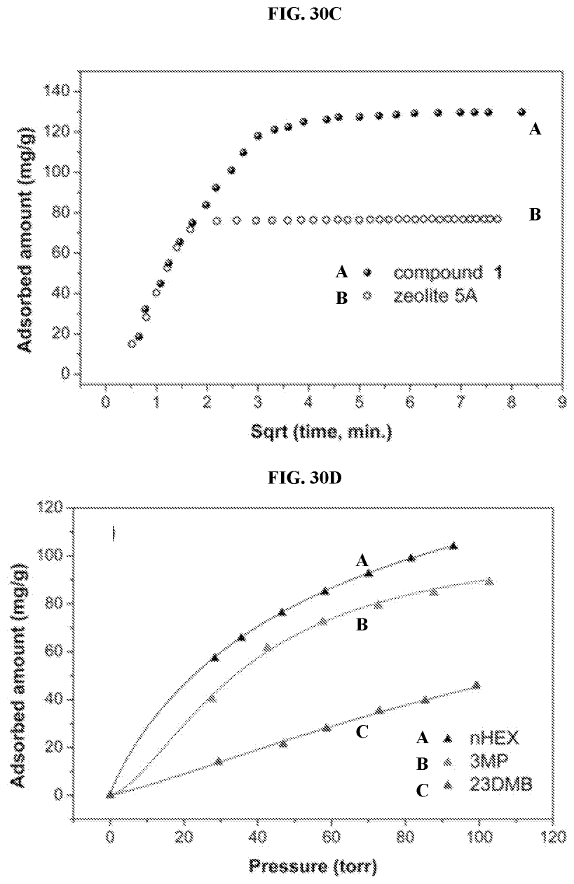

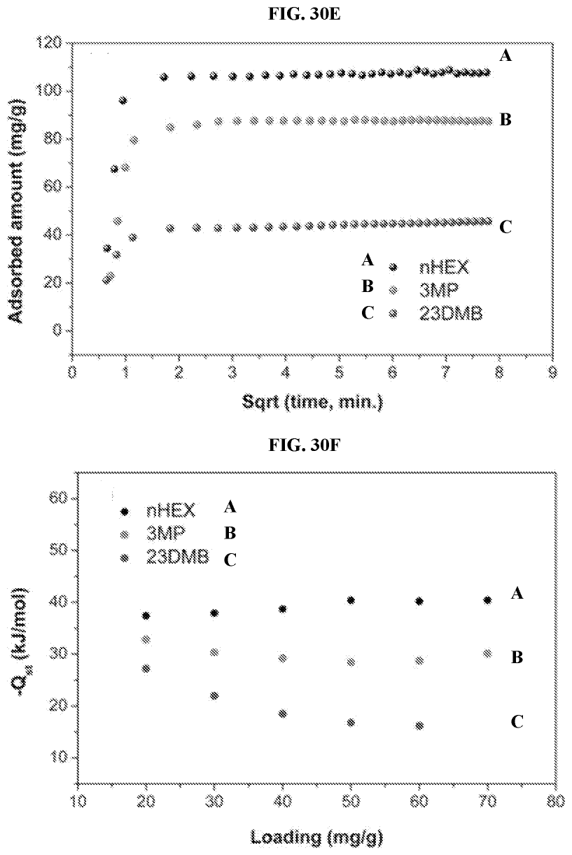

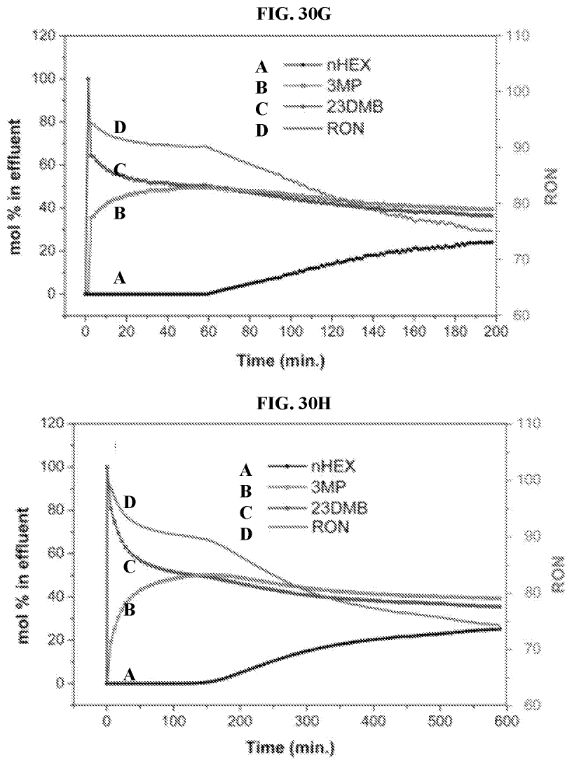

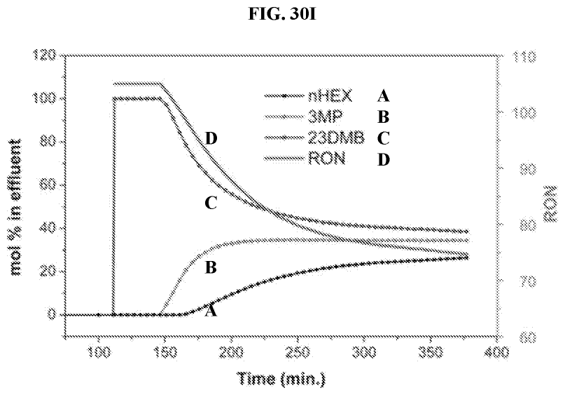

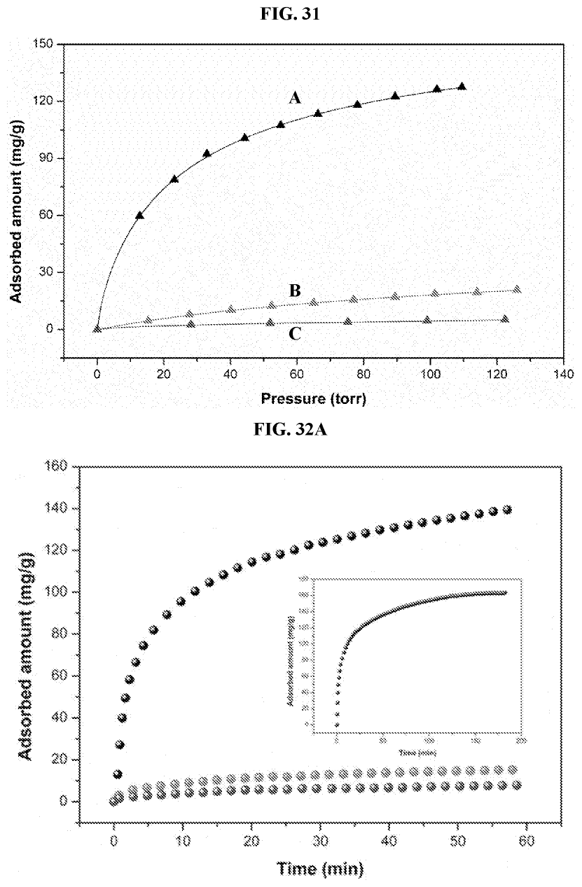

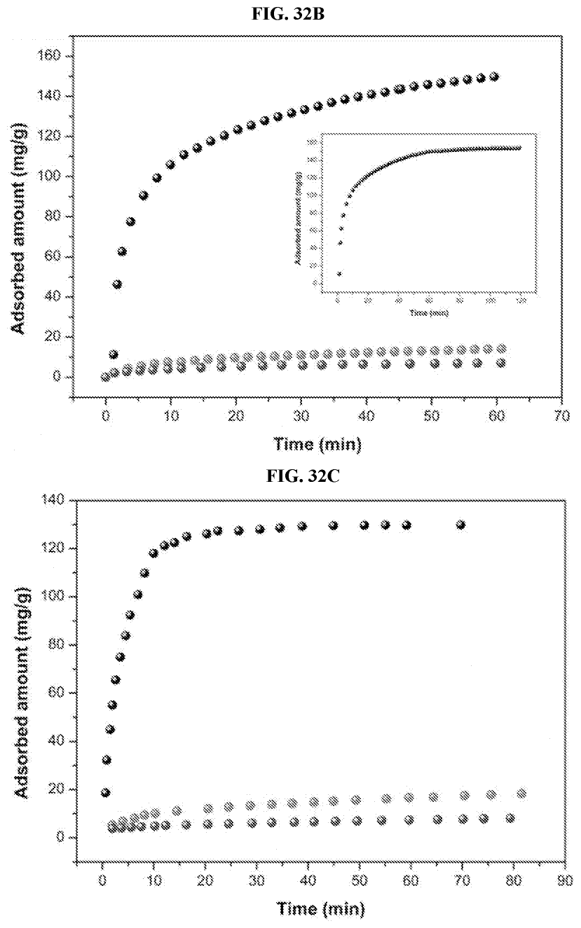

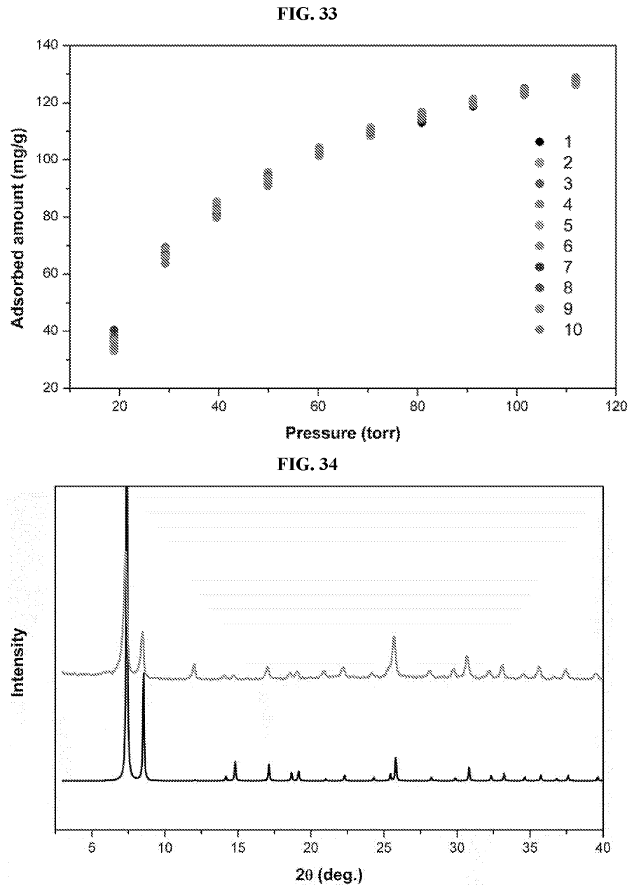

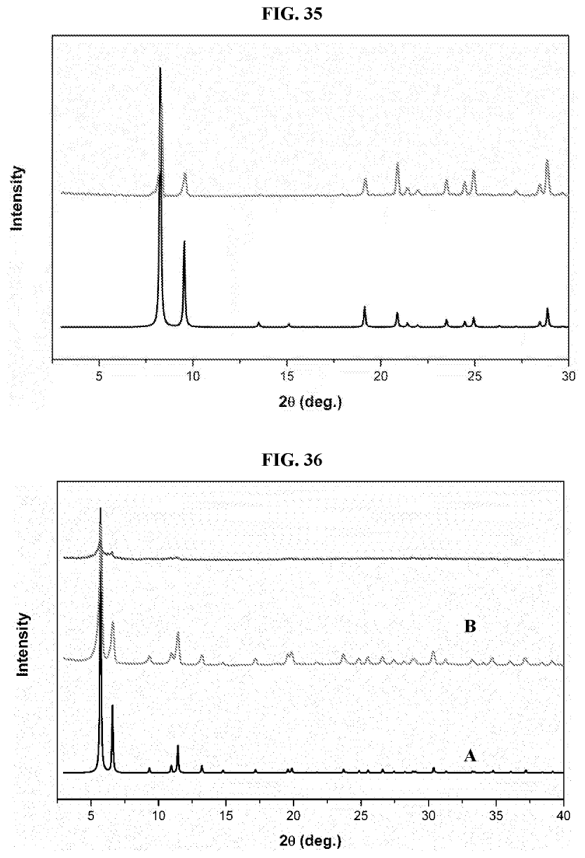

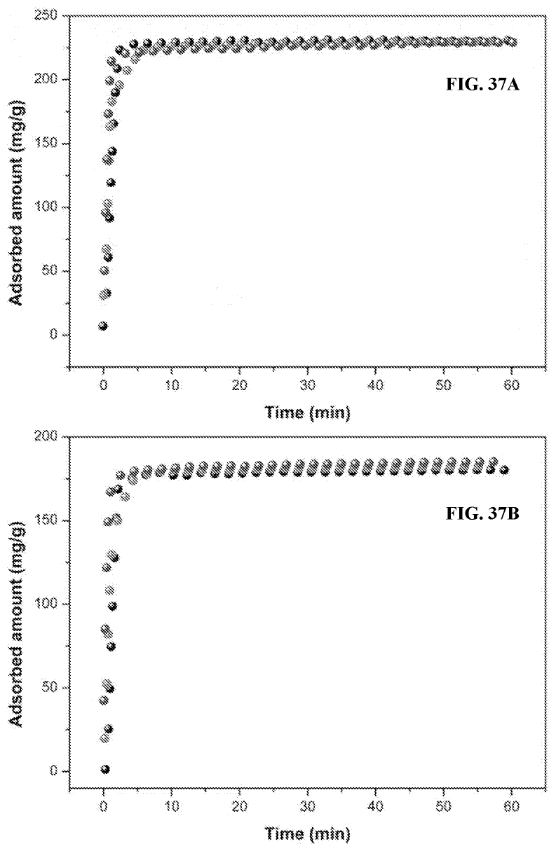

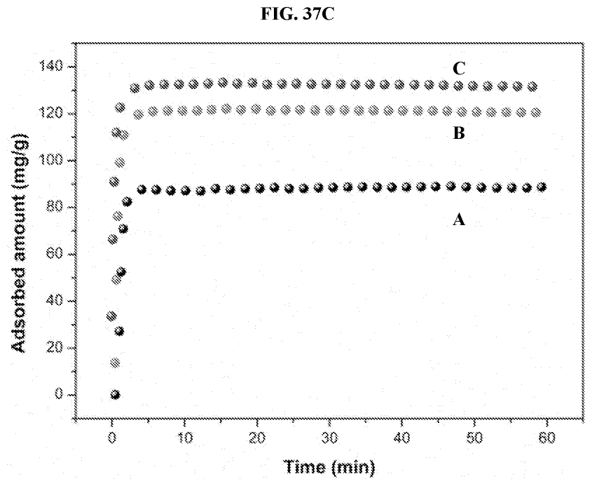

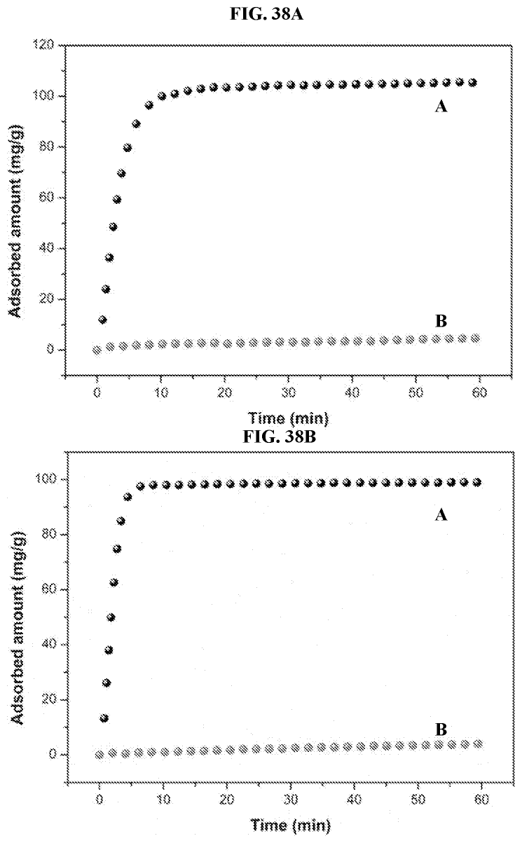

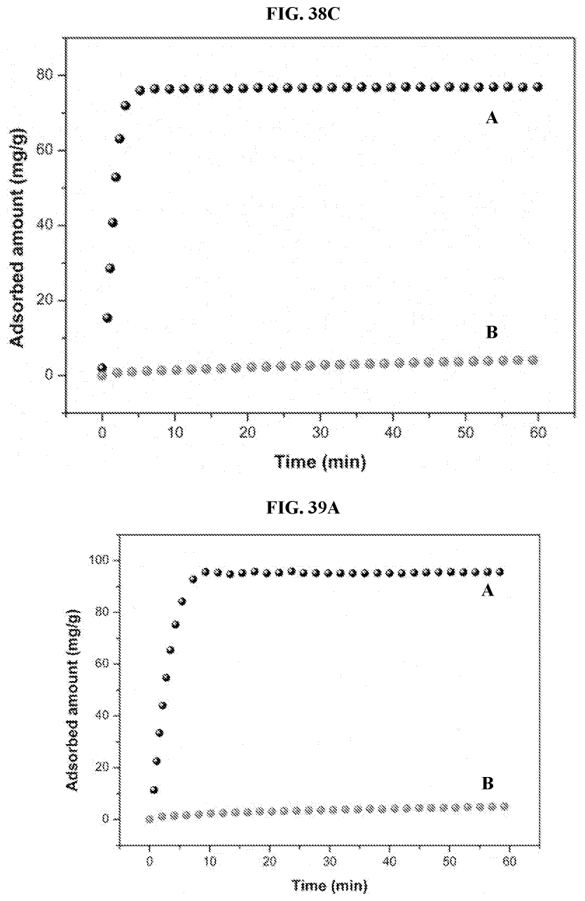

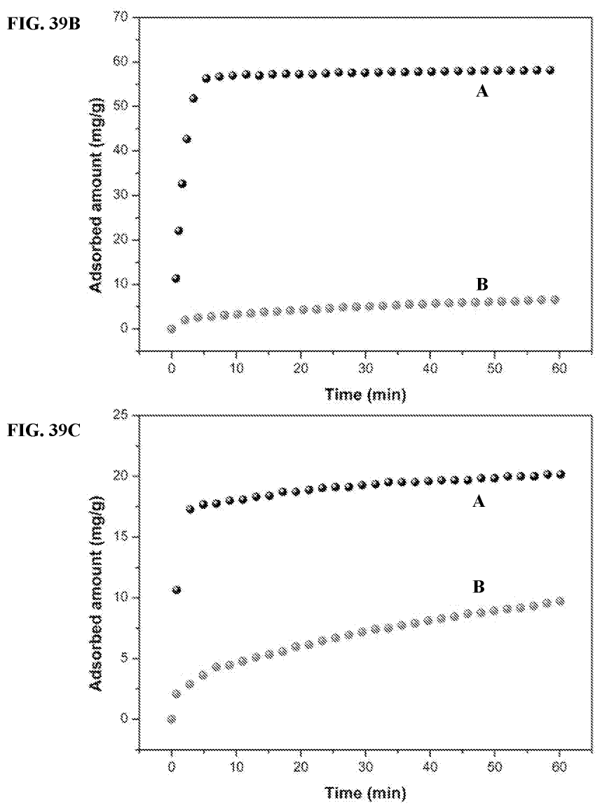

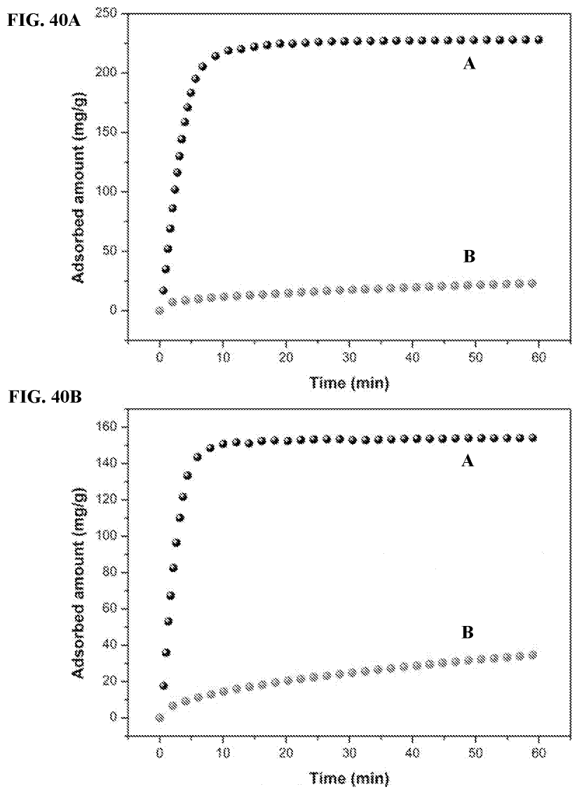

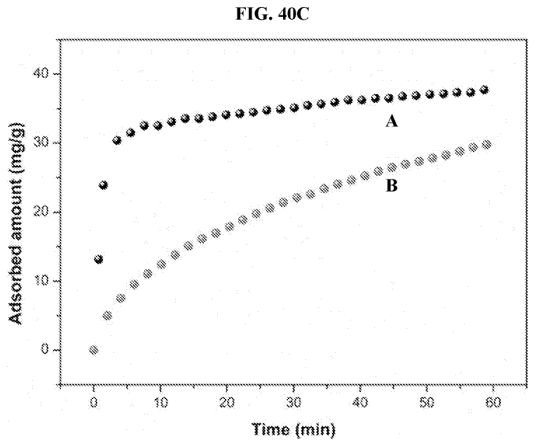

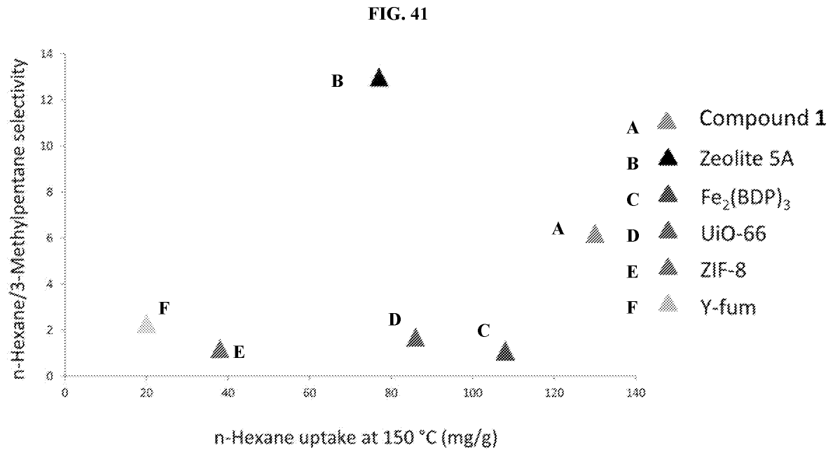

The strength of adsorbent-adsorbate interaction was evaluated by isosteric heat of adsorption (Qₛₜ) calculated using adsorption isotherms at high temperatures (180, 200, 220 and 240° C., FIGS. 27, 29). A value of 48 kJ/mol was obtained for nHEX. Notably, adsorption kinetics of nHEX on compound 1 is comparable to that on zeolite 5A at 150° C. and no diffusion restriction was observed (FIG. 30C). In contrast, compound 1 shows negligible adsorption of monobranched 3-methylpentane (3MP) and essentially no uptake of dibranched 2,3-dimethylbutane (23DMB, FIGS. 30A-30B, 31, 32A-32C). The lack of uptake can be attributed to the small pore window size. Without intending to be limited to any one theory, the small amount of 3MP taken up by compound 1 may be attributed to surface adsorption or adsorption at defect sites, not adsorption through the pores. This is further confirmed by breakthrough experiments and computational modeling, as discussed in Example 6. The selective adsorption of nHEX over the branched isomers by compound 1 follows a similar molecular exclusion mechanism as in the case of zeolite 5A, but having a much higher uptake capacity. Compound 1 also exhibits excellent recyclability without losing any uptake capacity after ten adsorption-desorption cycles (FIG. 33). The top performing MOFs known in the art were also produced and evaluated, and their adsorption capacity and selectivity were compared for the separation of C6 alkane isomers (FIGS. 34-36). Only compound 1 demonstrated a performance level comparable with zeolite 5A (FIGS. 37A-37C, 38A-38C, 39A-39C, 40A-40C, and 41).

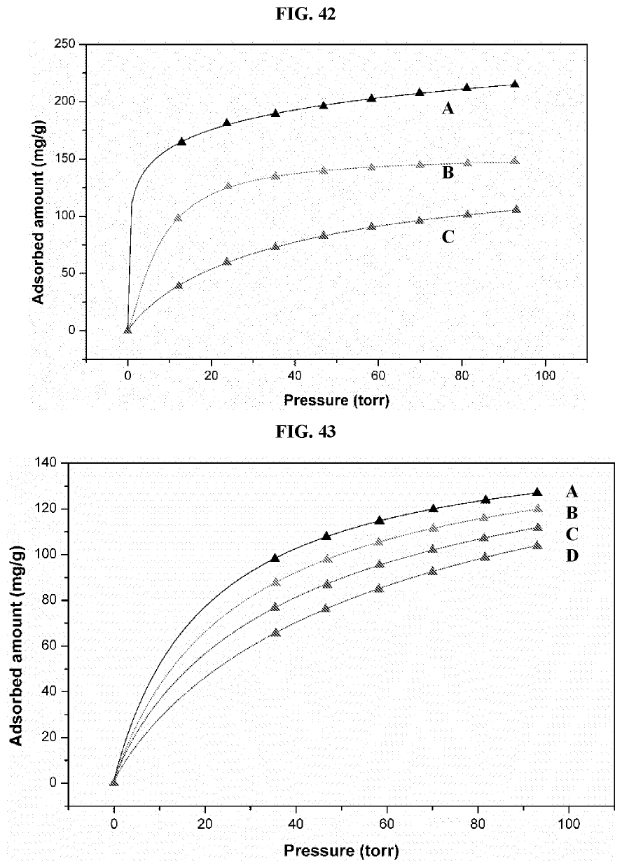

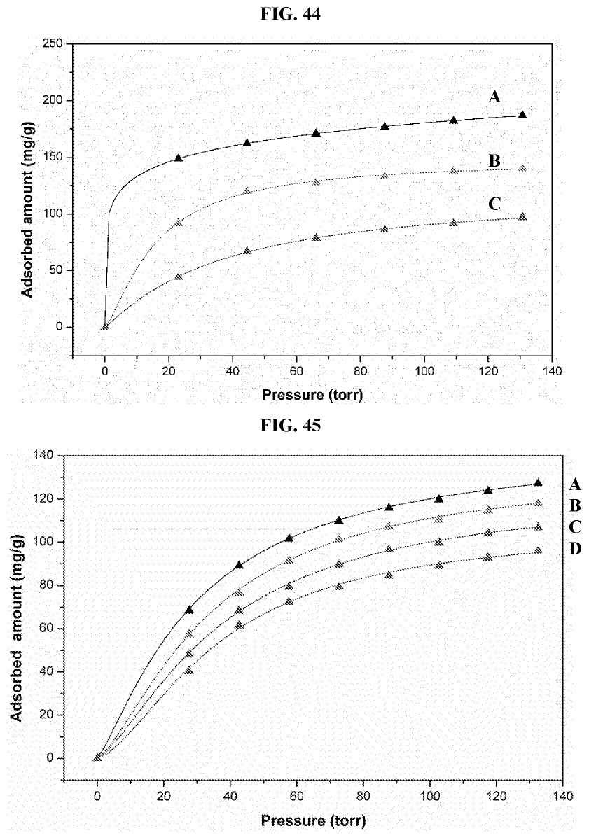

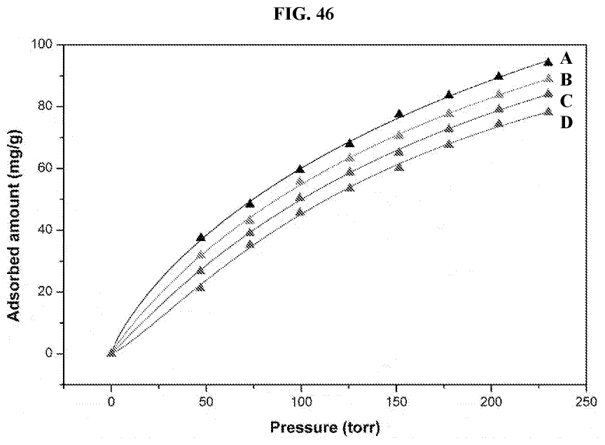

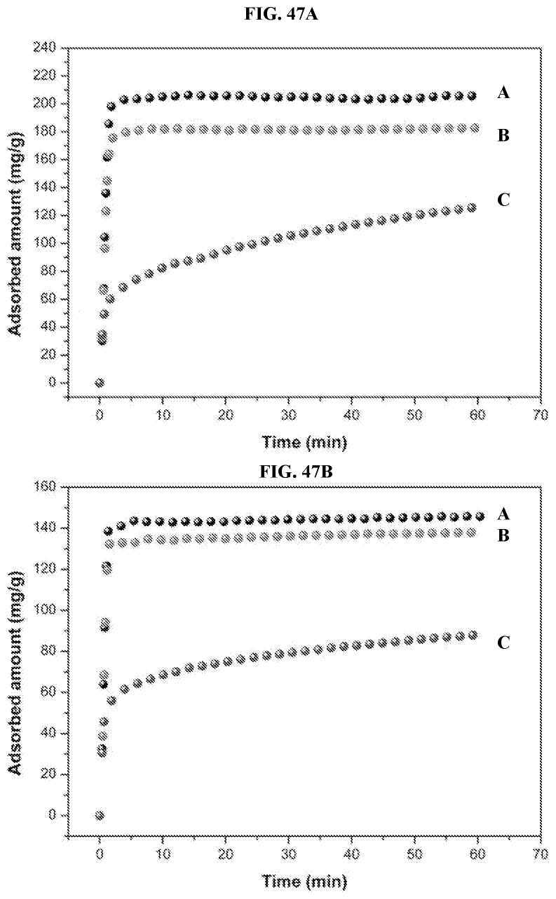

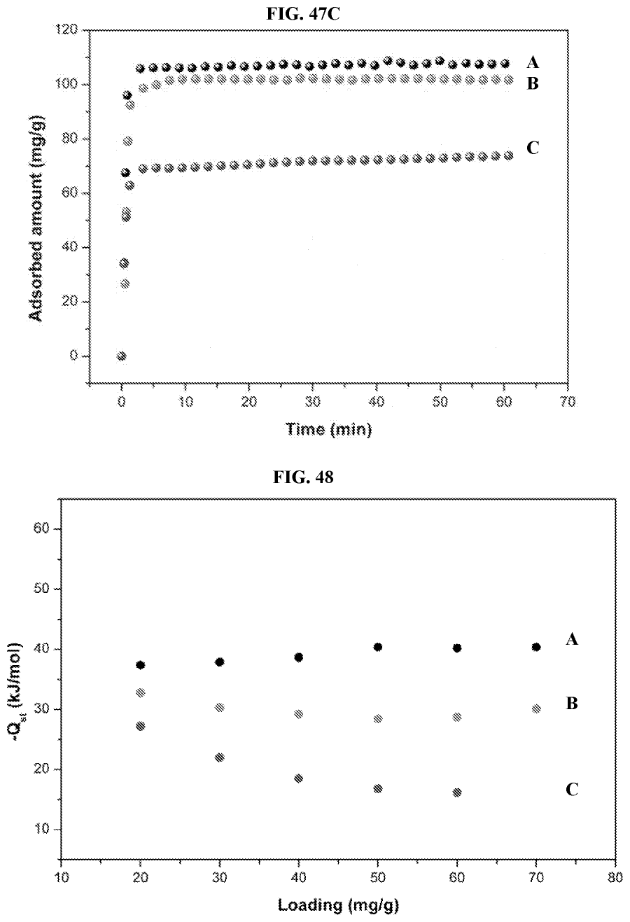

As shown in FIGS. 30D-30E and FIGS. 42-46, all three hexane isomers can be accommodated into the channel of compound 2 owing to its larger pore size. In addition, it showed no diffusional limitations for linear or monobranched isomers at any temperature investigated with only slight restrictions for dibranched isomer at low temperature (FIGS. 47A-47C). The adsorption capacity of nHEX in compound 2 is ˜105 mg/g at 150° C. and 100 torr, which is slightly lower than that of compound 1 but higher than that of zeolite 5A and most previously reported materials. Though the channels in compound 2 are large enough to adsorb all three isomers, it exhibits different extent of interaction with each individual isomer. As illustrated by the Qₛₜ calculations (FIG. 30F and FIG. 48), nHEX was the most preferentially adsorbed species while the adsorption affinity for the dibranched isomer was the weakest. Without wishing to be limited to any particular theory, this can be explained by the degree of contact between the adsorbate and the channel surface: the linear hexane molecules can maximize its van der Waals interaction with the pore surface while the dibranched isomer is poorest as it is not flexible enough for sufficient contact with the channel.

### Example 5: Column Breakthrough Measurements

To evaluate the capability of compounds 1 and 2 for separating C6 alkane isomers under practical conditions, column breakthrough experiments were conducted on both compounds 1 and 2 with an equimolar mixture of C6 isomers at 150° C. Measurements under identical experimental conditions were also performed on zeolite 5A for comparison. The results are shown in FIGS. 30G-30I. Both compound 1 and zeolite 5A adsorbed nHEX exclusively. While branched C6 alkanes eluted immediately, linear isomers showed a delayed retention. The real-time RON curves of the eluted product are also plotted in FIGS. 30G-30I. Before the breakthrough of nHEX, the RON values are higher than 90 for both adsorbent materials, meeting and exceeding the industrial standard for refined hexane blends (RON=83). Under the same experimental conditions, nHEX breaks at the 59^{th} minute on zeolite 5A and at the 118^{th} minute on compound 1, meaning the dynamic adsorption capacity (before breakthrough) of the latter is twice of that of the former. This is a significant improvement considering the fact that compound 1 retains the merit of complete exclusion of the branched isomers.

As stated above, branched alkanes (both monobranched and dibranched) broke immediately from the column of zeolite 5A or compound 1, suggesting that neither of these two materials is able to separate isomers of different degrees of branching. In contrast, compound 2 shows clean separation of monobranched and dibranched hexane isomers. As shown in FIG. 30I, breakthrough results for compound 2 indicated that 23DMB eluted first from the column. 3MP eluted at a much later time, followed by nHEX. The breakthrough times were 112, 151, and 166 minutes for the dibranched, monobranched, and linear isomer, respectively. The significantly longer breakthrough time of 3MP than 23DMB indicates a good separation between mono- and di-branched isomers. The separation factor achieved for this compound (˜1.3) is substantially higher than Fe₂(BDP)₃ (˜1.1), which holds the highest record prior to this work. The steepness of the breakthrough events for all three isomers suggests that there are no diffusion restrictions and the separation is thermodynamically controlled. This is consistent with the single component adsorption results where compound 2 shows equilibrium adsorption toward all isomers at 150° C. but with different uptake amount and adsorption affinity.

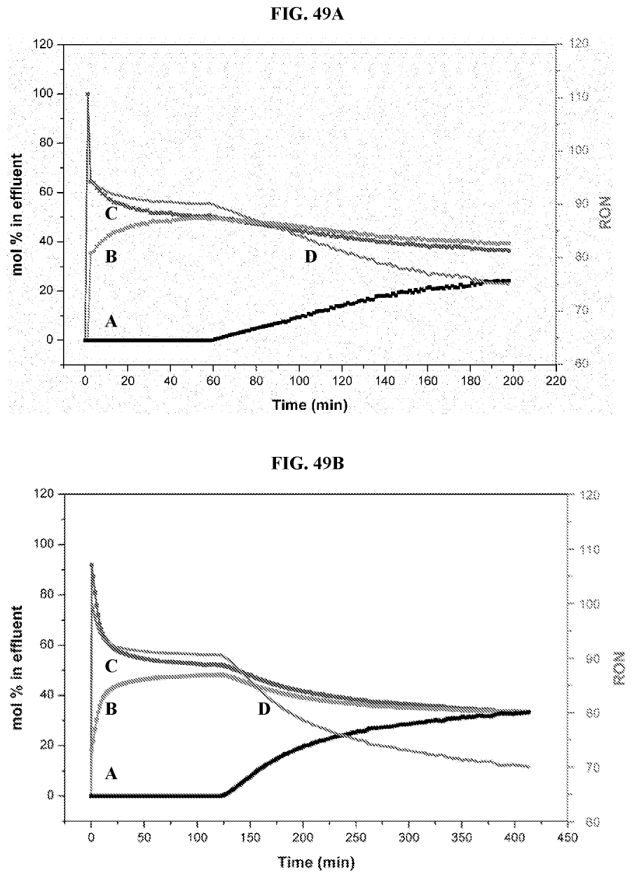

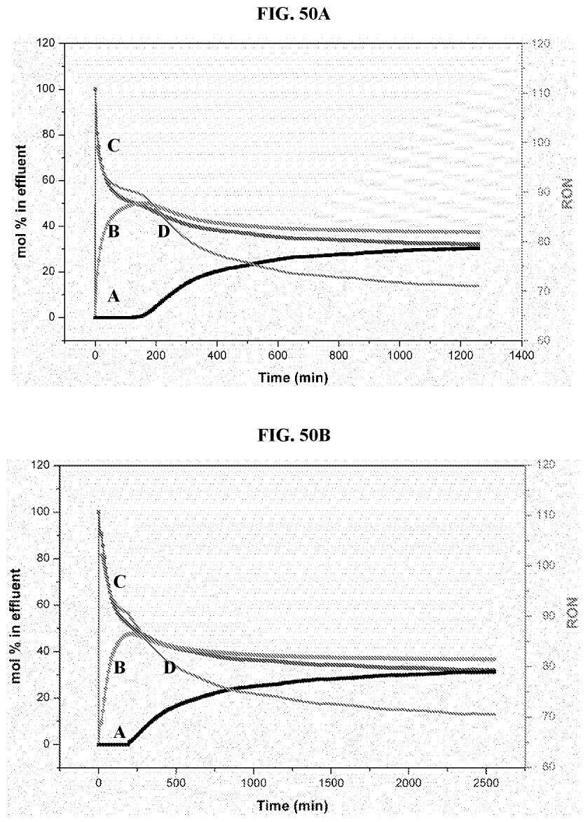

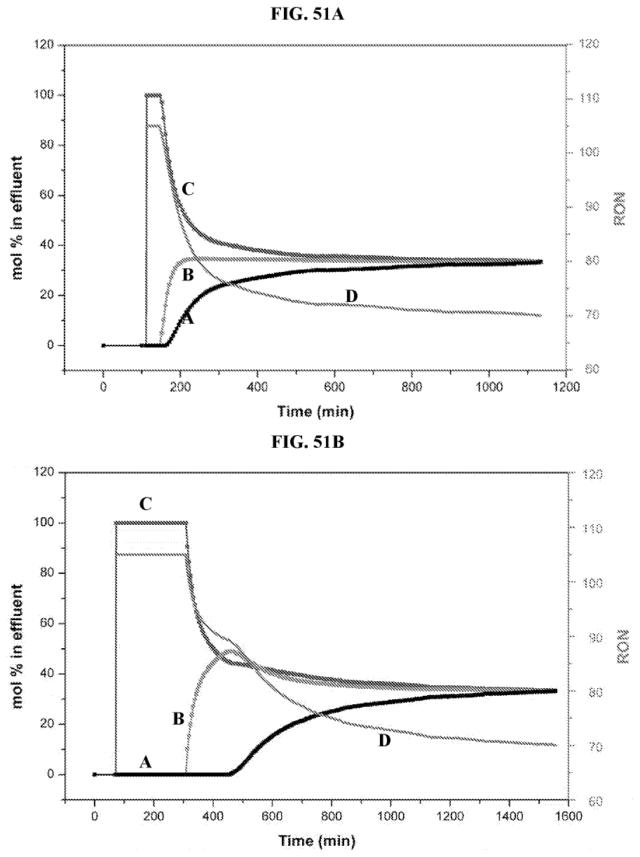

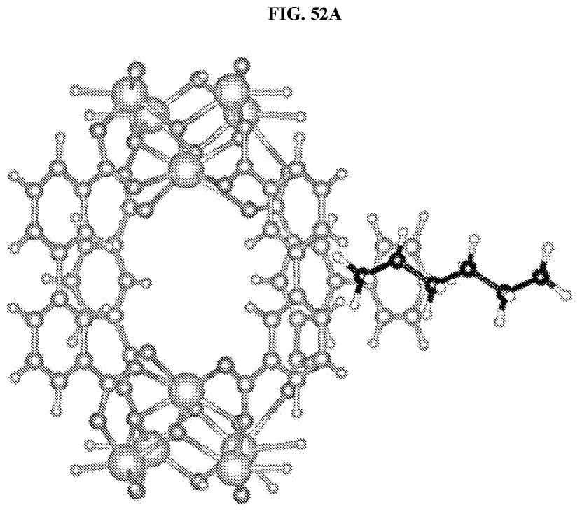

Notably, at the beginning of the breakthrough experiment, the eluted product had a RON higher than 100, well above the value for the state-of-the-art benchmark material zeolite 5A. This can be attributed to the material's ability to separate monobranched and dibranched alkane isomers, making it possible to obtain pure dibranched isomer with the highest RON value. This is of high importance for the petroleum refinement industry as it offers a method to further improve the quality of commercial gasoline. Breakthrough measurements at 30° C. show that the separation ability is retained for all compounds with higher uptake capacity and more diffusion restrictions (FIGS. 49A-49B, 50A-50B, 51A-51B).

### Example 6: Computational Modeling

To gain insight into the size selective molecular exclusion behavior of compound 1, density functional theory (DFT) calculations were performed, including ab initio molecular dynamics (AIMD), to model the diffusion barrier exerted on three C6 isomers while passing through the pore window into the MOF cages.

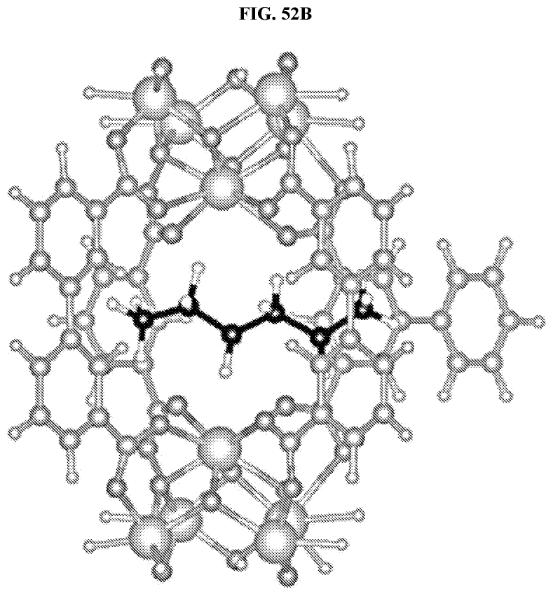

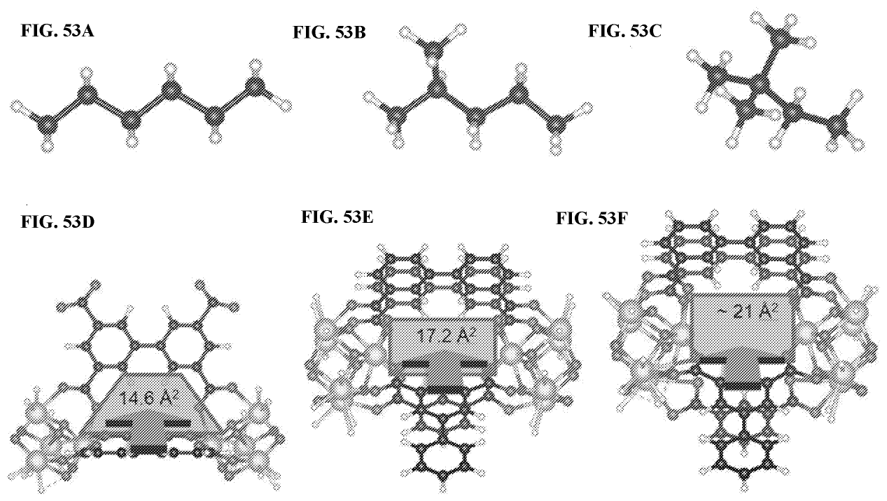

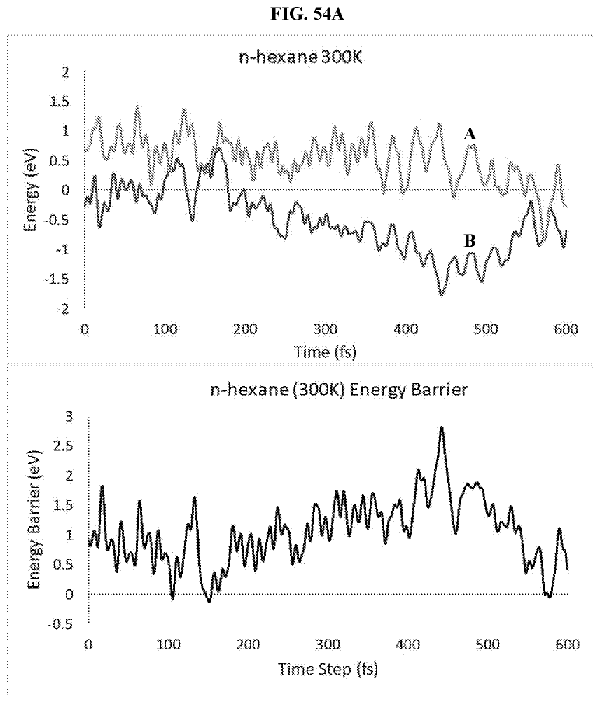

Three C6 alkane isomers with varying degrees of branching were studied with both classical and ab initio methods for adsorption into the Zr-MOF pore: n-hexane, 2-methylpentane, and 2,2-dimethylbutane. Initially, classical calculations were performed on the entire near 850 atom unit cell of n-hexane adsorbed Zr₆O₄(OH)₄(bptc)₃ with both the universal force field (UFF) and the MOF extension UFF4MOF, but unphysical geometric results suggested that those force fields were inadequate and necessitated the need for ab initio calculations. Due to the large size of the full unit cell of the MOF, cut outs were taken directly from the experimental crystallographic information file (CIF) to represent the windows the n-hexane molecules would pass through (FIGS. 52A-52B). Each cut out was properly hydrogen terminated and optimized at the density functional theory (DFT) level with VASP before the energy barriers were calculated as described elsewhere herein. The PBE exchange-correlation functional was used and PAW pseudopotentials were implemented with an energy cutoff of 600 eV; only the F point was used. Three mechanisms for entrance were tested: “straight”, “diagonal”, and “breathing” (FIGS. 53A-53E).

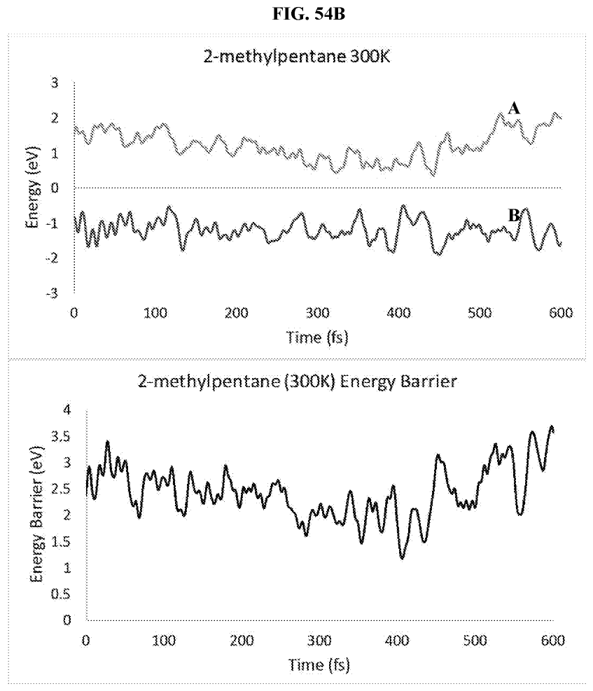

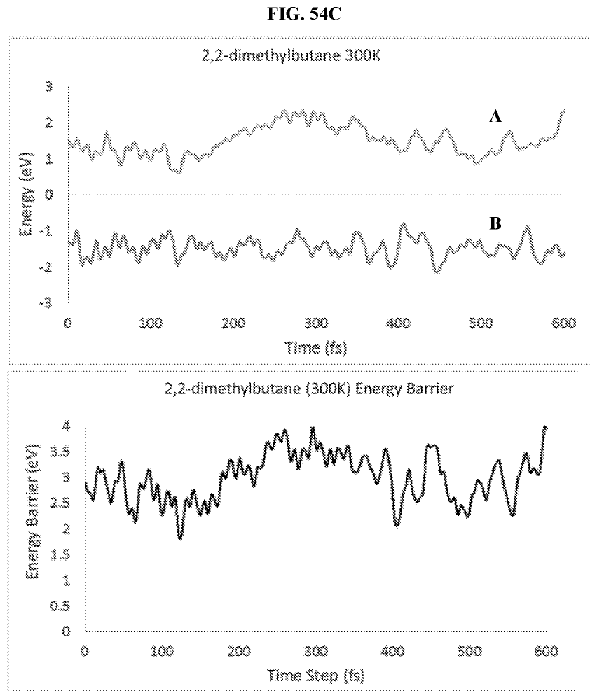

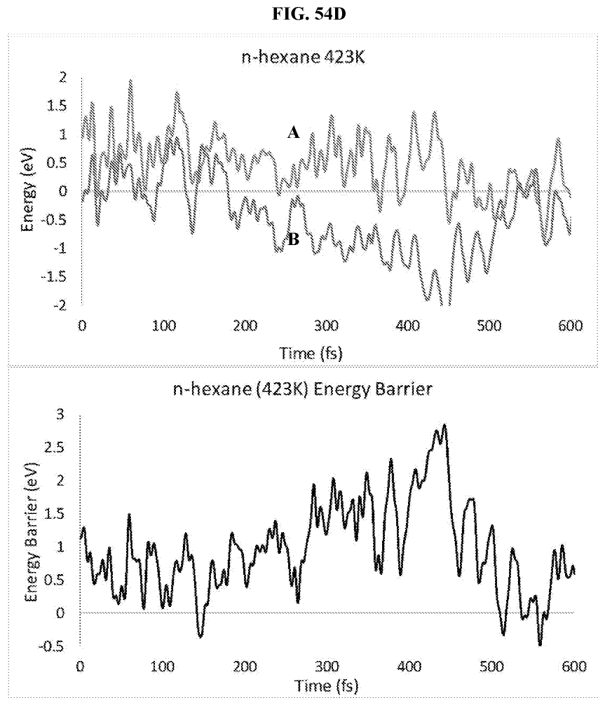

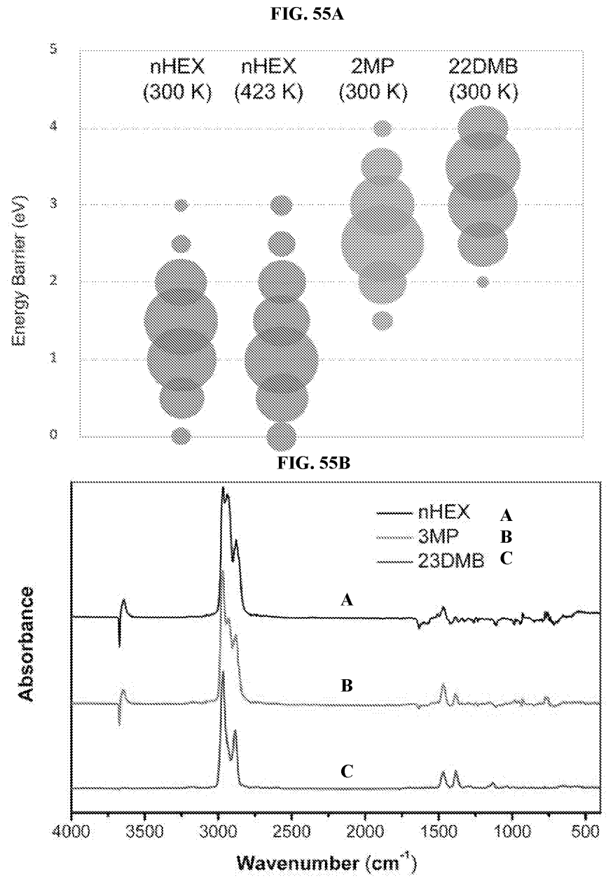

Table 2 shows the energy barrier values for ab initio ground-state calculations (single value, referring to a zero-temperature structure and a transition state search) and ab initio molecular dynamics (AIMD) calculations (range of values). Given the high values of the ground-state energy barriers—which correspond to 0 K—AIMD calculations were performed to study the effect that a finite temperature has on lowering the average barrier. Diffusion events over barriers are statistically rare events on the timescale accessible through AIMD calculations, preventing a direct assessment of the diffusion barrier. The diffusion barrier can then be estimated as E_{b}=Eₚₒᵣₑ−E_{entrance}, i.e. for the AIMD calculations the isomer was placed in two locations (depicted in FIG. 523-53F): outside of the MOF about to enter through the pore window and in the middle of the pore window, where it predictably experiences the highest barrier when passing through the MOF pore window into the MOF cage. The two calculations were run independently and then plotted to show the fluctuations of the total energy with time. After incorporating temperature, it was found that the barriers for n-hexane dropped significantly, even so much as to sometimes have a negative barrier—implying it is more favorable for the hexane to pass through the pore window than to stay outside of it. The total energies at each time step are plotted in FIGS. 54A-54D alongside the time-dependent energy barrier. An energy barrier of 1 eV is approximately an upper limit to have non-negligible statistical probabilities for molecules to pass through the pore window at the studied temperatures (300K and 423 K), and the percent of time spent below a 1 eV barrier is presented in Table 3. Only the n-hexane energy barriers cross below the 1 eV barrier, while the branched isomers do not even come close. Additionally, Table 3 shows that increasing the temperature from 300 to 423 K decreases the average energy barrier of n-hexane and increases the time spent below the 1 eV barrier by 13%. AIMD calculations were run for a total of 800 fs and data was collected after a 200 fs thermalization period.

TABLE 2
Calculated energy barriers. Three C6 isomers with varying degrees of branching
and three entrances were studied. 0 K temperature results are obtained
with ground-state ab initio calculations; the finite temperature results
are found via ab initio molecular dynamics simulations.

| | | Energy Barrier (eV) | | |
|---|---|---|---|---|
| Model | Temp. (K) | n-hexane | 2-methylpentane | 2,2-dimethylbutane |
| Straight | 0 | 4.141 | 5.890 | 5.979 |
| Diagonal | 0 | 3.711 | 5.738 | 5.721 |
| Breathing | 0 | 0.640-1.800 | 1.33-2.725 | 3.301-4.333 |
| Breathing | 300 | 0-2.8 | 1.2-3.7 | 1.8-4.0 |
| Breathing | 423 | 0-2.8 | N/A | N/A |

TABLE 3
Energy barrier statistics. Average energy barriers
and percent time spent below a barrier of 1 eV.

| | | |
|---|---|---|
| | Time Averaged | % Time with |
| Model | Energy Barrier (eV) | Energy Barrier < 1 eV |

300 K

| | | |
|---|---|---|
| n-hexane | 1.05 | 46% |
| 2-methylpentane | 2.41 | 0% |
| 2,2-dimethylbutane | 2.98 | 0% |

423 K

| | | |
|---|---|---|
| n-hexane | 0.96 | 59% |

One hypothesis for diffusion of adsorbate molecules into the MOF was through the “straight” or “diagonal” entrances depicted in FIGS. 53D-53E. However, in both models the ground-state energy barriers, i.e. the barriers corresponding to an optimized zero-temperature structure and transition state search, of >3.7 eV associated with the diffusion through the MOF pore window are too high for all studied isomers to explain adsorption. The effects of temperature were thus investigated through a possible “breathing” mechanism where the adjacent organic linkers slightly open the pore windows in a breathing motion (FIG. 53F). Breathing modes of pores in MOFs have been well characterized and are naturally present at finite temperature, but are often also associated with external stimuli such as ion introduction or added pressure. The breathing mode of our pore window is similar to the low-frequency mode of a ring, which turns into an ellipse by elongating one direction and shortening the other. A drastic drop-off in the ground-state barrier for nHEX is observed for the “breathing” entrance pathways compared to the “straight” or “diagonal” entrances (see Table 2). As expected, 2MP and 22DMB have higher kinetic energetic barriers, 2.7 eV and 4.3 eV, respectively, in comparison to nHEX's barrier of 1.8 eV. While the barriers did lower substantially using this “breathing” mechanism, they are still very high.

To further explore the fast diffusion of nHEX into compound 1, AIMD calculations were performed at 300 K for the three aforementioned isomers as well as the experimental temperature of 423 K for nHEX (FIGS. 54A, 55A). From these, one can directly learn about the time-dependent energy fluctuations and the resulting change in E_{b}. At 300 K, nHEX has a time-averaged barrier of 1.05 eV while the values for branched isomers are well above 2 eV (FIG. 55A, Table 3). An energy barrier of 1 eV is approximately an upper limit to have non-negligible statistical probabilities for molecules to pass through the pore window at these temperatures. The AIMD results indicate that the energetic barrier for nHEX is below 1 eV for 46% of the time. In contrast, the energy for branched isomers never drops below 1 eV during that time period, which suggests that their diffusion into the MOF cages is effectively suppressed. Increasing the temperature to 423 K for nHEX brings the time-averaged energy barrier down to 0.96 eV and increases the percentage of time below 1 eV to 59%. Most noteworthy, however, is that not only the energy barrier for nHEX is less than 1 eV for much of the AIMD trajectory time, but there are brief periods of time where the energy barrier is less than zero, indicating that it is energetically favorable for the adsorbate molecules to enter the cage. While these less-than-zero barrier times are brief, they are estimated to occur with a frequency of at least one per ps such that—over the experimental observation period—they help explain the fast diffusion observed for the nHEX molecule. These results are in good agreement with the experimental results that nHEX experiences equilibrium adsorption, especially at a higher temperature, while its branched isomers are excluded from the pores of compound 1.

### Example 7: Infrared Spectroscopy

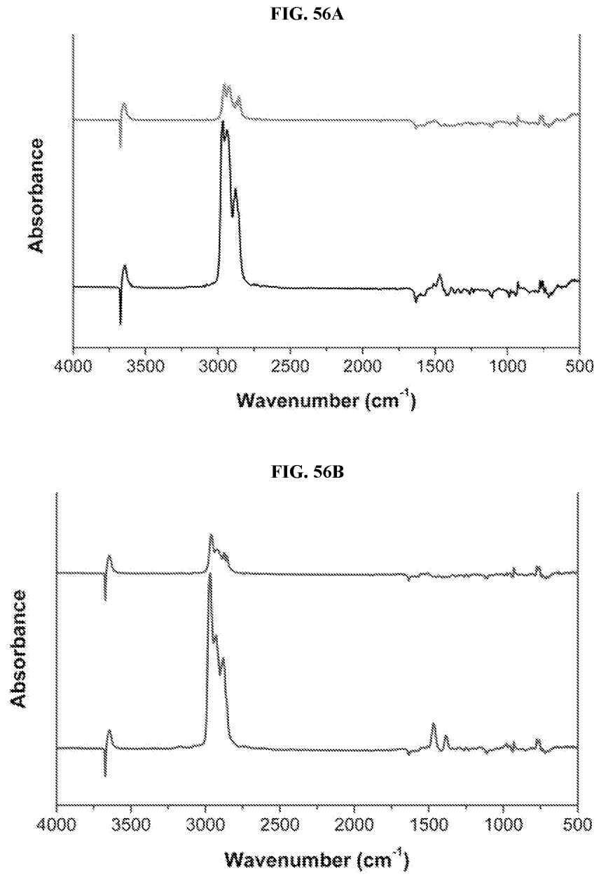

To examine the interaction of C₆ alkane isomers with compound 2 and gain insight in to the selective adsorption, IR spectroscopy studies were performed on the alkanes-loaded MOF. FIG. 55B shows the IR spectra of compound 2 upon adsorption of nHEX, 3MP, or 23DMB. For all three alkane gases, positive bands, located in the 3000-2850 cm⁻¹ and 1355-1470 cm⁻¹ regions, are associated with the C—H stretching and bending vibrations of the alkanes in the gas phase as they disappear quickly upon the evacuation of the cell (FIGS. 56A-56B). Therefore, only molecules adsorbed inside the MOF are detected through the corresponding vibrations that are typically shifted or modified as a result of their interactions with the framework. Interestingly, both nHEX and 3MP molecules exhibit distinct red shifts in the 3600 cm⁻¹ spectral region (from the initial position of 3671 cm⁻¹ to 3643 cm⁻¹) and a loss at 1633 cm⁻¹. In contrast, there is no detectable shift in the 3600 cm⁻¹ spectral region and no loss at 1633 cm⁻¹ during the adsorption of 23DMB. The peak initially at 3671 cm⁻¹ is associated with the O—H stretch vibration of the terminal hydroxyl group in the SBU. A red shift therefore indicates that the adsorbed species are interacting with this group through weak hydrogen bonding. Without wishing to be limited to any particular theory, it is possible that the loss of a peak at 1633 cm⁻¹ observed during the adsorption of nHEX or 3MP is due to an interaction between the adsorbed molecules and the carboxylate groups of the organic linker abtc⁴⁻ of the MOF structure. Altogether, the in situ IR measurements of compound 2 point to an interaction between nHEX (or 3MP) with the hydroxyl and carboxylate groups of the MOF, which is absent in the case of 23DMB. This finding is consistent with the results previously observed for 23DMB: lower adsorbed amounts, weaker affinity (lower heat of adsorption), and much shorter retention time in column breakthrough measurements.

### Example 8: Synthesis and Characterization of Ca(H₂Tcpb)

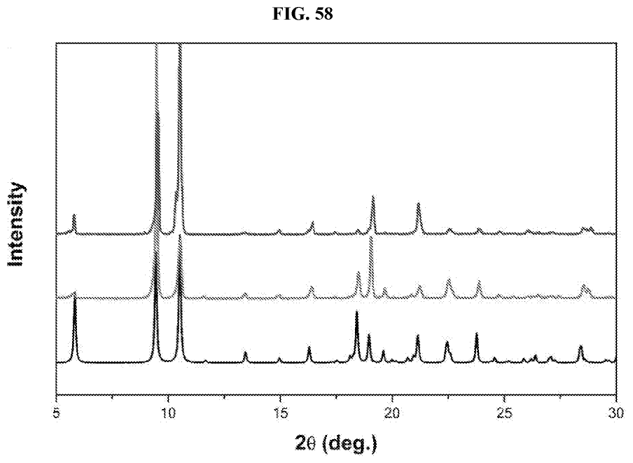

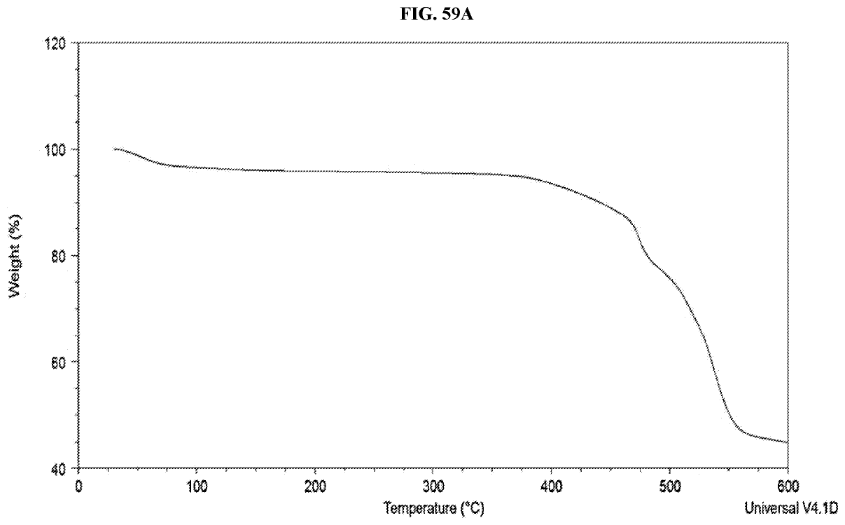

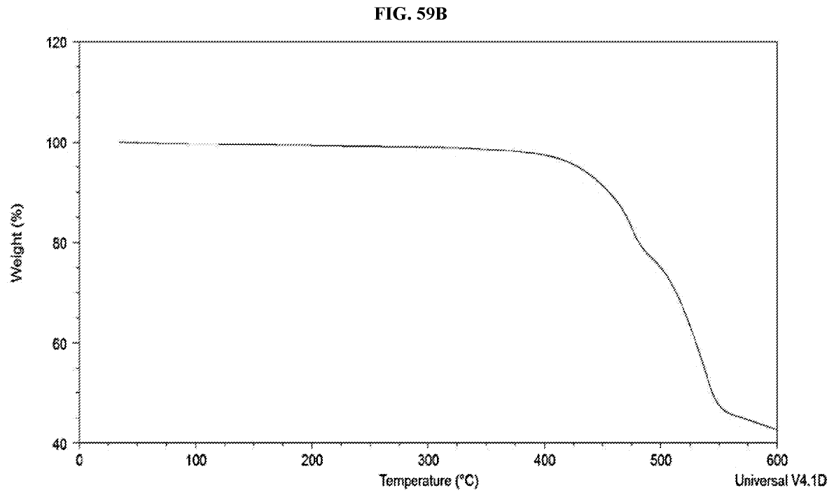

Ca(H₂tcpb) was synthesized via solvothermal reactions of CaCl₂ and H₄tcpb in ethanol at 100° C. for 3 days. In its crystal structure, Ca²⁺ ions are coordinated by six carboxylate oxygen atoms, and the CaO₆ octa-hedra are connected through H₂tcpb linkers to form a three-dimensional (3D) framework with 1D open channels running along the crystallographic a-axis (FIGS. 57A-57B). The material has a BET surface area of ˜200 m²/g, and the pore size of the as-synthesized structure is ˜5.5 Å (distance between H—H, excluding Van der Waals radii), close to the kinetic diameters of branched alkanes (5.0-6.4 Å). Additionally, this compound was selected as a candidate for the separation of alkane isomers because it is very robust, retaining crystallinity after 3 years on a shelf (FIG. 58). It exhibits high moisture stability and hydrophobic character. The activated structure does not adsorb water moisture after exposure to open air for 5 days (FIGS. 59A-59B).

### Example 9: Adsorption and Separation of C6 Alkane Isomers with Ca(H₂Tcpb)

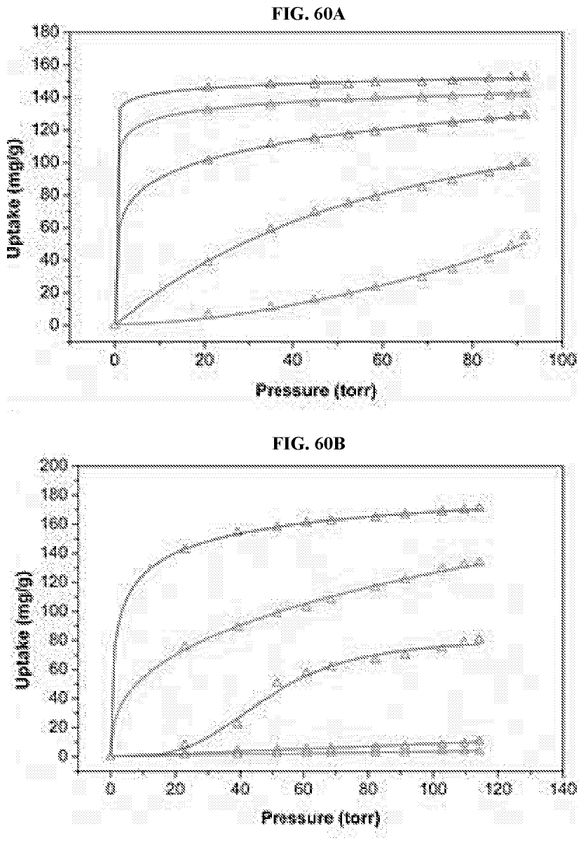

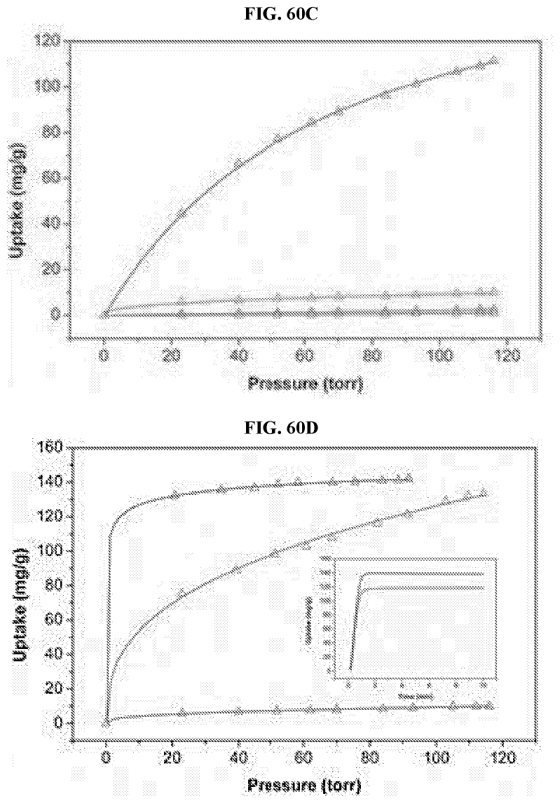

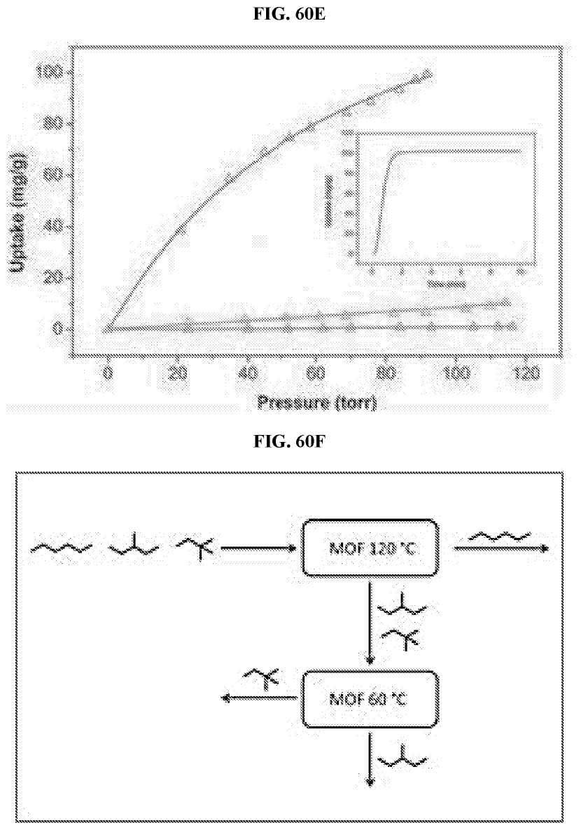

Adsorption isotherms were collected of three C6 alkane isomers with different degrees of branching on Ca(H₂tcpb) at various temperatures (30° C., 60° C., 90° C., 120° C., and 150° C., FIGS. 60A-60C). The isotherms of n-hexane (nHEX) at 30-120° C. show uptake capacities comparable to those of zeolite 5A and other reported MOFs. However, its isotherm at 150° C. exhibits a dramatic decrease in uptake amount. For 3-methylpentane (3MP), high uptake is also achieved at 30° C. but as the temperature increases to 60° C. and 90° C., the adsorbed amount decreases significantly. At 120° C. and 150° C. there is essentially no adsorption up to ˜120 torr. The MOF compound adsorbs negligible 2,2-dimethylbutane (22DMB) at all temperatures examined except 30° C. Full adsorption equilibrium was reached for each pressure point during the collection of these isotherms and no diffusional restriction was observed.

The anomalous adsorption phenomena observed here suggests that Ca(H₂tcpb) can be used to separate alkanes on the basis of branching. As demonstrated by the adsorption isotherms shown in FIGS. 60D-60E, at 60° C., Ca(H₂tcpb) adsorbs nHEX and 3MP but excludes 22DMB while at 120° C. it adsorbs only nHEX. This is the first example where a sorbent shows complete size sieving toward mono-branched and di-branched alkanes. A two-column system was then designed for breakthrough experiments, aiming at separating a ternary mixture of nHEX, 3MP, and 22DMB into chemically pure components. FIG. 60F depicts a schematic representation of the separation setup. The apparatus operates on the basis that when the ternary mixture passes through the first column packed with MOF powder at 120° C., nHEX is adsorbed and retained in the column while the branched isomers (3MP and 22DMB) are eluted out without retention. The eluted binary mixture is subsequently directed to the second column packed with MOF powder at 60° C. where 3MP will be retained but not 22DMB. Hence the initial ternary mixture can be separated into three chemically pure and individual components.

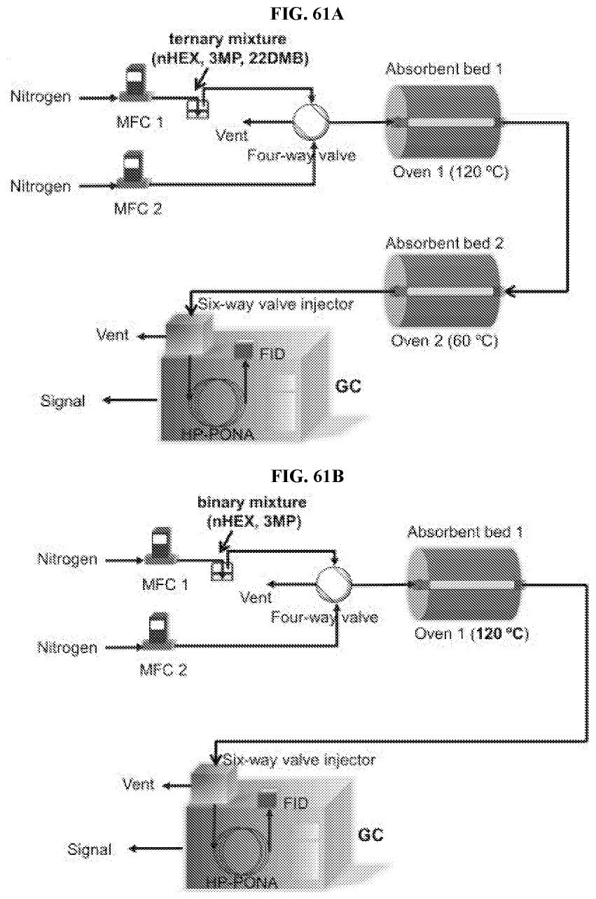

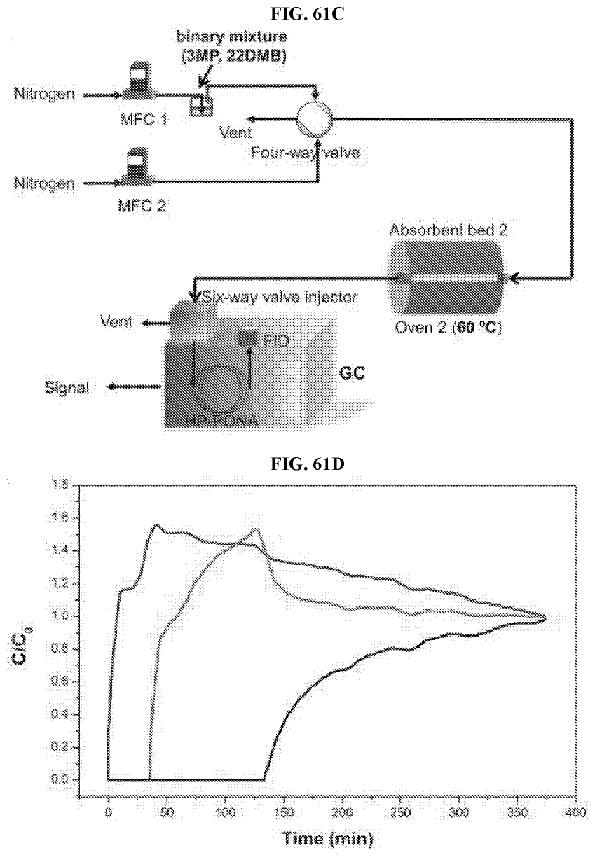

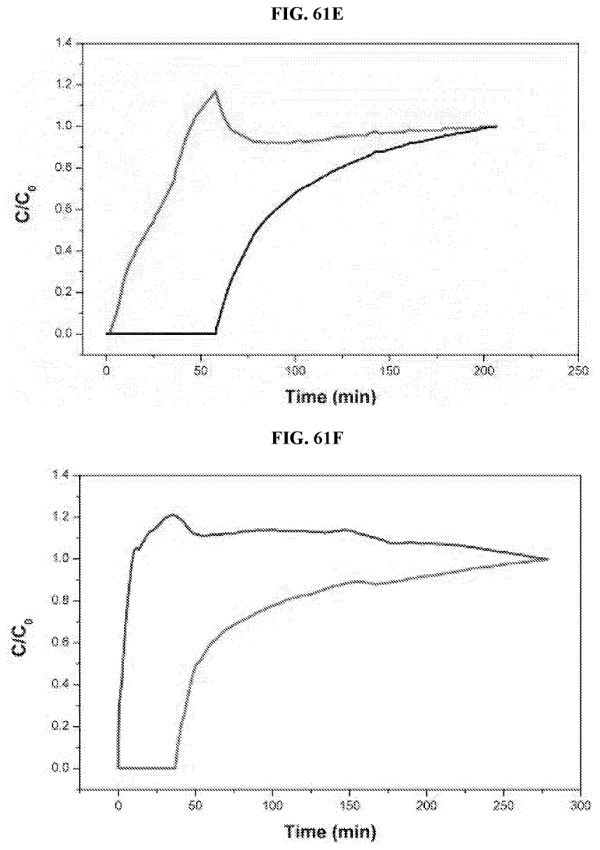

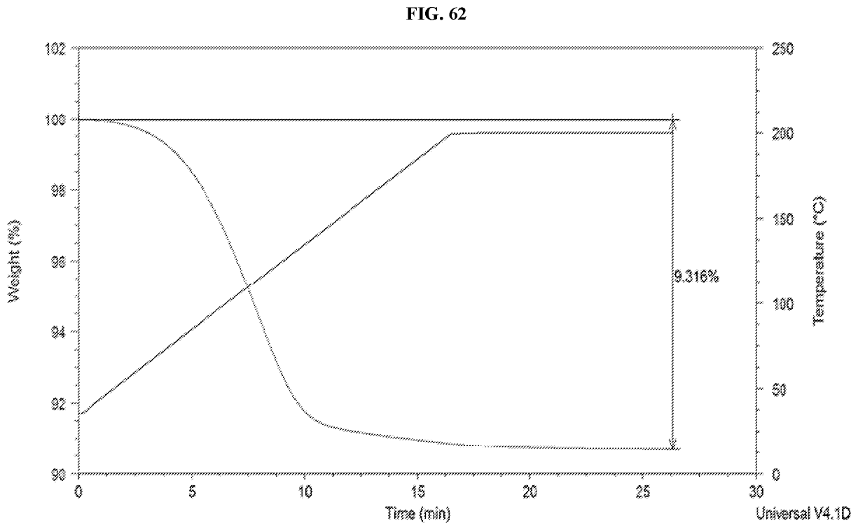

As shown in FIGS. 61A and 61D, when an equimolar ternary mixture of nHEX, 3MP, and 22DMB was injected into the two-column system, a clean separation was observed for the three components. nHEX was retained in the columns for the longest time of 134 minutes while 3MP broke through at the 36^{th} minute, indicating adsorption of both nHEX and 3MP but the adsorbed amount of the former was much more substantial than that of the latter. This is consistent with the single component adsorption isotherms and the design rationale as 3MP was only adsorbed at 60° C. (not 120° C.). In contrast, 22DMB eluted out from the system immediately without any retention, confirming that adsorption did not occur at either 60 or 120° C. This is significant since the MOF sorbent is not only capable of separating 3MP and 22DMB through size sieving, but more importantly, it offers a clean separation of all three isomers (linear, mono-branched, and di-branched) via selective molecular sieving. To further confirm that the separation occurs in compliance with the proposed mechanism, the two-column system was broken down into two single-column setups. A first single-column breakthrough experiment was performed with an equimolar binary mixture of nHEX and 3MP at 120° C., as shown in FIG. 61B. The results showed that 3MP broke through at the 2nd minute while retention of nHEX lasted for as long as 58 minutes. This is in good agreement with the single component adsorption isotherms since Ca(H₂tcpb) adsorbs ˜88 mg/g of nHEX but negligible amount of 3MP at 120° C. and 72 torr (partial pressure under dynamic breakthrough measurement). The second single-column breakthrough experiment was conducted with an equimolar binary mixture of 3MP and 22DMB at 60° C. as shown in FIG. 61C. A clean separation between these two components was observed where 22DMB eluted out from the column immediately while retention of 3MP in the column lasted for 38 minutes before breaking. These results are in agreement with the single component adsorption results where the Ca(H₂tcpb) material uptakes a substantial amount of 3MP but no 22DMB at 60° C.

### Example 10: Structural Analysis of Ca(H₂Tcpb) Framework Breathing

Without intending to be limited to any particular theory, it is possible that Ca(H₂tcpb) possesses unique adsorption behavior toward alkane isomers as a result of its framework flexibility and adsorbate-dependent structure change. The pore-opening of the activated compound is governed by a cooperative interaction between a specific adsorbate molecule and the framework which is temperature dependent. Structural flexibility can be advantageous for molecular separation. The material may be suitable for multicomponent separation when its framework breathing is temperature- and adsorbate-dependent. In such a case, when one adsorbate triggers pore opening at a given temperature, other adsorbates in the mixture cannot diffuse into the pores, resulting in high adsorption selectivity. Ca(H₂tcpb) represents a good example of this principle. As shown in FIG. 60B, the structural breathing (gate-opening) is evident in the isotherm at 90° C. as indicated by the step at ˜40 torr. Appreciable adsorption takes place after this point. At higher temperatures (120 and 150° C.), the material takes up negligible amount of 3MP, as the pressure applied (up to ˜120 torr) is insufficient to induce the pore opening. For 22DMB, on the other hand, essentially no adsorption takes place at temperature as low as 60° C. (FIG. 60C). A clear trend can be deduced based on these observations: at a given temperature, the larger the adsorbate molecule, the higher pressure (driving force) is required to open up the pores. Likewise, the larger the adsorbate molecule, the lower temperature is required to open up the pores. This behavior is retained in the binary mixture and is confirmed by the breakthrough results shown in FIGS. 61C and 61F, where at 60° C. only 3MP is being adsorbed and 22DMB is excluded. Similarly, the breakthrough results plotted in FIGS. 61B and 61E for a nHEX/3MP binary mixture, and in FIGS. 61A and 61D for a nHEX/3MP/22DMB ternary mixture further confirm that the sorbate-dependent structure change of Ca(H₂tcpb) applies to all three adsorbate molecules.

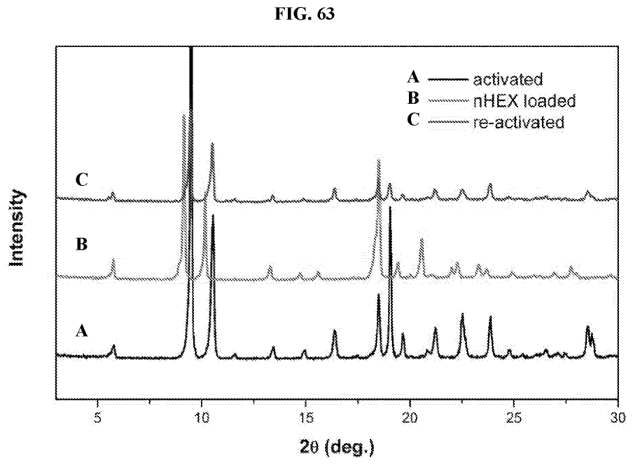

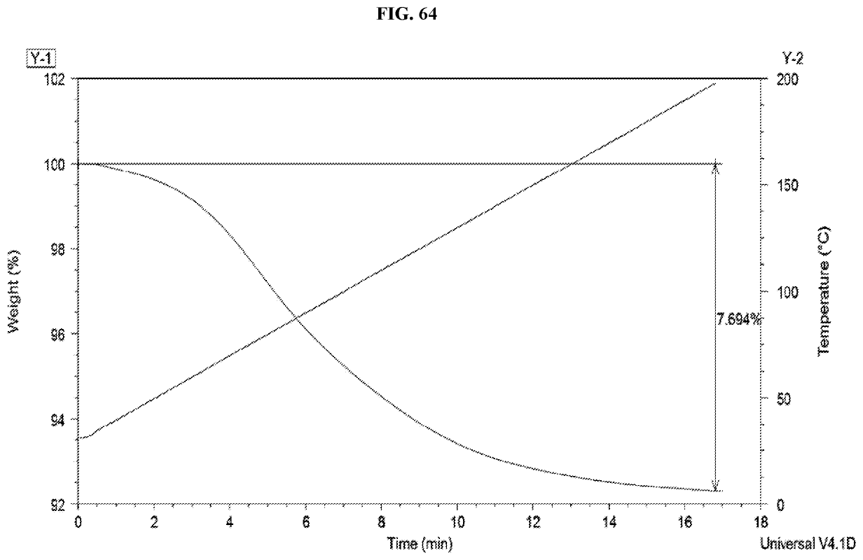

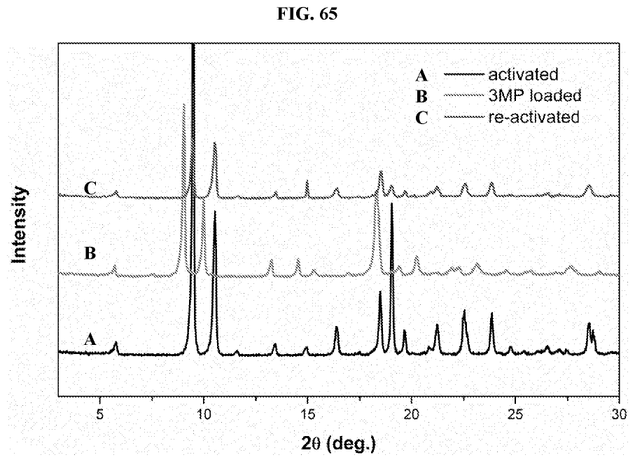

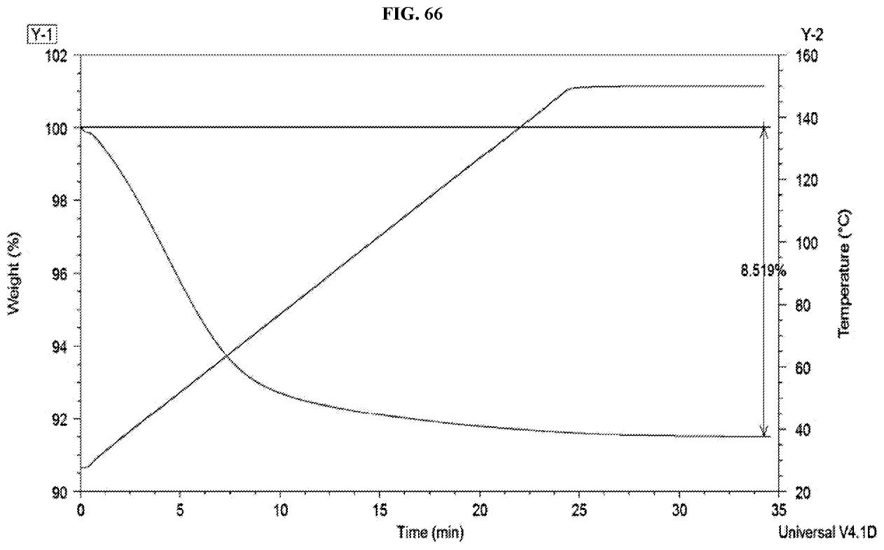

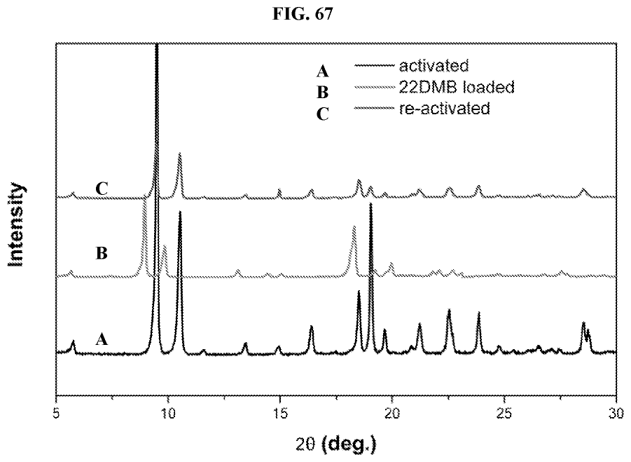

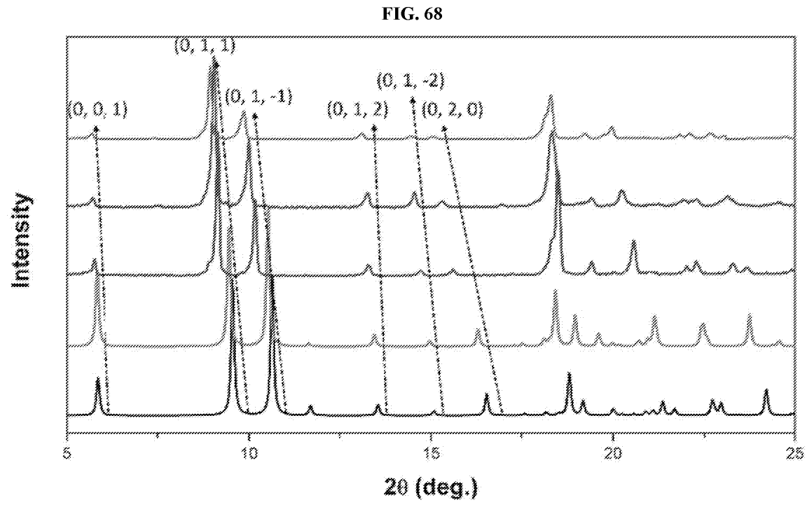

To provide additional support to the above hypothesis, structural analysis was performed on the MOF samples loaded with different alkane isomers. Attempts to determine alkane loaded structures by single-crystal X-ray diffraction were unsuccessful, as the quality of the single crystals deteriorated after alkane loading, likely due to the associated sizeable structural change. However, useful information was obtained by comparing the structures of the as-synthesized (Ca(H₂tcpb).xH₂O) and activated (Ca(H₂tcpb)) form (Table 4). Upon activation, the as-synthesized compound underwent a framework contraction, due to the removal of water molecules in the channels. By analyzing their crystallographic data, it was found that the main differences between the as-synthesized and activated structures lie in the b-axis and β angle. The length of b-axis reduces from 11.0274 Å to 10.8715 Å and the angle of β decreases from 87.657° to 85.982°. Changes associated with other unit cell parameters were negligible. A reduction of unit cell volume from 856.57 to 831.37 Å3 was also observed. A reverse structural variation was observed when the activated sample was loaded with alkane molecules at 30° C. Based on the powder X-ray diffraction data (FIGS. 63, 65, 67 and 68), a correlation can be drawn between the changes of the crystallographic parameters (expansion of b and β) and the pore size/shape of the MOF (FIG. 69). Clearly the observed structure changes from Ca(H₂tcpb) to Ca(H₂tcpb).y(alkane) are associated with a significant increase in the effective pore size. The structural change is reversible, continuous, and adsorbate-dependent. The extent of such changes also depends on the adsorbate size: the larger the molecular size, the more significant the change. Additionally, at a selected temperature, the pore size enlargement induced by a smaller adsorbate is insufficient to allow a larger adsorbate to diffuse into the pores of the adsorbent.

TABLE 4
Selected crystallographic data of Ca(H₂tcpb) and Ca(H₂tcpb)•xH₂O

| | Ca(H₂tcpb) | Ca(H₂tcpb)•xH₂O |
|---|---|---|
| | (activated) | (as synthesized) |
| a (Å) | 5.1011(3) | 5.1594(2) |
| b (Å) | 10.8715(9) | 11.0274(6) |
| c (Å) | 15.2363(8) | 15.2740(8) |
| α (°) | 83.132(5) | 83.310(4) |
| β (°) | 85.982(4) | 87.657(4) |
| γ (°) | 83.032(5) | 83.128(4) |
| Volume (Å³) | 831.37(10) | 856.57(7) |

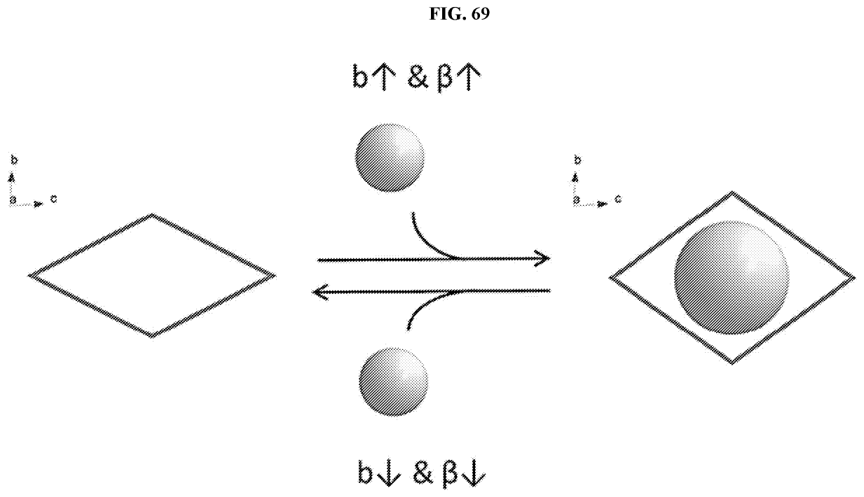

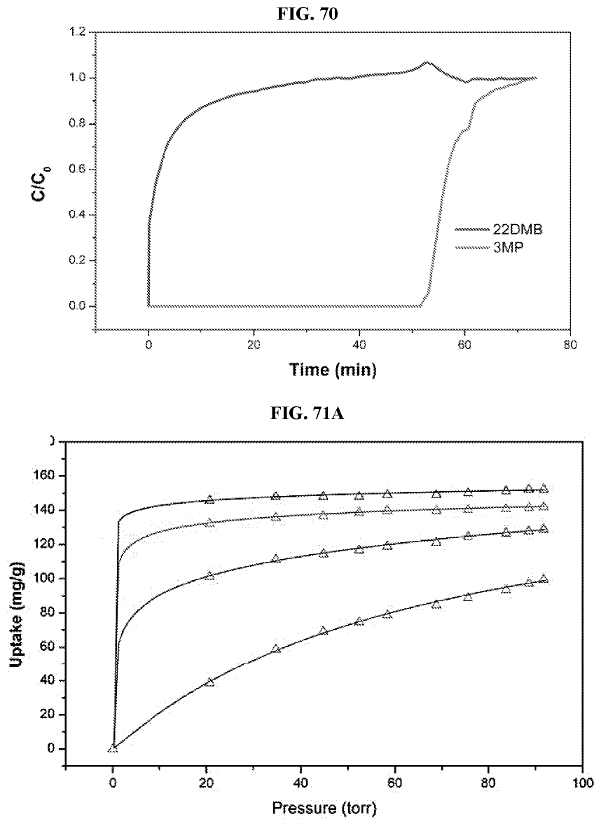

In order to take the hydrophobic nature of the MOF channels into account, a column breakthrough experiment was conducted with a binary mixture of 3MP and 22DMB in the presence of moisture (50% relative humidity) to explore the influence from competitive adsorption of water (FIG. 70). The dynamic 3MP adsorption capacity was 55.4 mg g⁻¹ (compared to 57 mg under equivalent dry conditions), indicating that Ca(H₂tcpb) is capable of retaining its separation ability under humid conditions. The fact that Ca(H₂tcpb) is capable of retaining strong separation in the presence of water is of great importance because competitive adsorption of water presents a common and challenging issue that often greatly impedes the adsorption/separation ability of MOFs known in the art.

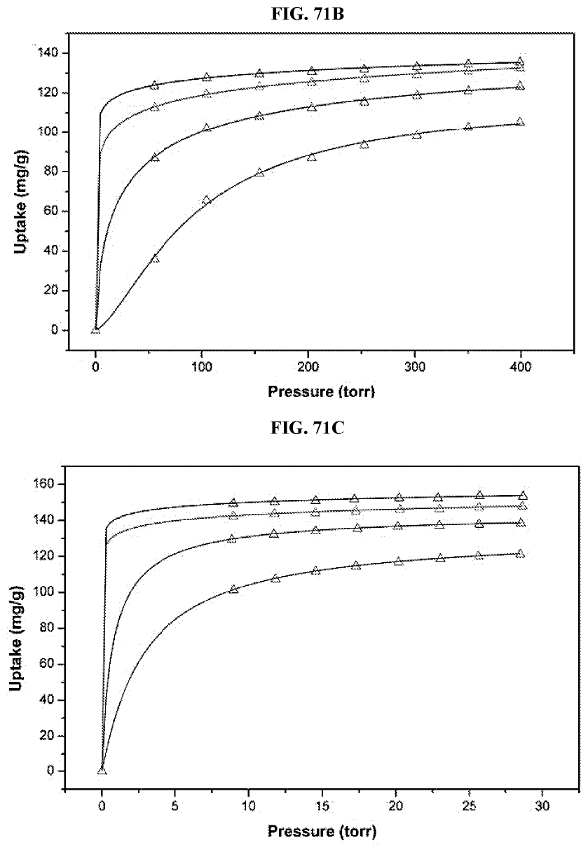

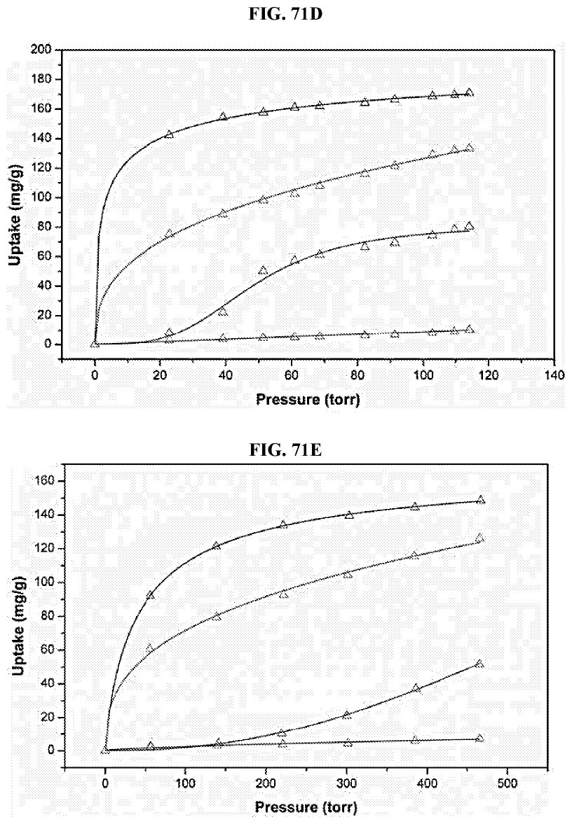

To explore the generality of the adsorption behaviors of Ca(H₂tcpb) towards additional alkanes, additional adsorption measurements were conducted with other common alkane components of gasoline including C5 and C7 isomers n-pentane (nPEN), 2-methylbutane (2 MB), and n-heptane (nHEP). The adsorption profiles for these alkanes are similar and follow the same trend as C6 alkane isomers (FIGS. 71A-71E). These results further confirm the capability of Ca(H₂tcpb) to separate alkane isomers having different degree of branching. In light of its high stability, hydrophobicity, and excellent separation performance toward alkane isomers, Ca(H₂tcpb) holds great promise for RON upgrading of gasoline.

The disclosures of each and every patent, patent application, and publication cited herein are hereby incorporated herein by reference in their entirety. While this invention has been disclosed with reference to specific embodiments, it is apparent that other embodiments and variations of this invention can be devised by others skilled in the art without departing from the true spirit and scope of the invention. The appended claims are intended to be construed to include all such embodiments and equivalent variations.

1. A metal-organic framework comprising at least one M⁴⁺ and at least one tetratopic organic linker of formula (I): 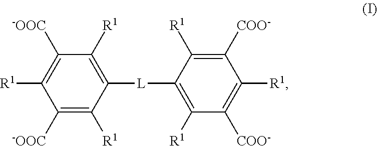
wherein in (I):
L is selected from the group consisting of a bond, optionally substituted C1-C6 alkylene, optionally substituted C2-C6 alkenylene, optionally substituted C2-C6 alkynylene, optionally substituted C1-C6 heteroalkylene, optionally substituted C2-C6 heteroalkenylene, optionally substituted C2-C6 heteroalkynylene, 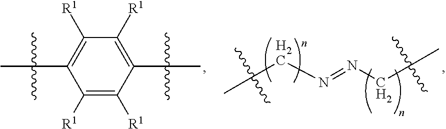
O, S, SO₂, NH and NCH₃;
each instance of R¹ is independently selected from the group consisting of H, CH₂, CH₂CH₃, OCH₃, OH, NH₂, F, Cl, Br, I, CF₃, SH, and NO₂; and
each instance of n is an integer from 0 to 3.

2. The metal-organic framework of claim 1, wherein M⁴⁺ is a metal selected from the group consisting of Zr⁴⁺, H⁴⁺ and Ti⁴⁺.

3. The metal-organic framework of claim 1, wherein M⁴⁺ is Zr⁴⁺.

4. The metal-organic framework of claim 1, wherein M⁴⁺ is in the form of a (M⁴⁺)₆ cluster.

5. The metal-organic framework of claim 4, wherein the (M⁴⁺)₆ cluster (i) comprises at least one μ₃-O bridging ligand, at least one μ₃-OH bridging ligand, and at least one formate bridging ligand, or (ii) is bound to 12, 8, or 4 tetratopic organic linkers of formula (I).

6. (canceled)

7. The metal-organic framework of claim 1, wherein the at least one linker of formula (I) is a compound selected from the group consisting of:

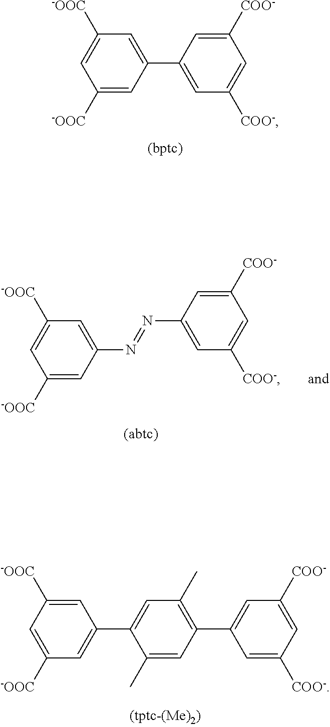

8. The metal-organic framework of claim 1, wherein the framework has at least one of the following characteristics:
(i) has a topology selected from the group consisting of ftw, scu and lvt,
(ii) crystallizes in a space group selected from the group consisting of space group Im3, space group C2/m, and space group Imma,
(iii) has a Brunauer-Emmett-Teller (BET) surface area from about 1,000 m²/g to about 1,500 m²/g,
(iv) has a micropore volume from about 0.35 cm²/g to about 0.50 cm²/g,
(v) is thermally stable up to about 400° C.,
(vi) is stable after being heated at up to about 180° C. for 1 month,
(vii) retains crystallinity in aqueous solutions having a pH from about 2 to about 12, or
(viii) is capable of reversibly adsorbing from about 100 mg/g to about 130 mg/g of aliphatic hydrocarbon (hydrocarbon/MOF).

9-15. (canceled)

16. A method of at least partially separating a first aliphatic hydrocarbon compound from a mixture comprising the first aliphatic hydrocarbon and at least one distinct aliphatic hydrocarbon compound, the method comprising contacting the mixture with the metal-organic framework of claim 1, whereby the first aliphatic hydrocarbon compound and the at least one distinct aliphatic hydrocarbon compound are at least partially separated from one another.

17. The method of claim 16, wherein the first aliphatic hydrocarbon compound and the at least one distinct aliphatic hydrocarbon compound are run through a column that is at least partially packed with the metal-organic framework.

18. The method of claim 16, wherein the first aliphatic hydrocarbon compound and the at least one distinct aliphatic hydrocarbon compound are at least one the following:
(i) independently selected from the group consisting of C5-C7 alkanes, C5-C7 alkenes, and C5-C7 alkynes,
(ii) isomers,
(iii) C6 isomers, or
(iv) selected from the group consisting of n-hexane, 2-methylpentane, 3-methylpentane, 2,2-dimethylbutane, and 2,3-dimethylbutane.

19-26. (canceled)

27. A method of separating a first aliphatic hydrocarbon compound from a first mixture of aliphatic hydrocarbons, the method comprising contacting the first mixture with a Ca(H₂tcpb) MOF: 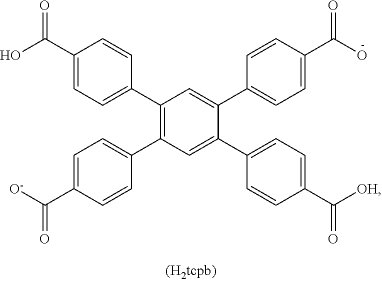 [SMILES: O=C([O-])c1ccc(-c2cc(-c3ccc(C(=O)O)cc3)c(-c3ccc(C(=O)O)cc3)cc2-c2ccc(C(=O)O)cc2)cc1]
wherein the first aliphatic hydrocarbon is selectively adsorbed onto the Ca(H₂tcpb) MOF over at least one additional aliphatic hydrocarbon in the first mixture, wherein the first mixture comprises at least one of the following:
(i) at least one selected from the group consisting of a C₅ alkane, a C₅ alkene, a C₆ alkane, a C₆ alkene, a C₇ alkane, a C₇ alkene, a C₈ alkane, and a C₈ alkene,
(ii) at least one selected from the group consisting of C₅ alkane isomers, C₅ alkene isomers, C₆ alkane isomers, C₆ alkene isomers, C₇ alkane isomers, C₇ alkene isomers, C₈ alkane isomers, and C₈ alkene isomers,
(iii) at least one selected from the group consisting of saturated hydrocarbons, single unsaturated compounds, double unsaturated compounds, and triple unsaturated compounds, or
(iv) at least one selected from the group consisting of straight chained, mono-branched and multi-branched compounds.

28-30. (canceled)

31. The method of claim 27, wherein the first mixture is run through a column that is at least partially filled with Ca(H₂tcpb) MOF at a temperature such that the first aliphatic hydrocarbon compound is adsorbed by the MOF while the remaining aliphatic hydrocarbons are not adsorbed or are adsorbed to a lesser extent than the first aliphatic compound, thereby at least partially separating the first aliphatic hydrocarbon from the mixture.

32. The method of claim 27, comprising the steps of:
(a) running the first mixture through a first column that is at least partially filled with Ca(H₂tcpb) MOF at a first temperature such that the first aliphatic hydrocarbon in the mixture is adsorbed by the MOF while the remaining aliphatic hydrocarbons in the first mixture are not adsorbed or are adsorbed to a lesser extent than the first aliphatic compound, thereby separating the first aliphatic hydrocarbon from the first mixture and generating a second mixture, which is depleted from the first aliphatic hydrocarbon as compared to the first mixture;
(b) running the second mixture of aliphatic hydrocarbons through a second column that is at least partially filled with Ca(H₂tcpb) MOF at a second temperature that is different from the first temperature such that a second aliphatic hydrocarbon in the mixture is adsorbed by the MOF while the remaining aliphatic hydrocarbons in the second mixture are not adsorbed or are adsorbed to a lesser extent than the second aliphatic compound, thereby separating the second aliphatic hydrocarbon from the second mixture and generating a third mixture, which is depleted from the second aliphatic hydrocarbon as compared to the second mixture; and
(c) optionally repeating step (b) one or more times to separate further additional aliphatic hydrocarbons from the third mixture.

33-37. (canceled)

38. The method of claim 32, further comprising collecting the adsorbed, separated first aliphatic hydrocarbon from the first column and/or the adsorbed, separated second aliphatic hydrocarbon from the second column.

39. The method of claim 27, wherein each mixture is a gaseous mixture.

40. A device for separating aliphatic hydrocarbon compounds from one another, the device comprising:
a first column that is at least partially filled with Ca(H₂tcpb) MOF, the first column comprising an inlet, a first outlet, and a second outlet;
a second column that is at least partially filled with Ca(H₂tcpb) MOF, the second column comprising an inlet, a first outlet, and a second outlet, wherein the inlet of the second column is in in fluidic communication with the first outlet of the first column;
a first heating element adapted and configured to regulate the temperature of the first column; and
a second heating element adapted and configured to regulate the temperature of the second column.

41. The device of claim 40, further comprising a hydrocarbon source in fluidic communication with the inlet of the first column, wherein the gas source is adapted and configured to supply a hydrocarbon mixture to the inlet of the first column.

42. The device of claim 40, further comprising at least one additional column comprising a first inlet, a first outlet and a second outlet, wherein the inlet of the additional column is in fluidic communication with the first outlet of the second column or the second outlet of the first column, and wherein the at least one additional column is at least partially filled with Ca(H₂tcpb) MOF.

43. (canceled)

44. The device of claim 42, further comprising at least one additional heating element adapted and configured to regulate the temperature of the at least one additional column.

45. A kit comprising the device of claim 40 and instructional materials for operating the device.
